(19) United States
(12) Patent Application Publication
(10) Pub. No.: US 2017/0184190 A1
(43) Pub. Date: Jun. 29, 2017

(54) FLEX SPLINE TORQUE TRANSFER DEVICE

(71) Applicant: Genesis Robotics LLP, Langley (CA)

(72) Inventor: James Brent Klassen, Langley (CA)

(21) Appl. No.: 15/309,437

(22) PCT Filed: May 6, 2015
(86) PCT No.: PCT/CA2015/050401

§ 371 Date: Nov. 7, 2016

Related U.S. Application Data
(60) Provisional application No. 61/989,515, filed on May 6, 2014.
(60) Provisional application No. 62/006,045, filed on May 30, 2014.
(60) Provisional application No. 62/035,489, filed on Aug. 10, 2014.

(51) Int. Cl. F16H 49/00

(52) U.S. Cl. CPC F16H 49/001; F16H 2049/003

(57) ABSTRACT

A flex spline torque transfer device has a flex spline that is deflected in the radial direction by magnetic attraction to form a wave. The flex spline may be deflected radially inward by magnetic attraction to form a wave. The flex spline (FS) may be deflected radially inward by magnetic attraction at one or more positions equally spaced around the FS inner diameter (ID). The attraction may be greatest at smallest radial air gap between FS and magnetic means and lowest at largest air gap. The magnetic means may or may not be actively commutated. The highest magnetic force may be determined by the smallest air gap. In another embodiment, a torque transfer device has a flex spline that is deflected radially inward by magnetic attraction to a permanent magnet means at one or more positions equally spaced around the FS ID.

### CROSS-REFERENCE TO RELATED APPLICATIONS

This application claims the benefit under 35 U.S.C. §119(e) of U.S. provisional application Ser. No. 61/989,515 filed May 6, 2014, 62/006,045 filed May 30, 2014, and 62/035,489 filed Aug. 10, 2014.

### BACKGROUND

Technical Field

Flexible spline gear systems.

Description of the Related Art

Conventional flex spline gear reducers are generally of the harmonic drive type. As shown in FIG. 1, these devices typically use a mechanical wave form generator 16 which exerts an outwardly radial force on the flex spline 14 to generate an elliptical shape with two apexes. The force is applied directly at the apexes of the flex spline 14 by rollers 18 to press the flex spline against circular ring gear 20. Torque is transmitted from the flex spline to a circular gear ring through teeth on the outside of the flex spline. In order to prevent unwanted interference of harmonic drive flex spline teeth and the ring gear teeth as the flex spline is deformed on either side of the apexes, modified involute tooth forms must be used. These tooth forms can produce a high number of contacting teeth, which can be beneficial for high torque, but the high contact angle of these tooth forms can result in a high separation force between the teeth under load. This high separation force requires high outward radial force of a mechanical wave generating member which is typically a rolling bearing element pushing outwards against the inner diameter ID of the flex spline. The drawbacks of this mechanical wave generator system include that it occupies significant space in the harmonic drive gearbox, requires very high ball bearing speed to achieve high wave generator input speeds, and must be very high precision to minimize backlash of the tooth engagement. The fixed radial position of the wave generator cam and bearings makes true zero backlash very difficult because manufacturing tolerances and heat expansion can cause closely fitted gears to bind.

Radial outward force from the mechanical wave generator in two or more positions will deform the flex spline into an elliptical shape with the smallest radius of curvature at the ellipse apexes (shown in FIG. 1 at the 12:00 and 6:00 positions). This smaller radius of curvature must be compensated for by the involute shape of the teeth so the flex spline teeth mesh with the circular ring gear teeth without interference. Creating gear teeth with conjugate motion with all of these challenges is extremely difficult, especially with a flexible member which changes shape slightly under load. The result is typically an undesirable amount of noise and vibration, especially as torque increases and the elliptical shape becomes asymmetrical.

FIG. 2 shows a non-toothed flex spline with a conventional mechanical wave generator cam applying a radially outward force applied to the flex spline at 12:00 and 6:00. The result is a point of contact between the flex spline and the outer ring at each of the two apexes (at the position where the radius of curvature of the flex spline is the smallest anywhere on the flex spline). The involute tooth form of a conventional harmonic drive must compensate for this reduced radius to achieve conjugate motion. In addition, when a torque is transferred through the flex spline, the elliptical shape is deformed asymmetrically, and the tooth form will therefore no longer be conjugate. This is believed to be one of the main reason why harmonic drive gear systems tend to emit gear noise and vibration, especially at higher loads when the flex spline is asymmetrically deformed.

Musser U.S. Pat. No. 2,906,143 discloses a rotating cam-driven harmonic drive and describes a number of different variations and ways to propagate the wave form. Poro U.S. Pat. No. 5,016,491 also shows a flex spline with teeth on the ID and outer diameter OD surfaces. A benefit of such a configuration is to eliminate the need for a flexible coupling between a single set of teeth (the teeth most commonly being on the OD of the flex spline in the prior art) to a reference or output member. When only an inner or outer tooth array is used in the prior art, torque transfer to a housing member is commonly done with a flexible (and commonly cylindrical) canister. The inner-outer tooth configuration provided in Poro provides the potential benefits of smaller axial width and simple construction because it can eliminate the need for the axial length of a flexible canister coupling. Harmonic drives have an inherent efficiency challenge that results from a high number of teeth which must slide on each other at the full output torque. The combination of this high sliding speed and high contact pressure causes a harmonic drive with a conventional tooth form to produce considerably higher internal friction as compared to a multi-stage planetary gearbox, for example, where the final stage will have high contact pressure but is operating at lower speed.

This inherently high friction loss is even more significant in an inner-outer toothed flex spline as provided by Musser and Poro because there are approximately twice as many teeth sliding at the contact pressure necessary to achieve the final output torque. If this inefficiency can be overcome, other benefits such as very low inertia and a large center through-hole can be realized.

### BRIEF SUMMARY

In an embodiment, there is disclosed a torque transmitting device comprising an outer ring having lobes; a flexible spline having an inner surface and an outer surface, the flexible spline having lobes on the outer surface of the flexible spline configured to mesh with the lobes on the outer ring; and a force applying element which holds the flexible spline in a shape conforming in curvature to the outer ring at two or more apexes at which the flexible spline contacts the outer ring.

A torque transmitting device comprising: an outer ring having lobes; and a flexible spline having an inner surface and an outer surface, the flexible spline having lobes on the outer surface of the flexible spline configured to mesh with the lobes on the outer ring; and a force applying element which holds the flexible spline in a shape conforming in curvature to the outer ring at two or more apexes at which the flexible spline contacts the outer ring.

A torque transmitting device comprising: an outer ring having lobes; and a flexible spline having an inner surface and an outer surface, the flexible spline having lobes on the outer surface of the flexible spline configured to mesh with the lobes on the outer ring, the lobes on the outer surface of the flexible spline having a lobe tip width to lobe height ratio of 2:1 or greater.

A torque transmitting device comprising: an outer ring having lobes; and a flexible spline having an inner surface and an outer surface, the flexible spline having lobes on the outer surface of the flexible spline configured to mesh with the lobes on the outer ring; a force applying element which holds the flexible spline in a shape that causes it to contact the outer ring at two or more apexes; and an array of electromagnetic elements arranged to arranged to propagate the apexes of the flexible spline when the electromagnetic elements are energized sequentially, the electromagnetic elements comprising permanent magnets and electromagnets having cores and coils, the permanent magnets and electromagnets being arranged so that at least part of the flux from the permanent magnets passes through cores of the electromagnets when the coils of the electromagnets are not energized, and at least some portion of the flux from the permanent magnets passing though the cores of the electromagnets is redirected through the flexible spline when the electromagnets are energized in opposition to the flux of the permanent magnets.

A strain wave torque transfer device comprising: a lobe ring; a flex spline meshed with the lobe ring; a wave generator; and features on the flex spline that sensed to indicate absolute position for greater than one output rotation.

A strain wave gear reducer with two or more magnets or sets of magnets diametrically opposed gear mesh zones that result from the somewhat elliptical elastic deformation of the strain wave member as a result of magnetic attraction of the strain wave member inward toward two more electro and/or permanent magnets, the magnets are housed in a member which is rotationally attached to the housing so the magnets rotate around an axis, in which rotation of this rotating member causes the magnetic attraction to the strain wave member to advance rotationally, causing the elastically deformed shape of the strain wave member to propagate in the direction of the magnet rotation and a coupling (such as a flexible coupling or rolling or sliding coupling) between the strain wave member and an output member transmits torque from the rotation of the strain wave member to the housing.

A strain wave gear device with two or more magnets which rotate around a common axis and are arrayed at or near 180 degrees to each other, in which the magnets exert an attraction force on the strain wave gear member to cause the normally circular shape to become somewhat elliptical, this somewhat elliptical shape resulting in the gears on the longer radial dimension at any given time, to mesh with the fixed outer gear teeth, and the rotation of the magnets causing the elliptical shape to rotate with the magnets, whereby the strain wave itself will rotate at a rate which is determined by the difference in the gear teeth of the strain wave and fixed gear.

A deflection wave gear reducer with two or more magnets or sets of magnets diametrically opposed gear mesh zones that result from the somewhat elliptical elastic deformation of the flexible ring as a result of magnetic attraction of the deflected flexible ring inward toward two more electro and/or permanent magnets. The magnets are housed in a member which is rotationally attached to the housing so the magnets rotate around an axis. Rotation of this rotating member causes the magnetic attraction to the flexible ring to advance rotationally, causing the elastically deformed shape of the deflected flexible ring to propagate in the direction of the magnet rotation. A coupling (such as a flexible coupling or rolling or sliding coupling) between the flexible ring and an output member transmits torque from the rotation of the flexible ring to the housing.

A deflected wave gear device with two or more magnets which rotate around a common axis and are arrayed at or near 180 degrees to each other. The magnets exert an attraction force on the flexible ring to cause the normally circular shape to become somewhat elliptical. This somewhat elliptical shape results in the gears on the longer radial dimension at any given time, to mesh with the fixed outer gear teeth. The rotation of the magnets causes the elliptical shape to rotate with the magnets. The deflected wave itself will rotate at a rate which is determined by the difference in the gear teeth of the flexible ring and fixed gear.

A torque transmitting device comprising a first ring with axially aligned openings disposed around the first ring and a second ring with axially aligned openings disposed around the second ring and pins extending through corresponding axially aligned openings on the first ring and second ring.

An electromagnet winding comprising windings with fluid flow gaps between windings formed by out of plane or out of round windings.

A magnetic ring with rotational symmetry that provides an increased magnetic force on the flexible spline (FS) at points of the FS which are radially closer to said ring.

A flex spline torque transfer device with lobes on the inner and outer surface of the flex spline which mesh with an outer fixed lobe ring and an inner output lobe ring, and one or more permanent magnets all contribute the same polarity flux to a rotationally symmetrical distribution ring inside the flex spline.

A flex spline torque transfer device with one or more permanent magnets that all contribute the same polarity flux to a rotationally symmetrical distribution ring inside the flex spline.

A flex spline torque transfer device with one or more permanent magnets that all contribute the same polarity flux to a three phase, four pole stator on the outside of the flex spline.

A flex spline torque transfer device with one or more permanent magnets that all contribute the same polarity flux to a three phase, four pole stator on the inside of the flex spline.

In various embodiments, there may be included any one or more of the following features: Any of the features of the dependent claims.

These and other aspects of the device and method are set out in the claims, which are incorporated here by reference.

### BRIEF DESCRIPTION OF THE SEVERAL VIEWS OF THE DRAWINGS

Embodiments will now be described with reference to the figures, in which like reference characters denote like elements, by way of example, and in which:

FIG. 1 is a diagram illustrating a prior art harmonic drive;

FIG. 2 is a schematic diagram showing an exaggerated general shape of a flex spline with a prior art wave generator cam;

FIG. 3 is a schematic diagram showing a flex spline pulled into a wave shape with four areas of reduced curvature using magnets located radially within the flex spline;

FIG. 4 is a diagram illustrating a flexible lobed spline in its undeformed shape between outer and inner rings, the inner ring having magnets to deform the shape of the flexible spline;

FIG. 5 schematic partial view of an elastically deformed flex spline of the embodiment of FIG. 4 with sections of ring gears and flex spline lobes removed for illustrative clarity;

FIG. 6 is a close-up view of a contact area of the flexible spline with the outer ring of the embodiment of FIG. 5 showing conformation of the flexible spline to outer ring curvature;

FIG. 7 is a close-up view of a contact area of the flexible spline with the inner ring of the embodiment of FIG. 5 showing conformation of the flexible spline to inner ring curvature;

FIG. 8 is close-up view of a transition zone of the embodiment of FIG. 5 where the flexible spline has a smaller radius of curvature;

FIG. 9 is close-up image of a contact area of the flexible spline with the outer ring of the embodiment of FIG. 5 showing strain in white;

FIG. 10 is a close-up image of the contact area of the flexible spline with the outer ring as shown in FIG. 9, but with torque now being provided;

FIG. 11 shows a partial view of the embodiment of FIG. 5 showing contacts of flex spline lobes with inner and outer ring lobes with strain in white;

FIG. 12 shows contacts of flex spline lobes with inner and outer ring lobes with torque applied with strain in white;

FIG. 13 is a close-up image of the contact area of the flexible spline with the inner ring showing strain as in FIG. 9;

FIG. 14 shows the same view as in FIG. 13 but with torque applied;

FIG. 15 shows an embodiment with a flexible spline between inner and outer rings with electromagnets arranged radially outside of the flexible spline to propagate a deformation wave of the flexible spline;

FIG. 16 shows the dominant permanent magnet and electromagnet forces on the flexible spline of FIG. 12;

FIG. 17 shows the embodiment of FIG. 15 with the permanent magnets also shown;

FIG. 18 shows an isometric view of the embodiment of FIG. 17;

FIG. 19 shows a front view of a simplified exemplary embodiment;

FIG. 20 shows an isometric view of the embodiment of FIG. 19;

FIG. 21 shows an isometric section view of the embodiment of FIG. 19;

FIG. 22 shows an isometric close-up section view of the embodiment of FIG. 19;

FIG. 23 shows the view of FIG. 22 with outer covers removed and an electromagnet flux path shown by arrows;

FIG. 24 shows electromagnet side plates of the embodiment of FIG. 19 showing cutouts which act as flux resistors;

FIG. 25 shows a schematic view of an example electromagnet commutation system;

FIG. 26 shows an example strain close-up view of a contact area between the flexible spline and the inner ring in an embodiment where lobes contact on the outer surface of the lobes of the flex ring rather than the inner surface;

FIG. 27 shows a prior art epicyclic drive;

FIG. 28 is a schematic diagram showing the distortion of a flexible spline due to magnetic force;

FIG. 29 is a close-up view of the flexible spline of FIG. 28 showing an exemplary tooth profile;

FIG. 30 is a close-up view of a contact area between the flexible spline and outer ring;

FIG. 31 is a close-up view of an area where the teeth of the flexible spline of FIG. 29 are out of phase with the teeth of the outer ring;

FIG. 32 is a finite element analysis of an example flexible spline and outer ring;

FIG. 33 is a close-up finite element analysis of a transition zone and contact area in an embodiment with slightly shorter teeth and slightly smaller tooth pitch distance than shown in FIG. 32;

FIG. 34 is a close-up finite element analysis of a contact area in an embodiment with slightly shorter teeth and slightly smaller tooth pitch distance than shown in FIG. 32;

FIG. 35 shows an example torque transfer device in which a spline gear is flexibly attached to a housing using buckled rods;

FIG. 36 is a schematic diagram showing an example of how a flex spline in a differential harmonic embodiment could interface with fixed and output gears;

FIG. 37 is a section view of a flex spline in an embodiment corresponding to FIG. 36;

FIG. 38 is an isometric view of a flex spline of the embodiment of FIG. 37;

FIG. 39 is a side view of a flex spline of the embodiment of FIG. 37;

FIG. 40 shows an exterior view of an embodiment of a differential harmonic drive with symmetrical gears on either side of a central gear on the flex spline;

FIG. 41 shows a section view of the embodiment of FIG. 40;

FIG. 42 shows a partially disassembled section view of the embodiment of FIG. 40;

FIG. 43 shows a further disassembled section view of the embodiment of FIG. 40;

FIG. 44 shows a partially disassembled and exploded section view of the embodiment of FIG. 40;

FIG. 45 shows a section view of a harmonic cup embodiment;

FIG. 46 is a schematic diagram showing an embodiment of the flex spline canister of FIG. 45 using a magnetic rotating cam;

FIG. 47 is a schematic diagram showing differential flex spline canister variation with high aspect ratio gears using a rotating rolling cam;

FIG. 48 is a schematic diagram showing another differential flex spline canister variation with high aspect ratio gears using a rotating rolling cam;

FIG. 49 is a schematic diagram showing a flex spline canister variation using a magnetic non-rotating cam;

FIG. 50 is a simplified schematic view of a flexible ring deflected by a magnetic cam;

FIG. 51 is a simplified exploded schematic view of a torque transfer device using a flexible ring deflected by a magnetic cam as in FIG. 50;

FIG. 52 is a schematic section view of a torque transfer device showing a rotating magnetic cam driven by an external rotary input;

FIG. 53 is a schematic section view of a torque transfer device showing a rotating magnetic cam driven by a drive internal to the torque transfer device;

FIG. 54 is a section view of an exemplary embodiment of a rotating magnetic cam torque transfer device;

FIG. 55 is a section view of an embodiment of a non-commutated mag ring with an axial flux path through the flexible spline (FS);

FIG. 56 is a section view of another embodiment of a non-commutated mag ring with an axial flux path through the FS;

FIG. 57 is a section view of an embodiment of a non-commutated mag ring with a soft magnetic material distribution ring;

FIG. 58 is a section view of a radial permanent magnet (PM) non-commutated (NC) mag ring;

FIG. 59 is a section view of a circumferential PM NC mag ring;

FIG. 60 is a simplified schematic partial section view of an embodiment of a FS with a set of non-commutated permanent mag rings with electromagnets allowing a safety brake effect when power is lost;

FIG. 61 shows the view of FIG. 60 in which the electromagnets are activated to engage the FS;

FIG. 62 shows a portion of a flexible spline having detents suitable for use in the embodiments FIGS. 60-61 fully engaged with an outer lobe ring;

FIG. 63 shows a detail view of the flexible spline of FIG. 62 in a disengaged state at the 12:00 position;

FIG. 64 shows a detail view of the flexible spline of FIG. 62 in a disengaged state at the 9:00 position;

FIG. 65 shows a side view of an exemplary embodiment of an electromagnet (EM) coil combined with PMs in such a way as to accomplish a primarily axial flux path thru the FS with reduced electrical energy required to energize the EMs;

FIG. 66 shows an isometric view of the embodiment of FIG. 65;

FIG. 67 shows a section isometric view of the embodiment of FIG. 65;

FIG. 68 shows another isometric view of the embodiment of FIG. 65;

FIG. 69 shows a detail section isometric view of the embodiment of FIG. 65;

FIG. 70 shows an isometric view of an embodiment with side rings omitted and all PMs in the same alignment;

FIG. 71 shows an isometric view of an embodiment with side rings omitted and with every second set in reverse polarity alignment;

FIG. 72 shows an isometric view of an embodiment in which a side iron connects every second PM on each axial end;

FIG. 73 shows a section view of the embodiment of FIG. 72 with EMs energized;

FIG. 74 shows a section view of an example of a circumferentially aligned EM-PM stator;

FIG. 75 shows the same configuration as FIG. 74 with the sectioned EM coil energized;

FIG. 76 is an isometric view of a circumferential PM configuration with alternating PMs and no flux linkage between endplate on an axial end;

FIG. 77 shows a section view of a stator with integrated lobes for engagement with the FS;

FIG. 78 is a perspective view of a flex spline actuator with pin couplers;

FIG. 79 is a perspective view of a part of a flex spline actuator with pin couplers coupling a flex spline with a part of a fixed housing, with an output ring;

FIG. 80 is a side view of pin couplers showing openings in a fixed housing, with the pin couplers in neutral position in ovoid holes;

FIG. 81 is a side view of pin couplers, with pin couplers biased to a lower side position in an ovoid hole of a flex spline, showing teeth of the flex spline schematically;

FIG. 82 is a side view of pin couplers, with pin couplers in a neutral position in an ovoid hole of a flex spline, showing teeth of the flex spline schematically;

FIG. 83 shows a side view of a flex spline with pin couplers in various positions around the flex spline;

FIGS. 84 and 85 show segments of FIG. 83;

FIGS. 86-91 show examples of pin coupled flex splines;

FIG. 92 shows an axial view of a partially assembled stator with an example winding;

FIG. 93 shows an isometric view of the stator of FIG. 92;

FIG. 94 shows a wiring diagram for axially aligned stators;

FIG. 95 shows a simplified partial sectioned assembly of dual split 90 degree phase shifted stator sets, each with a four pole three phase winding;

FIGS. 96, 97 and 98 show porous coils for electromagnets;

FIG. 99 shows a cooled electromagnetic coil with flow paths provided by non-round wires;

FIGS. 100-102 show an encoding system for closed loop operation of an actuator; and

FIGS. 103-107 show an exemplary actuator.

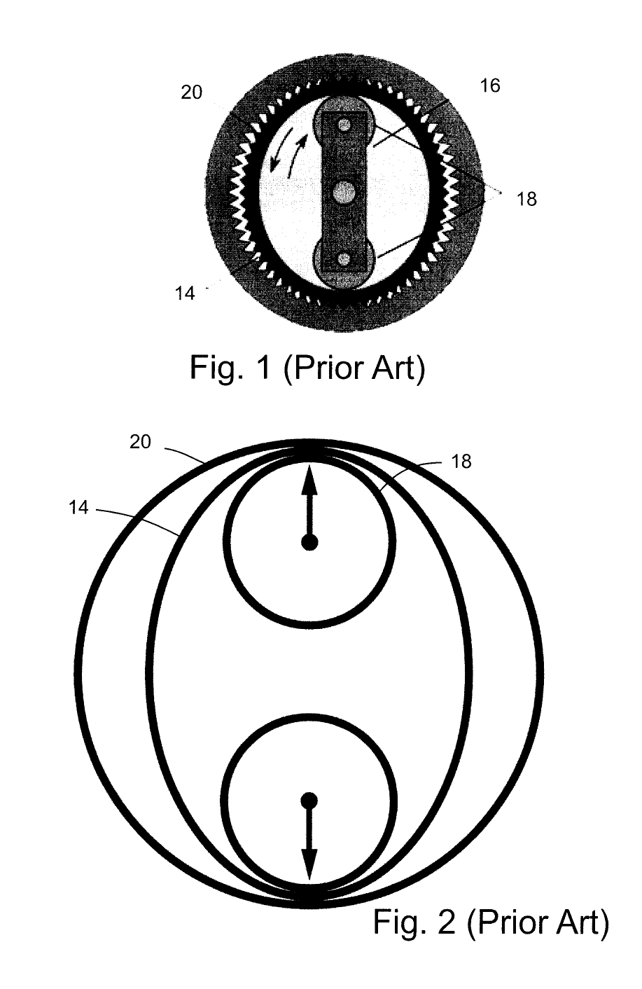

EM=Electromagnet, FS=Flex spline, ID=Inner diameter, OD=Outer diameter, PM=Permanent magnet, TDC=Top dead center, BDC=Bottom dead center, N=North, S=South, mag ring=magnet ring, ILR=inner lobe ring, OLR=inner lobe ring

### DETAILED DESCRIPTION

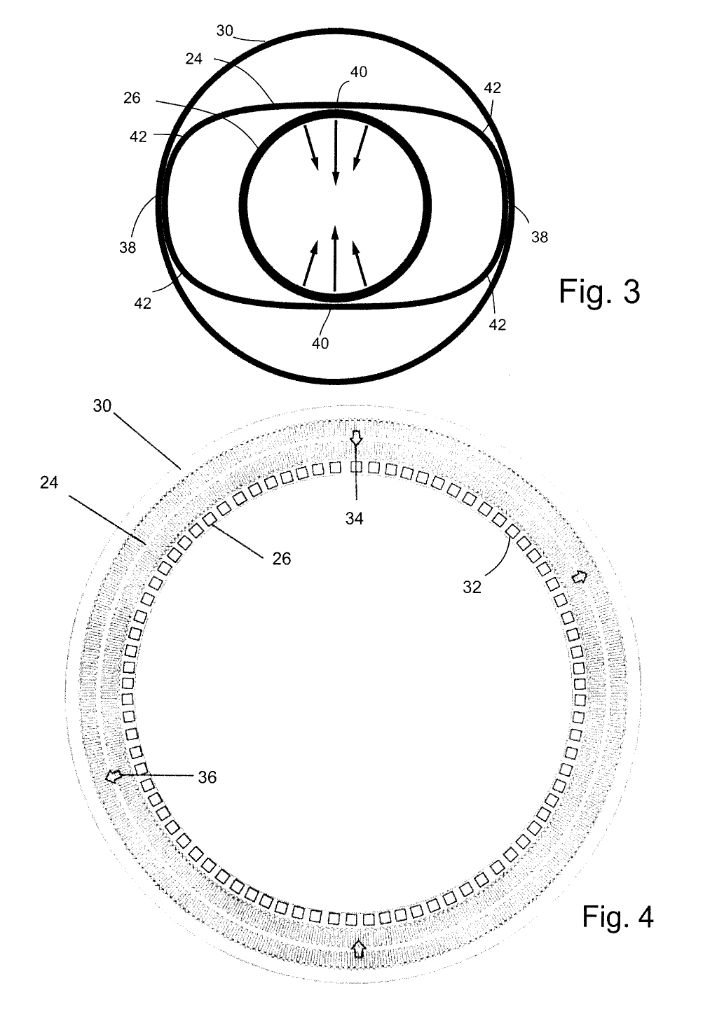

Disclosed in a first set of embodiments is a torque producing device with elongated lobes on the inner diameter (ID) and outer diameter (OD) of a rectelliptical flexible spline. Instead of a mechanical wave generator pushing outwards at two or more points on the flex spline, as with a conventional harmonic drive type of actuator, the present device uses permanent magnets (and/or electromagnet/s, but permanent magnets are preferred) to pull the flex spline inwards or outwards at two or more positions. In an initial embodiment schematically in FIG. 3, the magnets are located radially within the flex spline and pull inwards. This “magnetic cam” exerts a greater force on the flex spline at the positions of the flex spline which are closest to the magnets. For this reason, the permanent magnet ring 26 pulling inward on the flex spline 24 can be stationary because the flex spline is naturally pulled in toward the permanent magnet in two (or more, but two is preferable for many applications) opposing positions regardless of the propagated position of the flex spline wave. This pulling in of the flexible spline 24 in two positions results in the flexible spline bending outwards between the positions that it is pulled in, to contact outer ring 30. This outward bend tends to result in a lower curvature at the apexes of the flex spline matching the curvature of the outer ring.

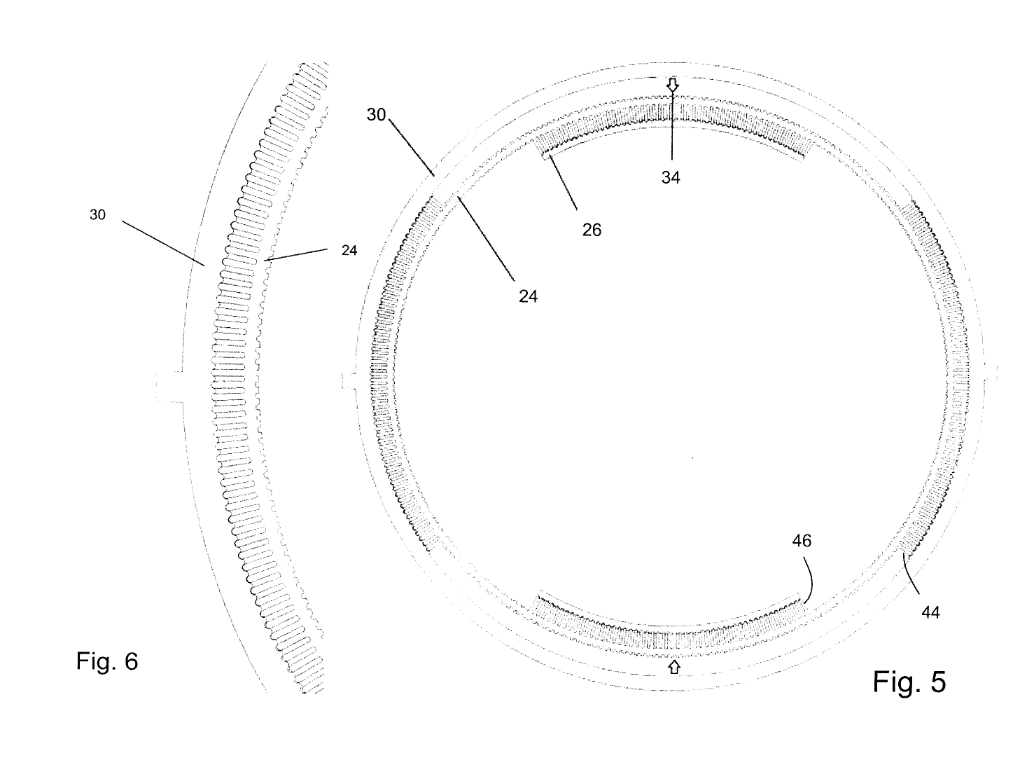

FIG. 4 shows an exemplary embodiment of (undeformed shape of) a complete flexible lobe spline of the present device. This image shows one of a number of different non-commutated permanent magnet configurations described elsewhere in this disclosure. This image shows the location of the permanent magnet forces 34 but not the effect of these forces on the flex spline. When the flex spline is round and concentric with the magnet ring, the radially inward force of the permanent magnets 32 on the FS is equal in all positions. By applying an external force at the 12:00 and 6:00 positions during assembly, as indicated in this image, the flex spline will elastically deform inwardly in these locations as shown in FIG. 5. An additional force 36 is applied by electromagnets (not shown) to propagate the deformation of the flex spline. Once the flex spline has been pulled inward in two places, as shown in FIG. 5 and others, the inner lobes of the flex spline mesh with the lobes of the inner lobe ring, and prevent further radially inward deflection. The “inward apex” at the 12:00 and 6:00 positions is then free to propagate rotationally depending on other forces acting on the flex spline. The permanent and/or electromagnetic field pulling inward on the flex spline does not necessarily need to rotate. The fact that the magnetic force falls off exponentially as the air gap increases, insures that the flex spline will always maintain its deformed shape as long as external forces do not overpower the permanent magnets.

In contrast to the two areas of reduced curvature of an elliptical shape of a conventional harmonic drive flex spline, the resulting shape of the present device has four areas of reduced curvature. A similar shape has been described as a “rectellipse” on the wolfram math web page.

A schematic flex spline with no lobes is shown in FIG. 3. It can be seen in this image that the inward force of the permanent magnet ring at 12:00 and 6:00 result in a radially outward displacement of the flex spline at 3:00 and 9:00. This radially outward displacement results in a contact of the flex spline with the outer ring such that the flex spline curvature at the contact conforms to the curvature of the outer ring. This curvature is larger in radius than the four minimum radius curvatures on either side of the contact area and results in the flex spline adopting the same radius of curvature of the ID of the outer ring in the contact areas.

Another description of a flex spline shape in an embodiment of the current device is as follows (and shown in FIG. 4 and FIG. 5). In this embodiment, the flex spline contacts both an outer ring and an inner ring. In FIG. 5, outward facing flex spline lobes 44 mesh with outer lobe ring lobes at 3:00 and 9:00 and inward facing flex spline lobes 46 mesh with inner lobe ring lobes at 12:00 and 6:00. The flex spline shape, when elastically deformed by the non-commutated permanent magnet cam has:

1. A radius of curvature (×2) where the flex spline meshes with the outer lobe ring at locations 38 in FIG. 3 which is equal to the outer lobe ring radius of curvature. This “conformed” shape is preferably for the circumferential distance of three or more lobes, as shown in FIG. 6.

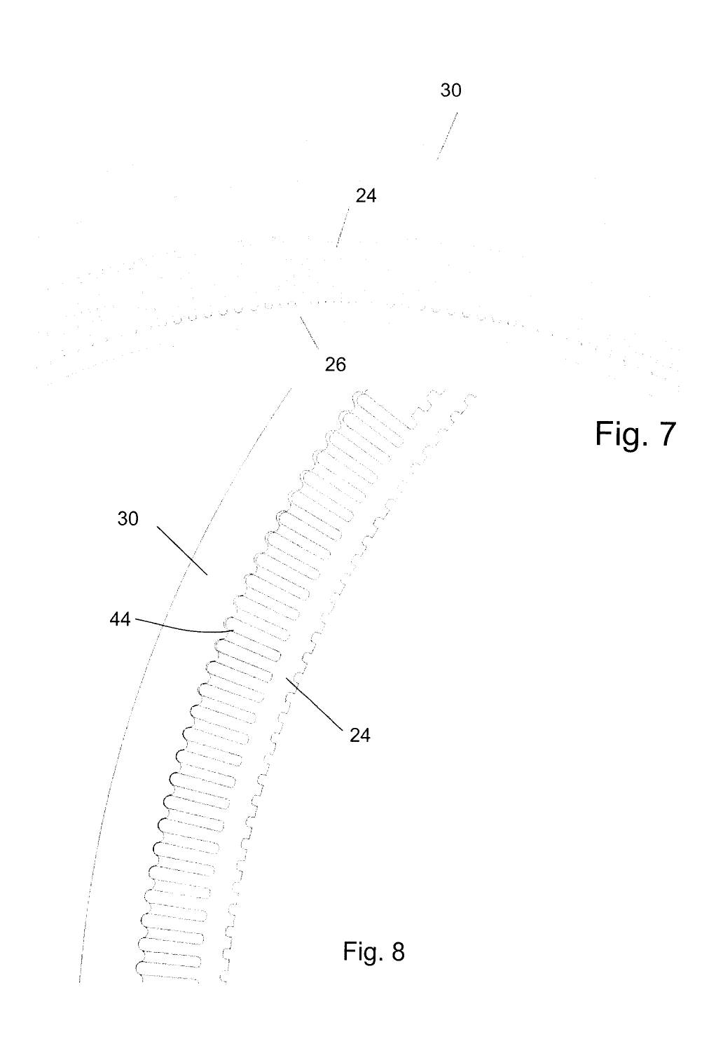

2. Another radius of curvature occurs where the flex spline meshes with the inner lobe ring at locations 40 in FIG. 3. This radius of curvature of the flex spline is, preferably, for three or more lobes, and preferably equal to the radius of curvature of the inner lobe ring, as shown in FIG. 7.

3. A third radius of curvature happens just before and after the flex spline conforms to the outer lobe ring at locations 42 in FIG. 3. This reduced radius of curvature zone results from the inward force of the permanent magnets causing a radially outward displacement of the flex spline at two positions 90° from the shortest radial dimension of the deflected flex spline which results in contact between the outer lobes of the flex spline and the outer lobe ring. The smaller radius of curvature on either side of this flex spline-to-outer-lobe-ring-lobe mesh, causes the lobes 44 on the outer surface of the flex spline to splay apart, as shown in FIG. 8. This zone of smaller radius of curvature allows lobes to “zipper” into engagement with minimal or no interference.

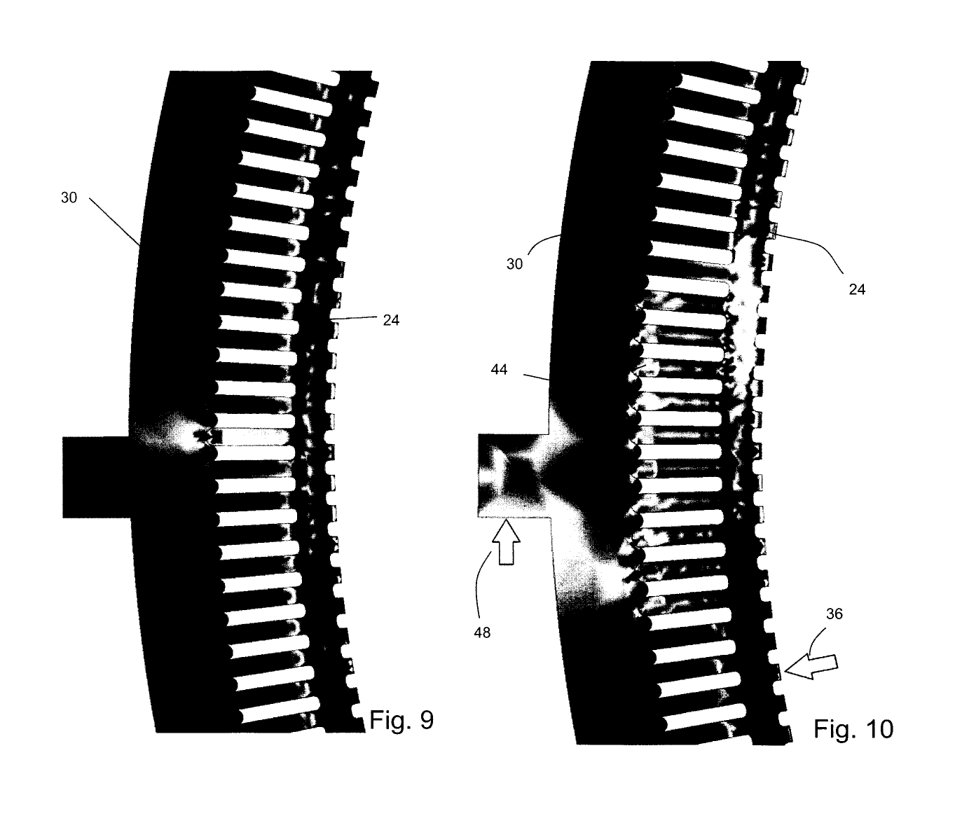

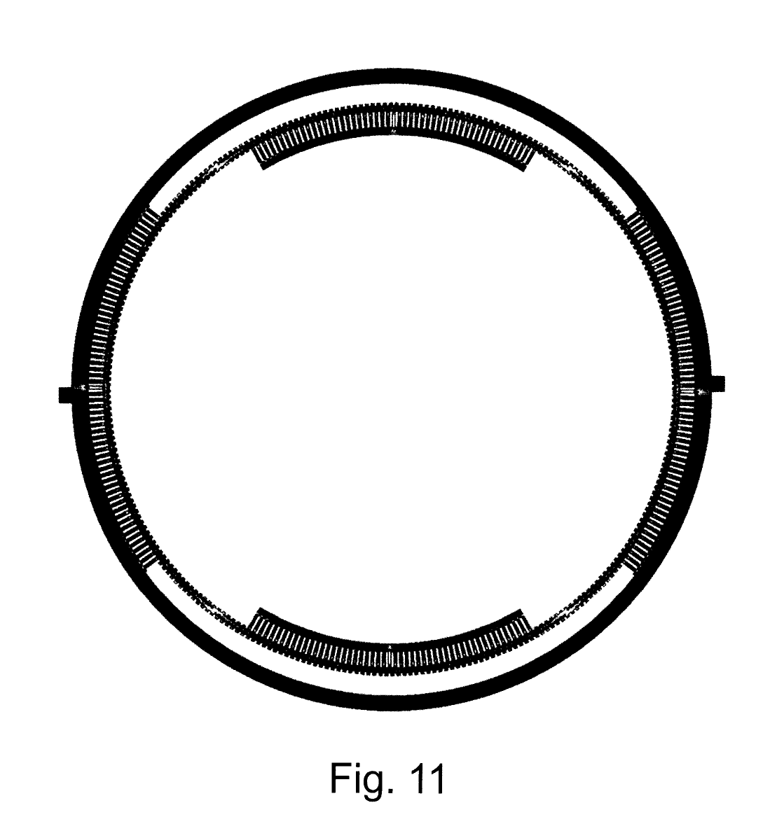

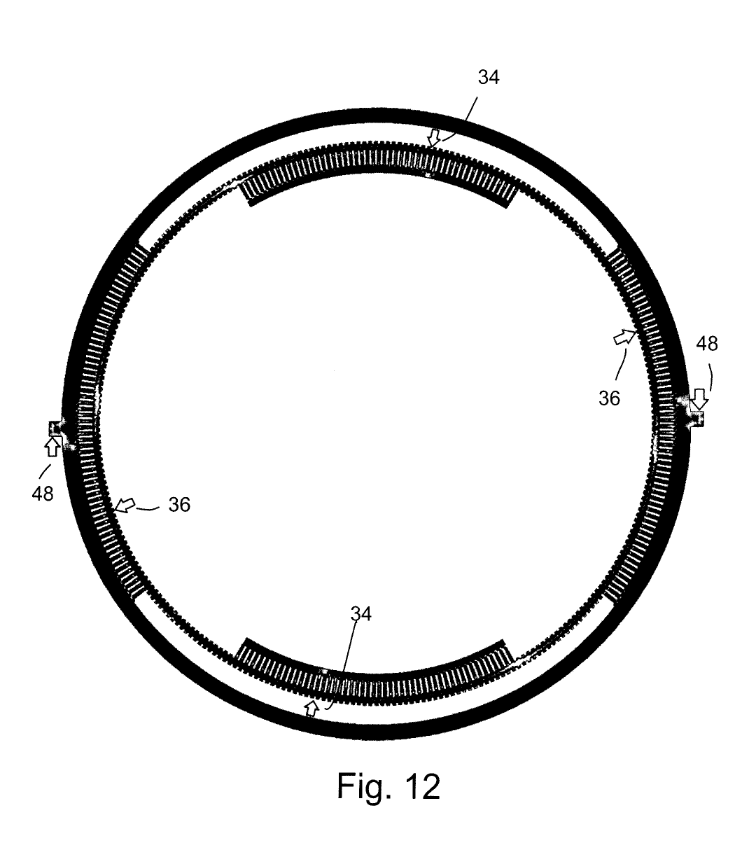

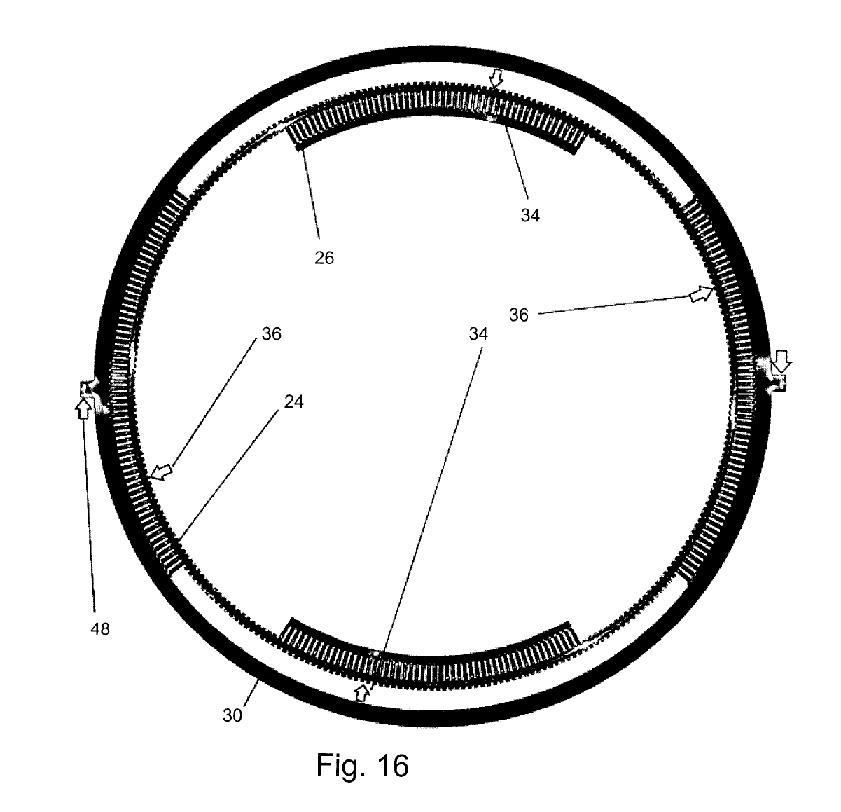

This splaying of the lobes at this third and smallest radius of curvature is used to the advantage of this device as follows: In order to reduce or eliminate backlash between the flex spline outer lobes and the outer lobe ring lobes, the space between the flex spline lobes can be slightly less than the width of the outer lobe ring lobes. When fully meshed, this can result in a pinching or circumferential preloading of the flex spline lobes on either side of the center of the outer lobe ring contact areas (lobe roots). In FIG. 9, white areas indicate contact of flex spline lobe tips with outer ring lobe roots when only the permanent magnet cam is in effect. Note that contact is only at the lobe roots for three to five lobes in this example. The flex spline lobes do not contact the outer lobe ring on their side faces. Also note that the flex spline lobes on either side of the center lobe are contacting at a slight angle inward toward each other. This inward bias illustrates the opposing force of these lobes if designed according to one form of the present device where the FS lobes are circumferentially preloaded in opposing circumferential directions on either side of the mesh zone center. This effect can be used to reduce or eliminate backlash. By causing the flex spline outer lobes to splay apart at the smaller radius areas (the third radius of curvature above), it is possible with the present device, to minimize or eliminate contact between the outer flex spline lobes and the outer lobe ring lobes until the outer flex spline lobe tips nearly completely mesh (or “bottomed out”) in the outer lobe ring lobe roots. The advantages of this include minimal sliding for high efficiency, and low friction. FIG. 10 shows contact where the electromagnets are also active to provide torque. With the addition of the electromagnetic force 36 and an opposing torque load shown by the arrow indicated with reference numeral 48, additional flex spline lobes are brought into contact to transmit this torque from the inner lobe ring through the flex spline to the outer lobe ring. Note that the contact is still generally at or near the roots of the outer lobe ring lobes, indicating that there is very little sliding contact between the flex spline lobes and outer ring lobes during torque transfer and FS wave propagation. This reduction of sliding contact when the FS lobes are coming into or exiting fully meshed contact with the lobe rings can provide for a significant reduction in friction as compared to the prior art. FIG. 11 shows a finite element analysis partial view of the embodiment of FIG. 5 showing contacts of flex spline lobes with inner and outer ring lobes and strain shown in white as in FIG. 9. FIG. 12 shows a finite element analysis of a partial view of the embodiment of FIG. 5 showing contacts of flex spline lobes with inner and outer ring lobes with torque applied with strain in white as in FIG. 10. The arrows here (and in FIG. 16) show an outward force from the electromagnets and an inward force from the permanent magnet cam. Although the EM arrows are on the ID of the FS, they are illustrating an attraction force of the EMs on the OD of the FS as detailed elsewhere in this disclosure. Likewise, although the PM arrows are on the OD of the FS, they are illustrating an attraction force of the EMs on the OD of the FS as detailed elsewhere in this disclosure.

Conforming the flex spline to the radius of curvature of the outer lobe ring has another significant advantage in that it allows two or more outer flex spline lobes, at each lobe mesh position (typically 180 degrees apart and approximately 90 degrees from the smallest radial deflected position as generated by the permanent magnet cam) to be fully meshed with the outer lobe ring lobes at all times. This provides a very smooth operating principle which functions much more like a rolling contact than a typical geared contact of a harmonic drive or other geared system. This conformed contact also allows the outer FS lobe tips to be radially preloaded against the outer lobe roots which can reduce or eliminate backlash even if the FS lobe tips are not circumferentially preloaded as described above.

The preloaded characteristic of the flex spline lobes against the outer lobe ring lobes makes this device relatively insensitive to manufacturing intolerances and heat expansion. In other words, if the flex spline is manufactured larger or smaller than ideal, or if the flex spline expands more or less than the outer lobe ring due to heat expansion, the flex spline will simply deflect a bit more or a bit less in the non-contacting areas between contact zones without binding or losing preloaded contact with the outer lobe ring to compensate for these dimensional changes.

The elongated shape of the lobes also allows them to flex slightly when they are fully meshed with the outer lobe ring lobes. This is important for two reasons:

a. It allows for a true zero backlash lobe interaction, because the elongated lobes can flex instead of binding.

b. It allows more consistent load sharing between the lobes to compensate for manufacturing imperfections.

The difference in the number of lobes on the outer surface of the flex spline and the number of lobes on the inward facing surface of the outer lobe ring is preferably two (2) with the flex spline having two fewer lobes. The example shown in FIG. 4 has a lobe count of 298 on the outer surface of the flex spline and a lobe count of 300 lobes on the inward facing surface of the outer lobe ring. More or fewer numbers of lobes can be used. These numbers are given as examples only. Many other lobe numbers and combinations of lobe numbers are possible and anticipated by the inventor. Also, it is possible to have a greater or lesser difference in the number of lobes between the flex spline and the outer lobe ring. This includes, but is not limited to, a 4 lobe difference (with the outer lobe ring have 4 more lobes than the flex spline), a 6 lobe difference (with the outer lobe ring having 6 more lobes than the flex spline), etc. The flex spline outer lobes and the outer lobe ring lobes can also be the same number (e.g., 300 and 300 etc.). This is not preferable with the present device because a two lobe difference is generally more practical with regard to achieving low sliding between the lobes when they mesh, but a zero lobe difference is possible and may have certain advantages in some applications. It is even possible to have a flex spline with a greater number of lobes than the outer lobe ring. This is only possible if the flex spline and flex spline lobes are designed to, and allowed to, flex considerably.

Table 1 shows a number of possible lobe number combinations. Many other combinations are possible and are anticipated by the inventor. These are given as non-limiting examples only.

TABLE 1

| | | | |
|---|---|---|---|
| Number of lobes on OLR | 300 | 456 | 576 |
| Number of lobes on outside of FS | 298 | 454 | 574 |
| Number of lobes on inside of FS | 149 | 227 | 287 |
| Number of lobes on ILR | 147 | 225 | 285 |
| Resulting reduction ratio | 49 | 75 | 95 |

Inner Lobe Mesh

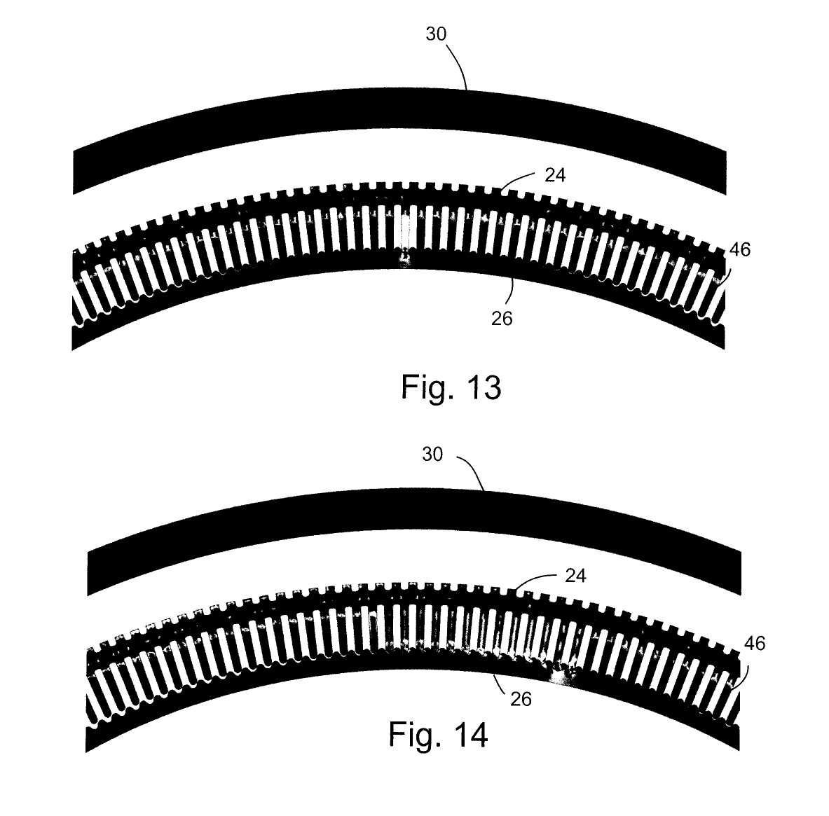

Embodiments with an inner lobe ring can use a similar strategy to transmit torque from the inward facing lobes of the flex spline to the outward facing lobes of the inner lobe ring. As the permanent magnet ring generates a radially inward force at two or more positions on the flex spline, the flexibility of the flex spline allows preferably three or more inwardly facing lobe tips of the flex spline to fully mesh with (or “bottom out” in) the outwardly facing lobe roots of the inner ring. FIG. 13 illustrates this, with three to five flex spline lobes 46 shown in contact with the inner ring lobes under permanent magnet force. White areas indicate contact of flex spline lobe tips with inner ring lobe roots when only the permanent magnet cam is in effect. Note that contact is only at the lobe roots for three lobes in this example. The flex spline lobes do not contact the inner lobe ring 26 on their side faces. Also note that the flex spline lobes on either side of the center lobe are contacting at a slight angle inward toward each other. This inward bias illustrates the opposing force of these lobes which can reduce or eliminate backlash. FIG. 14 shows the same view but with the addition of the electromagnetic force (as shown in FIG. 10) and an opposing torque load (also shown in FIG. 10) additional flex spline lobes 46 are brought into contact with the inner ring lobe roots to transmit this torque from the inner lobe ring 26 through the flex spline to the outer lobe ring 30. Note that the contact is still generally at or near the roots of the outer lobe ring lobes, indicating that there is very little sliding contact between the flex spline lobes and outer ring lobes during torque transfer. This provides a very smooth lobe mesh during wave propagation, with characteristics more akin to a rolling interaction than a typical geared interaction. The radially elongated (high aspect ratio) inwardly facing lobes on the flex spline splay apart as they approach the lobe mesh positions as a result of the radius of curvature increasing as compared to when the FS is in a non-deformed state. This can be used to prevent to avoid premature interference and so when they do mesh, one or more of flex spline inward lobes are preloaded against one or more other flex spline inward lobes on the opposite side of the center of each inner lobe mesh. This serves to reduce or eliminate backlash on the inner lobe mesh torque transfer areas.

It has been found by experimentation that many different lobe numbers can be used for the inner lobe features according to the principles of this device. The difference between the number of lobes on the inner surface of the flex spline and the outer surface of the inner lobe ring is preferably four (4) lobes for a total number of lobes on the inner ring of between 200 and 400, but the difference can be a greater or lesser number (such as, but not limited to, a six lobe difference, a two lobe difference, a zero lobe difference, or lobe number differences that include a greater number of lobes on the inner lobe ring than on the inner surface of the flex spline.

For consistent flexibility and material stress on the FS, it is preferable (although not necessary) to have the same number of lobes on the inside of the FS as on the outside of the FS. It has also been shown by experimentation that if the same number of lobes are used on the outside of the FS as on the inside of the FS that it is possible to achieve a low sliding interaction of the inner FS lobes with the inner lobe ring if the inner FS lobes skip over two inner lobe ring lobes during each wave (as compared to one outer lobe ring lobe per wave for the FS outer lobes). Alternatively the ID of the FS can have half as many lobes as the OD to achieve the same FAS to inner lobe ring ratio per wave propagation even though the inner FS lobes may only skip from one inner lobe ring lobe to the next inner lobe ring lobe on every FS wave propagation. In various embodiments, there may be fewer lobes on the inside than the outside of the FS. The ratio of number of inner lobes to outer lobes can be for example less than 90%, less than 80%, less than 70%, or less than 60%.

Note: if a three apex flex ring is used, the lobe number differences will be factors of three rather than two. Other numbers of apexes will require other lobe number differences.

Elongated Flex Spline Lobes

Other advantages of the elongated flex spline lobes include, but are not limited to, the following:

The air space between the lobes acts as an electrical insulator so if the present device is powered by electromagnetic force with the flux path primarily in the axial direction, the eddy currents in the flex spline will be reduced in the same way that laminations in electric motor reduce eddy current losses.

High aspect ratio lobes increase the cross-sectional area for reduced flex resistance while still allowing the required flexibility in the flex spline.

Power

The low separation force of the flexible lobe torque transfer principle as described here, allows the radially inward force of an array of permanent and/or electromagnets as shown in FIG. 4 to provide enough radially outward force (on one or the other side of 90° to the radially inward force) to maintain engagement of the OD of the flex spline lobes with the outer lobe ring and the ID of the flex spline lobes with the inner lobe ring.

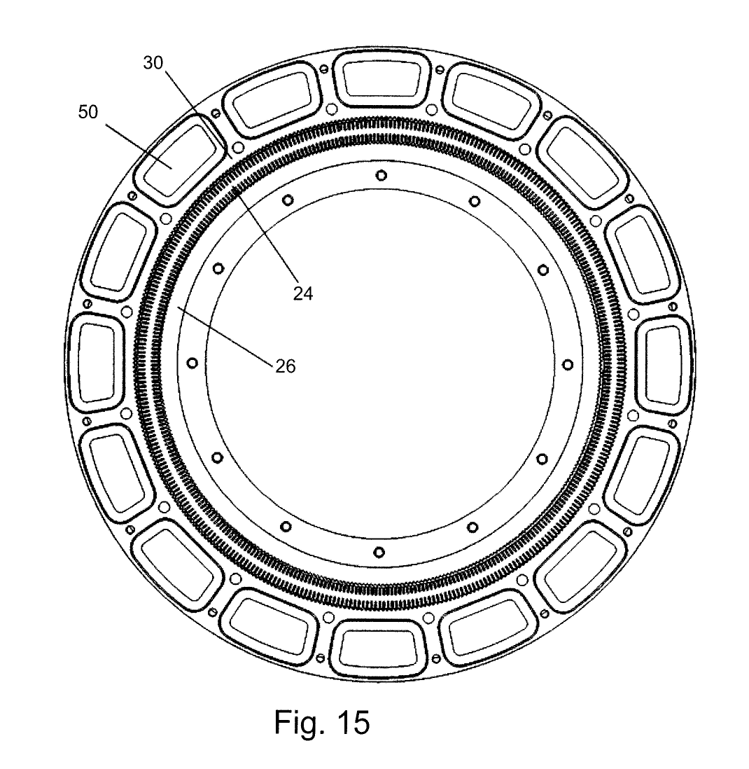

This eliminates the need for a mechanical wave generating cam as is common to, for example, a harmonic drive. It also eliminates the need for a rotating member to propagate the flex spline wave. Instead, electromagnetic force acting directly on the FS can be used to cause the flex spline wave to propagate. The flex spline, in this configuration, is made of a magnetic material such, but not limited to, steel. 4340 steel has good magnetic and mechanical properties and is considered an ideal material with regard to performance and cost effectiveness. To propagate the wave, an array of electromagnets 50 can in an embodiment be located around the outside of the flex spline, as shown in FIG. 15. By sequentially powering these magnets as follows, the wave form of the flex spline is propagated such that relative movement between the inner lobe ring and the flex spline and the outer lobe ring is accomplished.

In an exemplary embodiment of the present device, the inner lobe ring has 294 lobes, the inward facing lobes of the flex spline number 298, the outward facing lobes of the flex spline also number 298, and the outer lobe ring has 300 lobes. Two or more opposing electromagnets, on one rotational side of the flex spline lobe mesh with the outer lobe ring, are energized to create an attractive force which, if greater than the effect on the flex spline of the opposing torque on the output member of the device (for the embodiments using an inner lobe ring, the inner lobe ring will be referred to as the output ring, although the inner lobe ring could also be used as a fixed member, and note that in the stress analysis images the inner lobe ring is analyzed as the fixed member) then the flex spline wave apexes will propagate in the direction of the energized magnets. By sequentially commutating the magnets in one direction or the other, the flex spline waveform is caused to propagate in that direction. The flex spline itself will rotate but at a much lower rate depending on the ratio of the flex spline lobe number relative to the fixed lobe ring member (in this disclosure, the outer lobe ring will be referred to as the fixed or reference member).

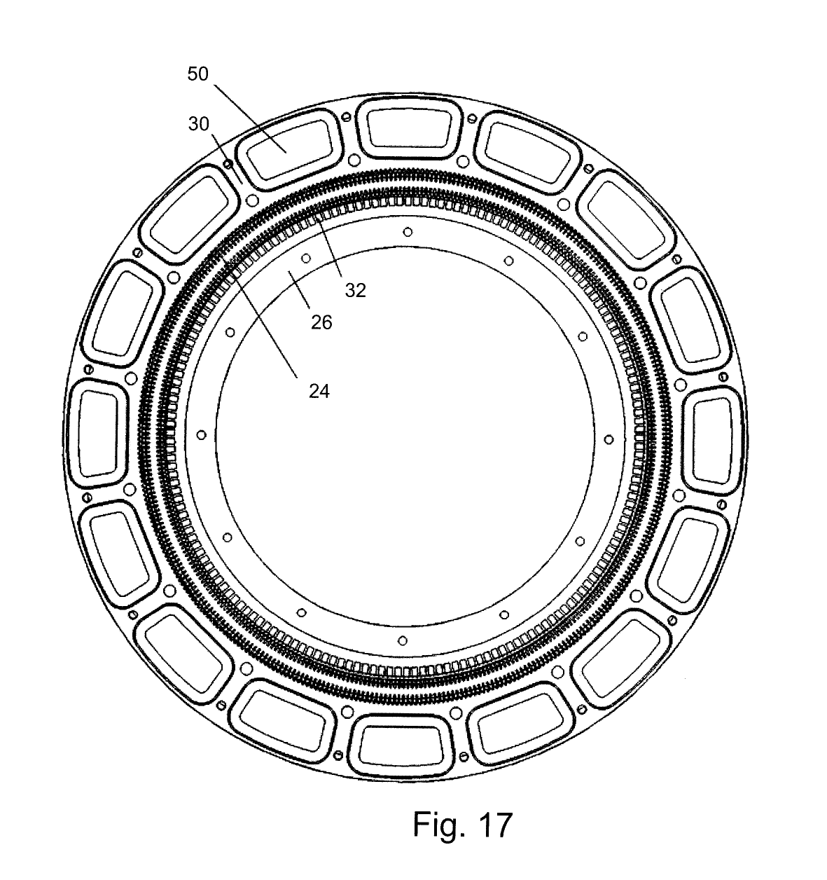

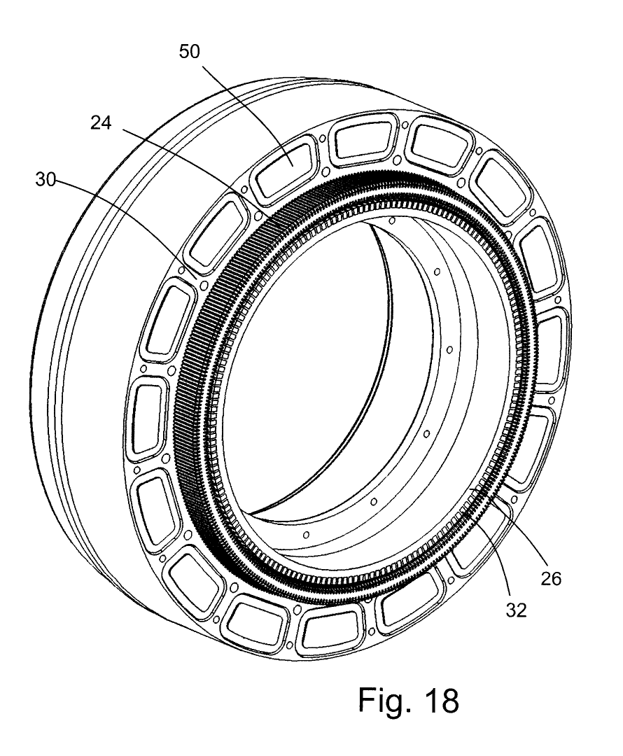

As shown in FIGS. 15, 17 and 18, an electromagnet array is preferably arranged to act on a cylindrical area of the flex spline OD, preferably co-radial with the flex spline lobe tip arc centers (see FIG. 16) on both axial ends of the lobed torque transfer area between the flex spline and the outer lobe ring. Similar cylindrical areas on the ID of the flexible spline provide maximum surface area for the permanent magnet array. The permanent magnet array can be arranged in many different ways that are anticipated by the inventor. An exemplary embodiment is shown here with laminated cores and copper coils sandwiched between magnetic side plates made of material such as but not limited to laminated steel. The coils are located inside axial pockets in the outer ring housing member. In an exemplary embodiment, air passageways are provided through the side plates on one side of the magnets to the fluid chambers surrounding the electromagnets. The electromagnetic coils are preferably made of copper and are preferably manufactured in such a way as to provide airflow radially inward across the coils toward the core. The core is preferably constructed with an array of fluid channels which allow this airflow to escape through openings in the opposite side plate. By pressurizing the annular chamber on one side of one side plate, fluid is caused to flow into the chambers surrounding electromagnetic coils, where it flows radially inward across the coils, removing heat from the coils, and then axially outward along the core and the openings in the opposite side plates and into the lower pressure annular chamber on the opposite axial and the torque motor.

The fixed and output members of the torque can be attached to different components of a robot other device which requires rotary motion. Example of a SCARA robot arm with unique characteristics and which uses the present actuator to provide a lightweight high speed system.

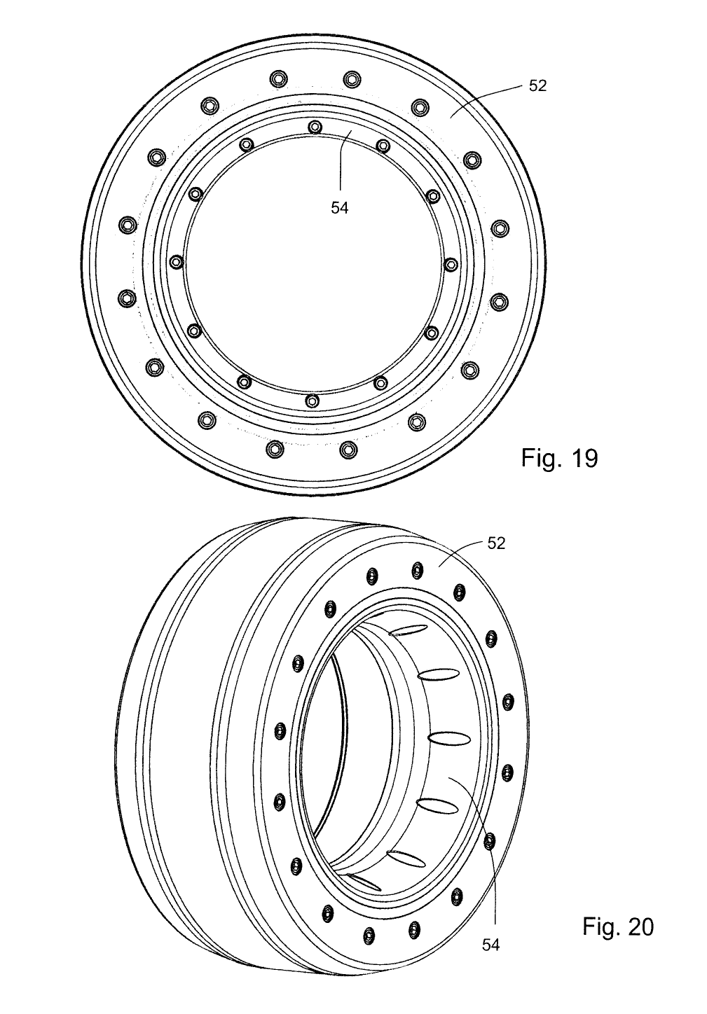

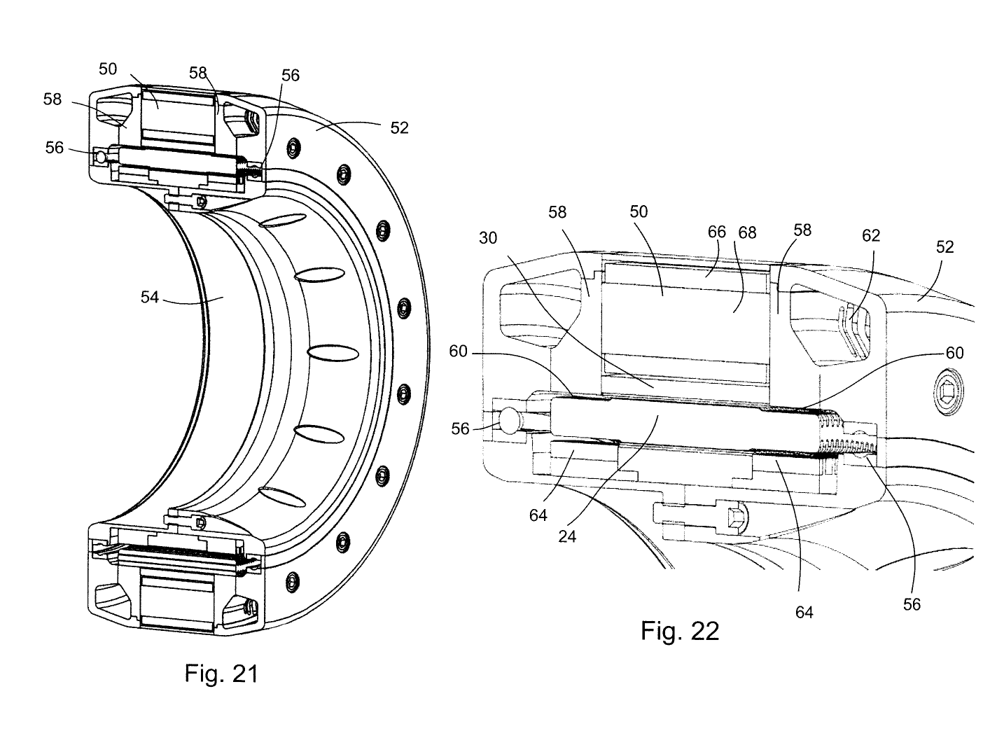

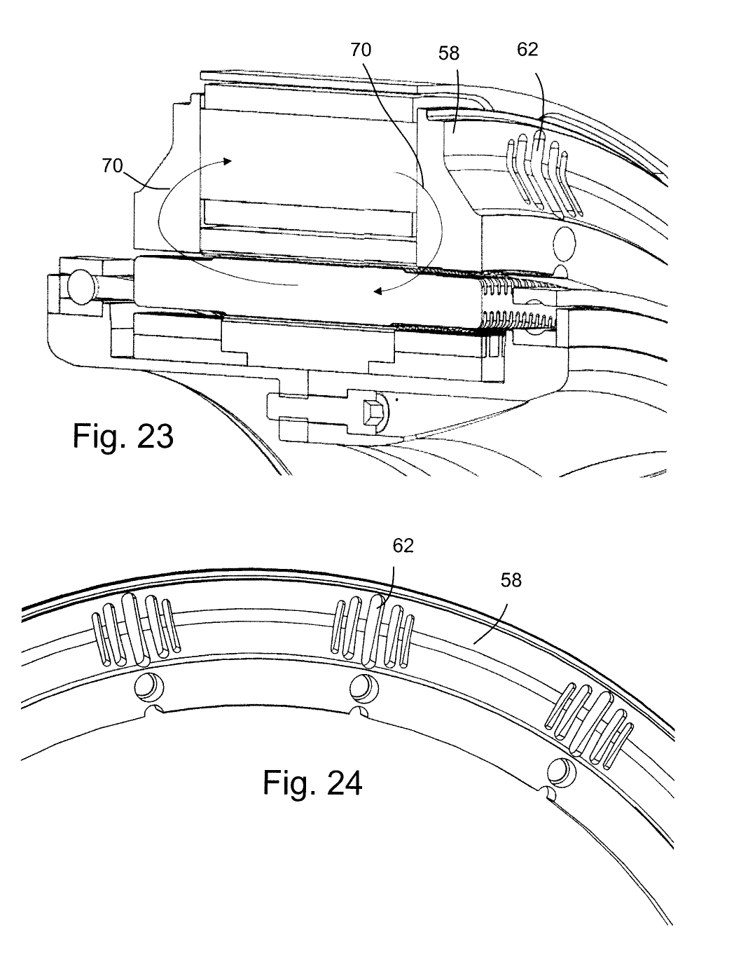

FIGS. 19-24 show views of a simplified exemplary embodiment. Outer cover 52 and inner cover 54 can rotate with respect to each other on bearings 56. Some components are not shown. Electromagnets comprising coils 66 surrounding cores 68 are arranged with ends contacting side plates 58 between which the electromagnets are arranged. The side plates are adjacent to cylindrical areas 60 of the flexible spline and act to direct a flux path from the electromagnets to the flexible spline. Cutouts 62 in the side plates 58 which act as flux resistors direct flux from each magnet to the flex spline directly inward from each magnet. One or more permanent magnet arrays 64 with steel backing and insulating material between magnets are arranged adjacent to inner cylindrical areas of the flexible spline. In FIGS. 22 and 23, flex spline 24 is shown in a non-deflected position. Arrows 70 indicate a path of magnetic flux through the flex spline 24 when electromagnets 50 are active.

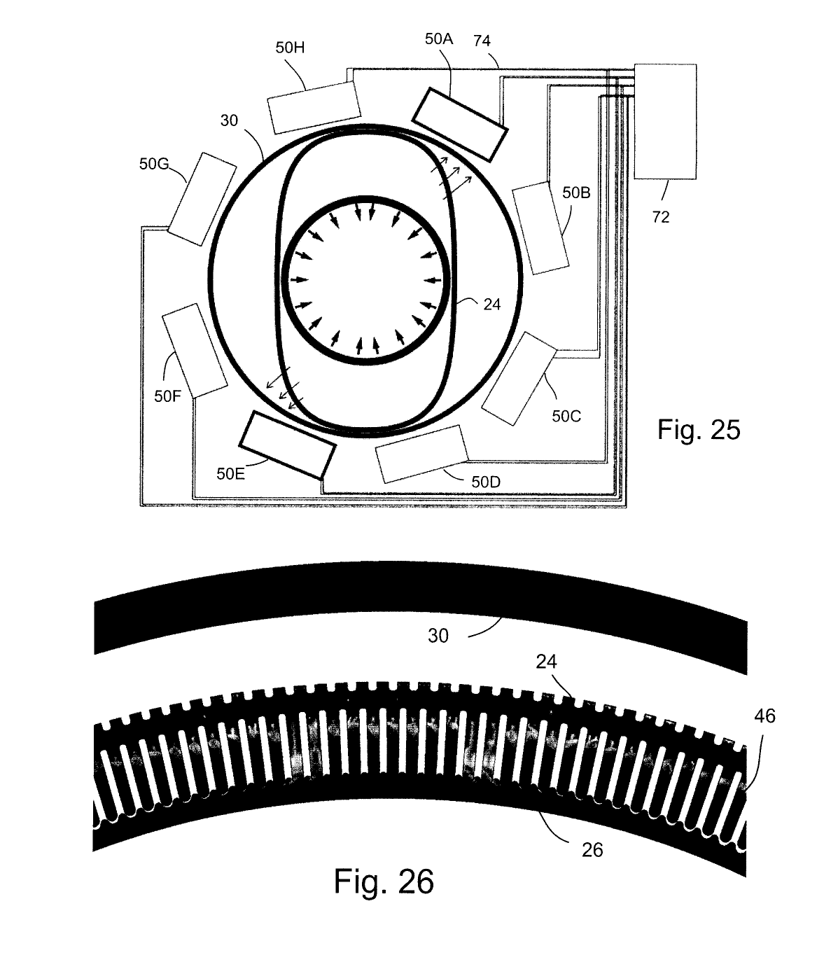

FIG. 25 is a schematic of an example of an electromagnet commutation system for the present device. Electromagnets are also preferably used as eddy current sensors by sending a high frequency signal from, for example, the motor controller 72, to detect the radial position of the flex spline at one or more magnets. This information is then used by the controller 72 to determine the position of the flex spline. The torque produced by or input to the flex spline can also be determined with this system by measuring the deflection of the flex spline at preferably two or more magnets compared to the no-torque shape. The motor controller and driver 72 commutates electromagnets 50A-50H in pairs, for example, in one direction, 50A and 50E, then 50B and 50F, then 50C and 50G, then 50D and 50H. Wires 74 connect motor controller 72 to electromagnets 50-50H.

Non-Limiting Examples of Variations

In some applications, it is beneficial to have the lobes of the flex ring contact the lobes of the inner and/or outer lobe rings on the outer surface of the lobe tips of the flex ring rather than the inner surface as shown in FIG. 26 as a non-limiting example.

Examples of Other Features and Variations

Lobe tips are shown in this disclosure as arc sections. This is preferable in many cases, but many other shapes are possible and anticipated by the inventor.

Other types of electric motors can be used on the inside and/or the outside of the flex spline. These include but are not limited to brushed or brushless magnet arrays, induction magnet arrays, permanent magnet flux switching magnet arrays such as but not limited to a Hilden-brand flux switching magnet array or a Flynn parallel path magnet array.

Unlike a conventional planetary gearbox or harmonic drive, the present device does not require a mechanical rotary input to propagate the wave form.

Ratios:

The flex spline lobes height (measured from the tip of the lobe to the root of the lobe) to the lobe width (measured across the contact surface of the lobe tip) in some configurations, is preferably 2:1 or greater.

The flex spline lobes height (measured from the tip of the lobe to the root of the lobe) to the lobe width, in some configurations, is preferably 3:1 or greater.

The flex spline lobes height (measured from the tip of the lobe to the root of the lobe) to the lobe width, in some configurations, is preferably 4:1 or greater.

The flex spline lobes height (measured from the tip of the lobe to the root of the lobe) to the lobe width, in some configurations, is preferably 5:1 or greater.

The outer flex spline lobe number and inner flex spline lobe number is preferably the same for some configurations.

The outer flex spline lobe number and inner flex spline lobe number is preferably the same for some configurations and the inner and outer lobes are aligned.

The outer flex spline lobe number and inner flex spline lobe number is preferably the same for some configurations and the inner and outer lobes are not aligned

An electromagnet on the ID of the flex spline can be used to augment the permanent magnets. If the permanent magnets are not adequate on their own to maintain the flex spline wave shape, the system can be designed to self-lock if the electromagnets lose power.

Brake members can be located axially beside the flex spline to lock the motor when it loses power. These brake members would be withdrawn from contact when the motor is powered.

A flex spline torque transmitting device may have lobes on the inner and outer surfaces of the flex spline which mesh with lobes on an inner ring and an outer ring respectively. One of the inner or outer lobe ring may be the reference ring and the other may be the output ring. The lobes have a lobe height to lobe tip width ratio of 2:1 or greater, 3:1 or greater, 4:1 or greater, or 5:1 or greater. Torque may be transferred from the reference lobe ring to the output lobe ring through the flex spline. The flex spline may be held in a rectelliptical or approximately rectelliptical shape by an array of permanent magnets situated radially inward from the flex spline. The flex spline may be held in a shape with four apexes, 5 apexes, 6 apexes or 7 or more apexes by an array of permanent magnets situated radially inward from the flex spline. The flex spline may have, for example, two fewer lobes on the flex spline outward facing surface than the number of lobes on the outer lobe ring, four fewer lobes on the flex spline outward facing surface than the number of lobes on the outer lobe ring, the same number of lobes on the flex spline outward facing surface as the number of lobes on the outer lobe ring, two more lobes on the flex spline outward facing surface than the number of lobes on the outer lobe ring, or more than two more lobes on the flex spline outward facing surface than the number of lobes on the outer lobe ring. The flex spline may have two fewer lobes on the flex spline inward facing surface than the number of lobes on the inner lobe ring, two or more fewer lobes on the flex spline inward facing surface than the number of lobes on the inner lobe ring, three fewer lobes on the flex spline inward facing surface than the number of lobes on the inner lobe ring, four fewer lobes on the flex spline inward facing surface than the number of lobes on the inner lobe ring or four or more fewer lobes on the flex spline inward facing surface than the number of lobes on the inner lobe ring. The flex spline may have an equal number of lobes on the ID of the flex spline as compared to the OD of the flex spline. The flex spline may have fewer lobes on the ID of the flex spline as compared to the OD of the flex spline. The flex spline may have half as many lobes on the ID of the flex spline as compared to the OD of the flex spline. An array of electromagnets may be positioned around the outer surface of the flex spline and the electromagnets energized sequentially to propagate the wave form. An array of electromagnets may be positioned around the inner surface of the flex spline and the electromagnets energized sequentially to propagate the wave form of the flex spline. An array of electromagnets may be positioned around the inner and outer surfaces of the flex spline and the electromagnets energized sequentially to propagate the wave form of the flex spline. An array of permanent magnets may be positioned around the outer surface of the flex spline so that the permanent magnets provide a force on the flex spline causing it to mesh with the outer ring lobes. The inner and outer lobe rings may be held concentric by bearings or bushings which allow rotation. The space between the flex spline lobes may be smaller than the width of the lobes on a lobe ring so the flex spline lobes are in bending tension when fully meshed. The sliding speed and pressure of the lobes in mesh may be low enough that the device can be operated without lubrication. Spinodal bronze, for example, may be used as an inner and outer ring lobe material. An array of inductance magnets may be used to propagate the flex spline wave form. An array of reluctance magnets may be used to propagate the flex spline wave form. An array of magnetic flux switching valves may be used to propagate the flex spline wave form. The flex spline may comprise a magnetic material such as but not limited to steel.

Gear Tooth Design and Rotary Actuator

Disclosed here is a gear tooth geometry and actuation means that provides a high contact ratio with minimal sliding during operation.

The geometry can be applied to a harmonic drive, or a differential harmonic drive, or other flexible gear tooth engagement systems. Preferably, the tooth geometry is used with a magnetic cam for example as disclosed above.

Gear Tooth Profile

For simplicity of this description, in the following embodiments positions 3 o'clock and 9 o'clock will be referred to as the positions where the flex spline is drawn inward by magnetic force. Positions 12 o'clock and 6 o'clock will be used to denote the positions where the inward elastic deformation at 3 o'clock and 9 o'clock result in the radially outward elastic deformation of the flex spline to cause meshing of the flex spline gear teeth with the output ring gear teeth. As the flex spline wave propagates in a circular/orbiting motion, the positions 3 o'clock and 9 o'clock, and 12 o'clock and 6 o'clock will, for the purpose of this description also rotate so that 3 o'clock and 9 o'clock will always be the positions where the flex spline is radially closest to the center axis of the device, and positions 12 o'clock and 6 o'clock will always be the positions where the flex spline is radially the furthest away from the center axis of the device.

It is also recognized that embodiments of the present device can use a single gear mesh position or more than two gear mesh positions. For clarity of description, a somewhat “rectelliptical” shape with two gear mesh positions will be referred to for the majority of this disclosure.

Comparison of Present Device with Conventional Epicyclic Gear Drive

The preferred gear tooth profile used in the embodiment of the device described here has some similarities to an epicyclic gear tooth profile, such as is manufactured by Sumitomo, in that the gear teeth have a rounded shape in the contact region. The gear teeth can be helical or spur. Spur teeth are illustrated here for simplicity of explanation. There are several important differences between this present device gear tooth profile and an epicyclic gear tooth profile, such as used by Sumitomo. One difference is that the inner gear of the present device is flexible so it can have more than one contact zone with the outer gear (similar in some ways to a conventional harmonic drive—but with some important differences that will be described later in this disclosure). Another difference, in comparison to a conventional epicyclic drive, is that the teeth are not intended to contact at all times (i.e., through the full cycle). Instead, the teeth of the present device are designed for clearance for most of the cycle and to engage only at one or more positions circumferentially between the regions of the flex spline which are drawn radially inward by the magnets at 3 o'clock and 9 o'clock. In these areas of the flex spline which are drawn radially inward by the magnets, the teeth of the flex spline are preferably 90° out of phase with the teeth of the output gear. Unlike a Sumitomo epicyclic gear, the teeth in these positions do not contact during normal operation, but if the magnet force drawing the flex spline radially inward at 3 o'clock and 9 o'clock is not adequate at any time, the crests of the flex spline teeth and the crests of the output gear teeth are radially close enough so contact will occur between the crests of these teeth and prevent significant radial outward movement of the flex spline at 3 o'clock and 9 o'clock. In this way, it is possible to prevent the flex spline teeth from becoming disengaged from the output gear teeth at 6 and 12 o'clock.

FIG. 27 shows a (prior art) Sumitomo-type epicyclic gear drive. Note that all of the teeth are in engagement at all times. This provides the benefit of high overload torque capability because the teeth that are 90 degrees out of phase (at 6:00 in this image, opposite the meshed teeth at 12:00) prevent the possibility of the 12:00 teeth becoming disengaged. A disadvantage of this tooth geometry is that a high percentage of the inner gear teeth are potentially in sliding engagement at all times. This increases friction and reduces efficiency, especially at higher speed reduction ratios where a large number of inner gear orbits result in a small output gear movement.

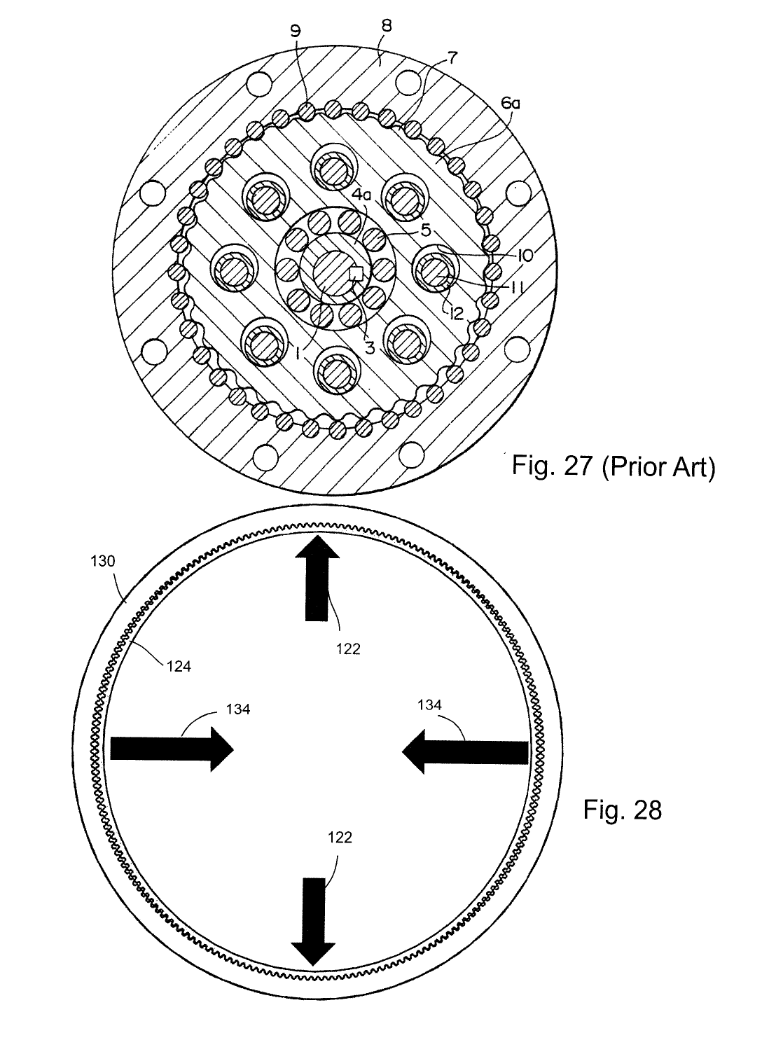

FIGS. 28-31 show an exemplary embodiment of the present device with an elastically deformed inner gear having two gear mesh locations (more or fewer gear mesh zones are also possible), one at 12:00 and one at 6:00. It is preferable for one or more teeth to be fully engaged at all times at each of the gear mesh zones. In this example, there are approximately five teeth engaged at 12:00 and 6:00, but more or fewer teeth can be engaged on the same device depending on the magnetic and torque forces that are acting on the inner gear.

Continuing the comparison with the prior art epicyclic gear, it can be seen that the gear teeth at 3:00 and 9:00 in the exemplary embodiment of the present device are out of phase by 90 degrees, similar to the gears at 6:00 in the epicyclic drive above. The difference, however, is that the gears in the present device are preferably (but not necessarily) not contacting at 3:00 and 9:00. They are, however, preferably close enough to contacting that they still prevent the teeth at 12:00 and 6:00 from disengaging if the flex spline comes loose from the magnetic holding force for any reason.

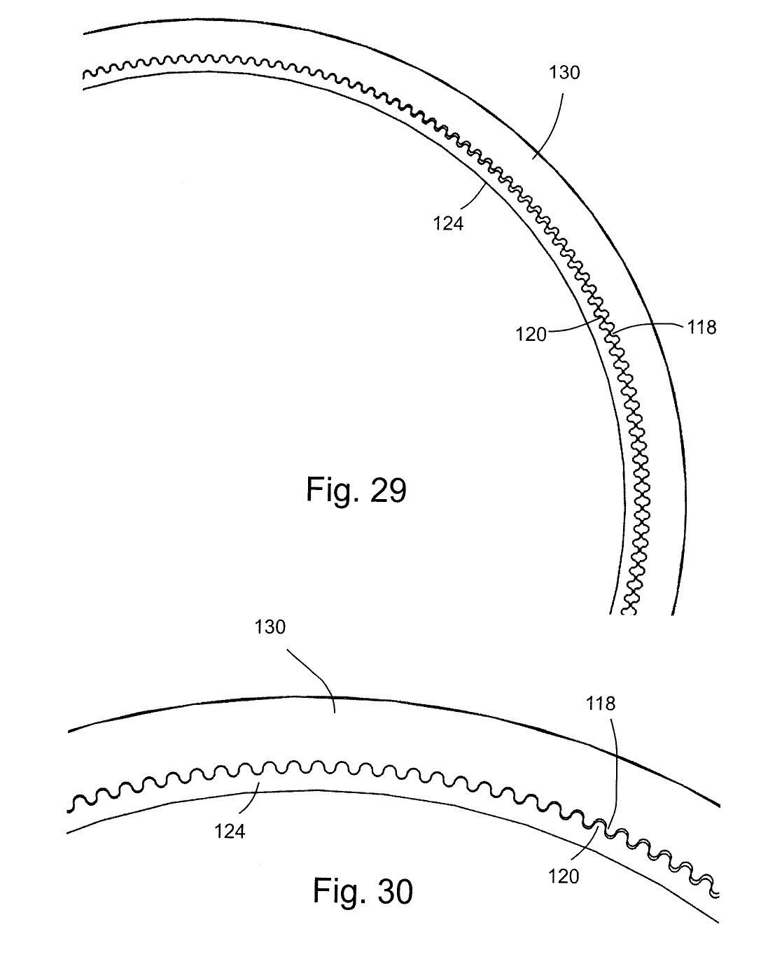

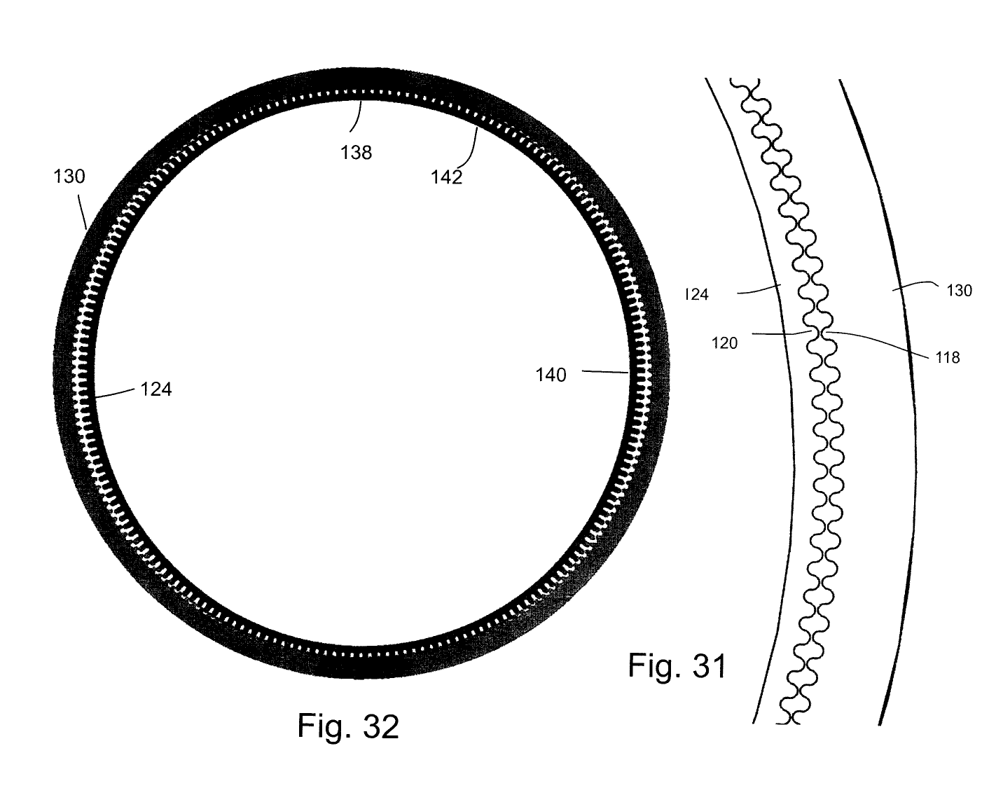

FIG. 28 is a schematic showing the magnetic force 134 on the flex ring 124 and the resulting elastic deformation forcing parts of the flex ring outwards as indicated by arrows 122 to contact outer ring 130. FIGS. 29-31 are three close-up views to illustrate the relative position of the flex ring teeth 120 and outer ring teeth 118 during deformation of the flex ring 124. As shown in FIG. 30, approximately five teeth are fully engaged at 12 o'clock. As shown in FIG. 31, the teeth at 3 and 9 o'clock are 90 degrees out of phase but preferably not contacting.

Comparison of Present Device with Conventional Harmonic Drive:

It is known in conventional harmonic drives, the flexing motion of the spline prevents the use of standard gear tooth geometry and improper tooth profiles can produce significant kinematic errors which lead to problems with velocity and torque variation, transmission error, stiffness, dynamic performance, friction, fatigue and wear. In an embodiment of the present device, the flexibility of the spline becomes an advantage and is used in combination with unusually long teeth on the flex spline to allow the teeth to “splay” apart more than a conventional tooth when the radius of curvature is decreased. This decrease in curvature happens in what will be referred to as the transition zone 142, between the large curvatures at 3 o'clock and 9 o'clock, and the curvatures at 12 o'clock and 6 o'clock which are the same or similar to the pitch diameter of the output gear as illustrated in the finite element analysis shown in FIG. 32. The radiuses of curvature in the gear mesh zone 138 and gear clearance zone 140 are both larger than the radius of curvature in the transition zone. The gear mesh zone takes on the larger curvature of the output ring because it is “flattened” against it. The gear clearance zone curvature is larger than the transition zone curvature because it is pulled inward by magnetic cam magnets (not shown here) to a more straight shape. The transition zone must have a reduced curvature radius to compensate for increased radius of the gear mesh zone and gear clearance zone.

In the transition zone in the present device, the radius of curvature is smaller than in the gear mesh zone or the gear clearance zone of the flex spline. This smaller radius curvature helps to reduce the tendency for tooth interference between the flex spline and the output gear in the transition zone by virtue of an effect that is referred to here as “zippering” the teeth together.

A comparison with a zipper is appropriate because a zipper has a smaller radius of curvature area between the engaged and disengaged zipper teeth. In this area, both sides of the zipper are deformed with a high enough curvature that they mesh together at the beginning (or end) of the mesh zone, but the teeth are not able to disengage from the mesh zone (without increased interference) unless they are “zippered” apart with a smaller radius of curvature.

With the unusually long (in the radial direction, as compared with the prior art) teeth 116 of this embodiment of the present device, the circumferential distance between adjacent teeth (sometimes referred to as the single tooth pitch) will increase (somewhat similar to how zipper teeth are caused to splay apart when they are interdigitating). The benefit of this with regard to the present device is that the single tooth pitch of the flex spline gear teeth can be slightly smaller than the single tooth pitch of the output gear with which it meshes. As a result, it has been shown in FEA simulations that the interference which would otherwise occur with his tooth profile on either side of 12 o'clock and 6 o'clock (approximately between the positions of 1:00-2:00, 4:00-5:00, 7:00-8:00, and 10:00-11:00) can be eliminated due to the teeth being closer together than if a conventional tooth profile and outward force cam was used.

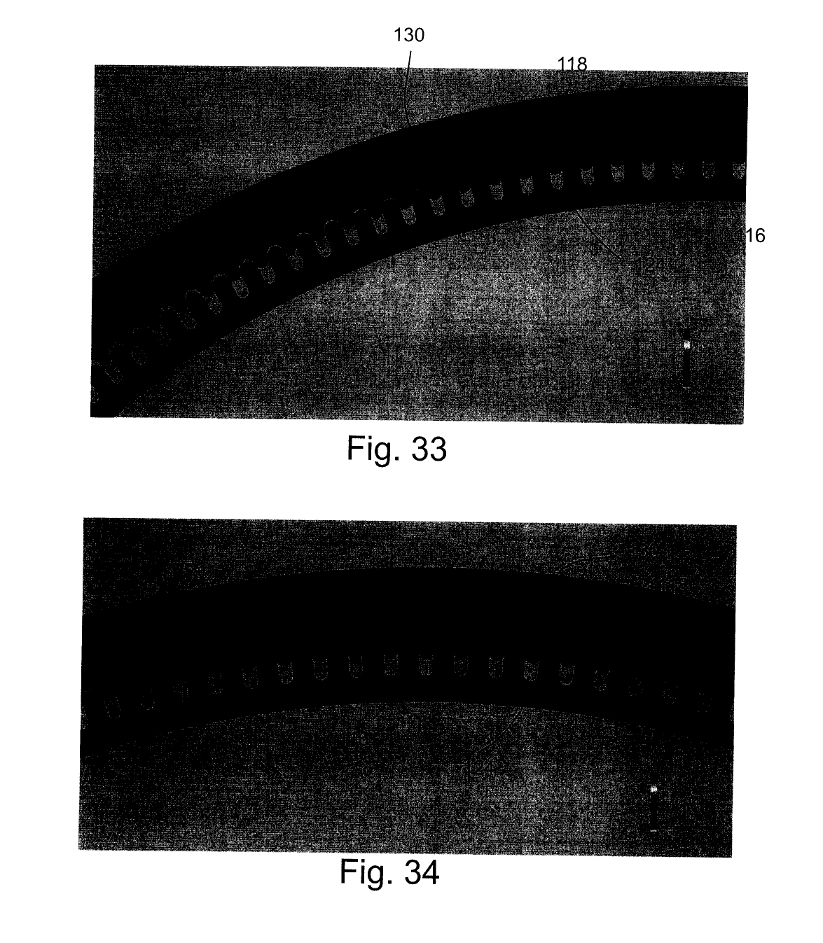

FIG. 33 is an image from an FEA analysis showing the contact force between the meshed teeth at 12:00 (eight teeth 116 are shown in meshed contact on this side of 12:00 and another approximately eight teeth 116 will be in contact on the other side of 12:00). The area which is most likely to produce unwanted interference is at approximately 10:30. There is no contact in this analysis, but the parts are very near to contacting. Adjustments to the geometry that will create greater clearance in these areas will be discussed later in this disclosure.

An important consideration is that the unusually tall teeth combined with a smaller single tooth pitch distance requires a greater vertical elastic deformation of the flex spline to increase the zippering effect and increase the clearance between the flex spline teeth and output gear teeth in the transition zone.

FIGS. 33 and 34 show the same geometry as in FIG. 32, except with slightly shorter teeth (and a slightly smaller single tooth pitch distance). The output gear in this example has a pitch diameter of approximately 5.5″. By shortening the teeth by 0.010″ (approximately 0.2% of the pitch diameter), the extra 0.010″ vertical deformation of the flex spline at 12:00 results in a visibly greater tooth clearance at the 10:30 position. In FIG. 34, contact can be seen on the sides of teeth 116 of the flexible spline facing the 12:00 position as they oppose the symmetrical contact of the sides facing the 12:00 position of teeth on the opposite side of 12:00. Teeth at 12:00 are in a neutral loading position when no torque is applied to system.

Another benefit of the unusually tall tooth profile combined with the magnetic cam of the present device is a true zero backlash gear system which results from the force of the teeth on either side of the 12 o'clock position acting inward toward 12 o'clock. In other words, the flex spline teeth (having a smaller single tooth pitch) which are in mesh (having been splayed apart allowing them to be “zippered” together in the transition zones) and once fully engaged, would be closer together than the single tooth pitch of the mating output gear teeth would allow. This spring loads the flex spline teeth on one side of 12 o'clock (in this example) in opposition to the teeth on the other side of 12 o'clock so that backlash is completely eliminated.

The stress and displacement of the flex ring has been estimated with Finite Element Analysis (shown in FIGS. 33 and 34) using a circular tooth profile which, using standard gear design conditions, would normally experience interference during the engaging process with the circular spline teeth profile (between 12:30 and 2:30 positions, for example).

By making the pitch diameter smaller we obtain noninterference, as well as reduced sliding contact compared to an involute gear shape. Also by reducing the distance between teeth in the flex spline compared to the distance between teeth in the circular spline, it creates a gripping effect between opposing teeth on either side of 12:00 where the teeth on the flex spline would normally be closer together but are prevented from moving together by the outer gear teeth. This grip effect is advantageous because it ensures reduced or zero backlash during operation and especially during torque direction changes.

By adding a small clearance of 0.0002″-0.0008″ per surface, which is within standard gear manufacturing tolerance, the gripping effect is diminished.

The effect of the magnetic force magnitude on the deformation of the flex ring has been studied. It has been found that as torque loading increased, more magnetic force was needed to maintain gear mesh. Due to the nearly tangential force transfer between teeth however (compared to 14.5 or 20 degrees as examples of involute gear tooth force transfer angles) the magnetic force required to keep the teeth in mesh at higher loads can be provided by the increased magnetic force required to generate that torque.

Simulations also revealed that higher torque loads resulted in greater conformation of the flex spline to the outer gear pitch diameter thereby engaging more teeth. In one example, six teeth were engaged under zero torque load while up to 17 teeth were engaged at 1000 lbf*in (with a gear that is 0.75″ wide). The contact stress and bending stress of the teeth is relatively small compared to the fatigue stress limit (0.5 of yield limit) of gear steel. In these simulations, we are using 4140 steel as the flex spline material for its strength and magnetic properties however many other materials could be used. The maximum stress in the flex spline occurs as compression stress in the teeth grooves near the application points of magnetic forces, and has a value close to the infinite life fatigue limit of the material.

Other embodiments of the present device can also use tooth profiles which do not eliminate backlash, but still take advantage of other benefits of the present device such as a large number of teeth in contact and reduction or elimination of sliding motion between the teeth. One way to do this is to use a narrower tooth profile of the same height on the flex spline.

The nearly tangential contact between gear teeth also nearly eliminates the gear separation force, allowing lower magnetic forces to be used in the cam, thereby reducing the cost and/or weight and/or power consumption of the device as compared to one with a substantial gear separation force. The holding force provided by the magnets only needs to be sufficient to counter the internal spring force of the ring in its deformed state.

This gear tooth profile can be used in combination with any type of flexible gear tooth with one or more of these benefits. Illustrated below are three examples of flexible gear tooth systems which can be used in combination with the present tooth profile.

Buckled Rod Example

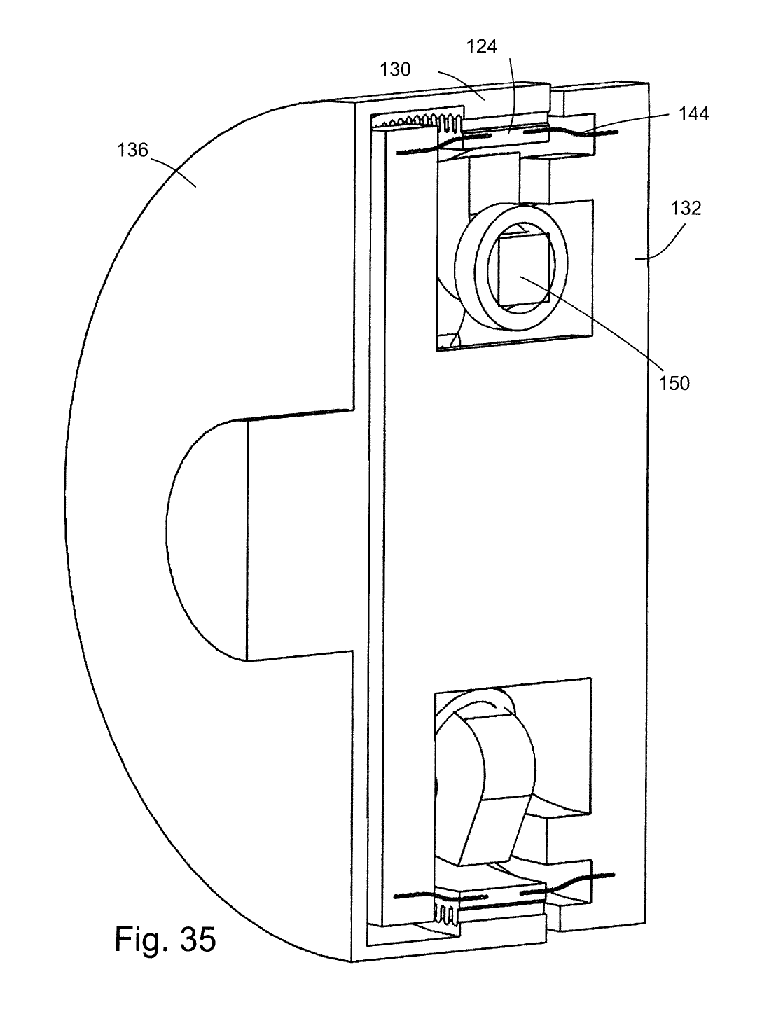

The first example, shown in FIG. 35, uses axially preloaded buckled rods 144 to transmit torque from the flex spline 124 to housing part 132. In this exemplary embodiment, the flex spline does not rotate relative to housing part 132. An additional housing part 136 is connected to outer ring 130 and rotates with respect to housing part 132. The permanent magnets and/or electromagnets establish the somewhat elliptical shape causing the teeth of the flex spline to mesh with teeth of the output gear at 12 o'clock and 6 o'clock. To produce rotary output movement, electromagnets 150 proximal to the permanent and or electromagnets which produce the somewhat elliptical shape, are sequentially powered on and off to reduce the air gap on either side of 3 o'clock and 9 o'clock to change the position of the tooth mesh interface with the output gear. For each full rotation of the somewhat elliptical shape there is a two or more tooth difference between the output ring gear and the flex spline gear so that two or more teeth are progressed for each elliptical shape full rotation.

Differential Harmonic Example

In another embodiment of the device, the flex spline has a central gear tooth profile which meshes with the output gear at 12 o'clock and 6 o'clock (in a two mesh configuration, but one mesh or more than two meshes such as three or four or five or six gear tooth mesh positions is also possible). The flex spline in this configuration also has a different gear tooth profile on one, but preferably on both axial sides of the central gear tooth profile. The outer gear teeth mesh with internal gears which are fixed to the housing. In this embodiment, the flex spline is not connected to the housing other than through gear meshing with the fixed internal gears and the flex spline is therefore able to rotate relative to the housing. This allows for the possibility of very high gear ratios, such as is possible with conventional differential gear drives, but with the advantage of high efficiency by virtue of the elimination of rotating shafts and bearings as are common to harmonic drives and harmonic differential drives with rotary shaft inputs. High efficiency is also believed to be possible for a high ratio differential speed change device of this design, as a result of the minimal sliding achieved by the tooth profile geometry disclosed here.

The following figures in this section illustrate one embodiment of the device, showing a flex spline with one gear tooth profile in the center and another surrounding it. The figures are schematic, and the output and fixed rings are also necessary but are not included for the sake of simplicity. Other configurations are possible such as having the output ring mesh with the outside gears of the flex spline and fixing the portion which meshes with the center of the flex spline to the housing. The number and size of teeth on each gear determines the gear ratio of the system. Table 2 shows some example calculations to illustrate how a multitude of different gear ratios may be achieved by varying the number of gear teeth on each component of a differential harmonic drive system.

TABLE 2

| | | Outputs | | | | | | | | | |
|---|---|---|---|---|---|---|---|---|---|---|---|
| Inputs | | | | | | | Fixed Ring | | | | |
| Desired | Teeth on | | | | #Flex | #Flex | Number of | Constant | Constant | Actual | |
| Ratio | Output | | Ratio | Output | Teeth 1 | Teeth 2 | Teeth | 1 | 2 | Ratio | Error |
| e_{f} | Nₒ | Ratio | Type | Direction | N_{F1} | N_{F2} | N_{FIX} | eₐ | e_{b} | e_{fcalc} | δ |
| −0.002 | 202 | 500:1 | Reduction | Reversed | 251 | 200 | 253 | −0.007984032 | 1.2525 | −0.002 | 0 |
| −0.002777778 | 302 | 360:1 | Reduction | Reversed | 516 | 300 | 518 | −0.003878116 | 1.719047619 | −0.002777778 | 0 |
| −0.001923077 | 300 | 520:1 | Reduction | Reversed | 418 | 298 | 420 | −0.004779142 | 1.404312668 | −0.001923077 | 0 |
| −0.01 | 102 | 100:1 | Reduction | Reversed | 202 | 100 | 204 | −0.00990099 | 2.02 | −0.01 | 0 |
| 0.01 | 100 | 100:1 | Reduction | Same as | 65 | 98 | 67 | −0.030715316 | 0.66442953 | 0.01 | 0 |
| | | | | Input | | | | | | | |

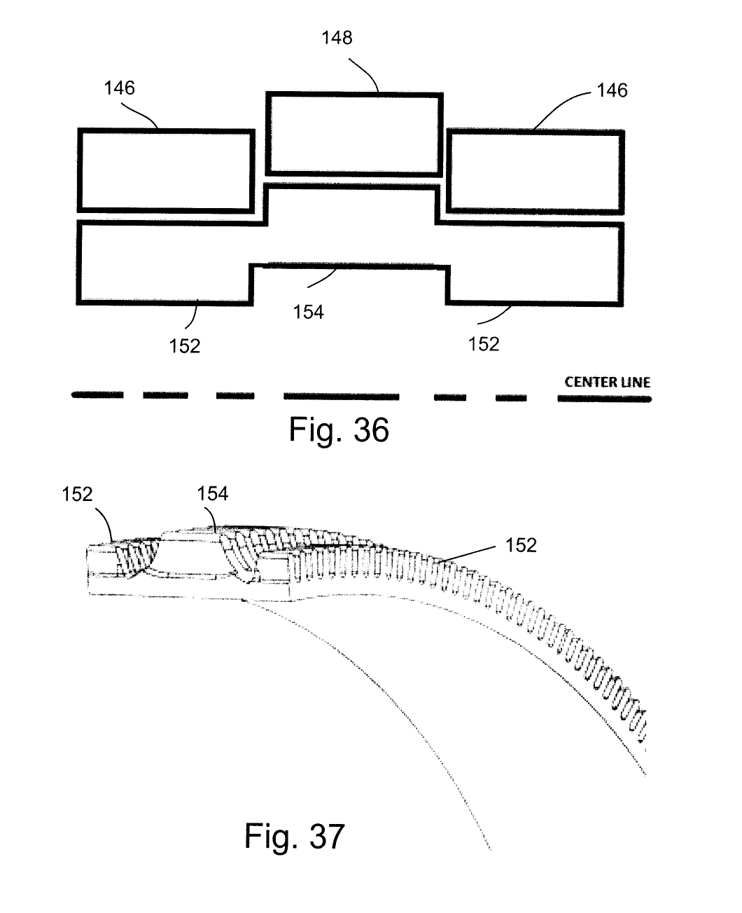

FIG. 36 shows a schematic cross section of how a flex spline of this embodiment would interface with a fixed gear 146 and an output gear 144, showing the flex ring side regions (flex1) 152 and central regions (flex2) 154 and meshing gears corresponding with the cell descriptions used table 2.

FIG. 37 is a section view of a flex spline of this embodiment, showing one possible representation of the tooth geometry on the flex ring.

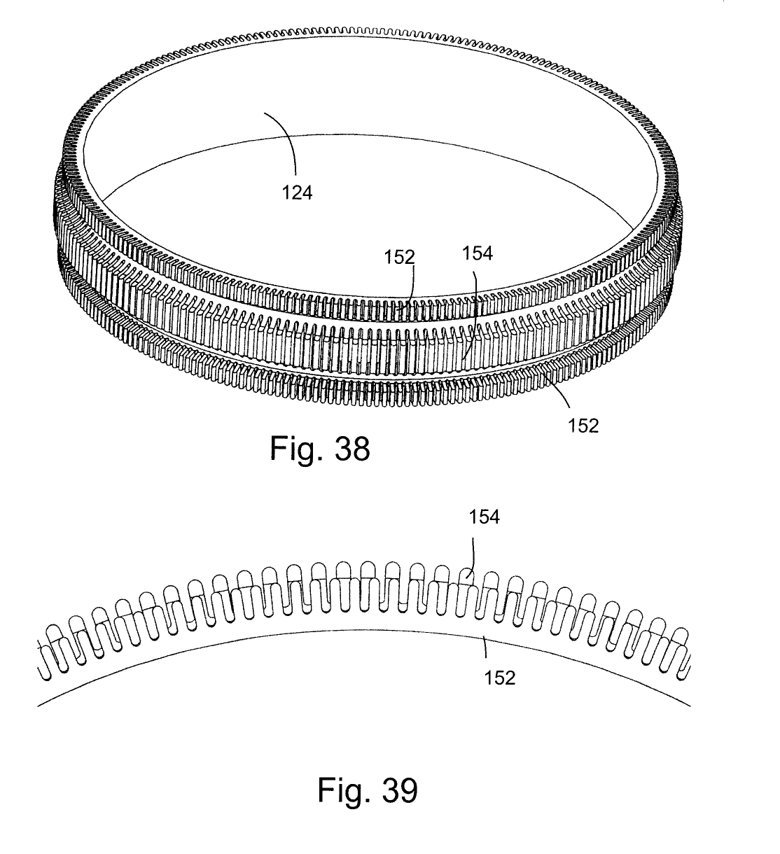

FIG. 38 and FIG. 39 show isometric and close-up side views respectively of a flex spline of this embodiment.

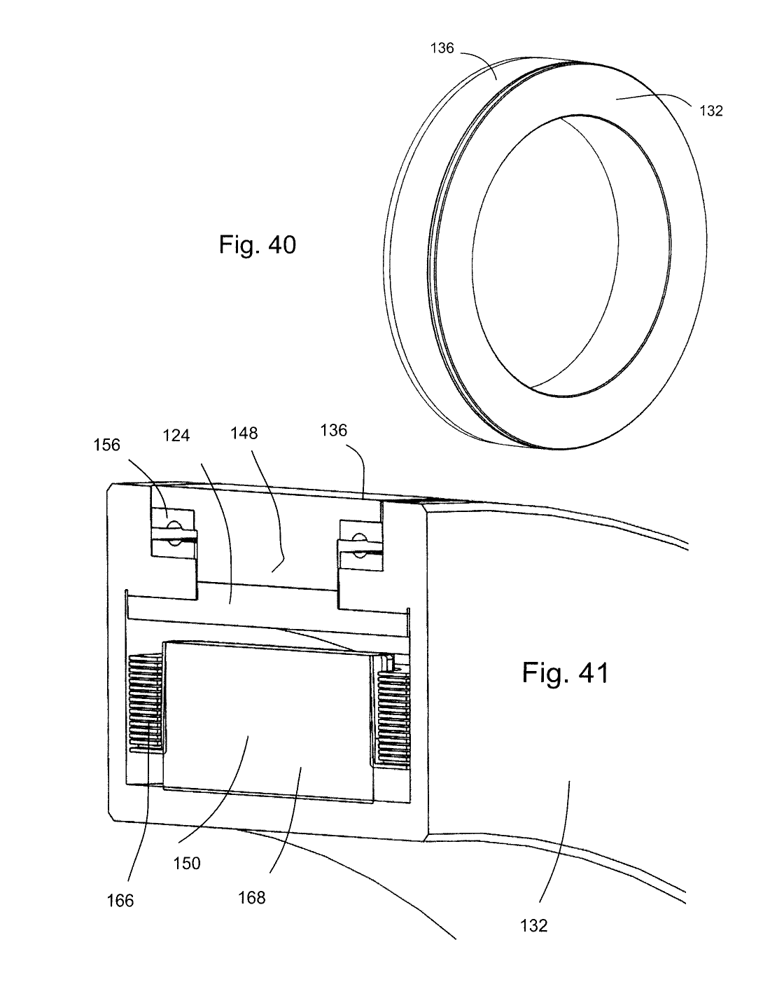

FIGS. 40-44 show schematic and simplified images of a preferred embodiment of a differential harmonic drive with symmetrical gears 152 on either side of a central gear 154 on the flex spline. The central gear 154 on the flex spline meshes with the output ring gear 148. The symmetrical gears on either side of it, also attached to or part of the flex spline, mesh with the fixed rings 146. Magnets and/or electro magnets 150 comprising coils 166 and cores 168 pull the flex ring inward at one or more places (two in this example) and then propagate the wave form so the gear meshes progress around the outer gears. The flex spline is “floating” in that it is not fixed to either of the fixed or output members. It is free to rotate except for the gear mesh with the fixed ring which couples it to the fixed ring and the gear mesh with the output ring which couples it to the output ring. The output ring 148 and fixed rings 146 are, therefore, coupled via the flex ring 124. Electromagnet cores can have a permanent magnet/s imbedded in them, such as but not limited to a neodymium magnet/s. This permanent magnet can be used to hold the flex spline in a deformed shape, while the electromagnets are energized in sequence to propagate the wave. Housing part 132 is connected to the fixed ring in this embodiment and additional housing part 136 is connected to the output ring. Bearings 156 allow housing part 136 to rotate relative to housing part 132.

These images show the non-rotating flex spline magnetic cam and symmetrical differential gear flex spline. They do not show the high aspect ratio gear tooth design.

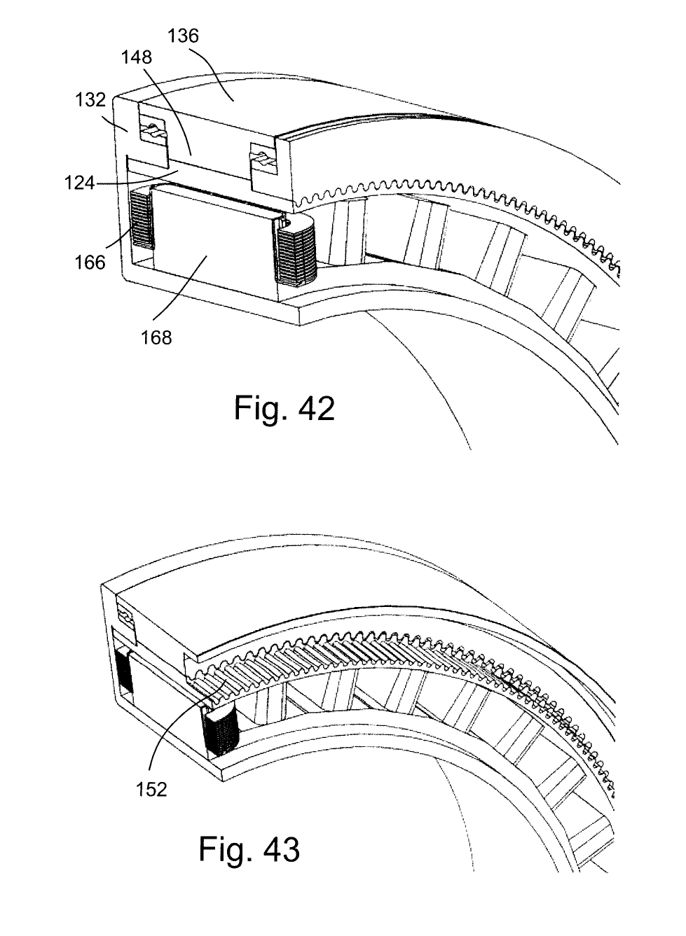

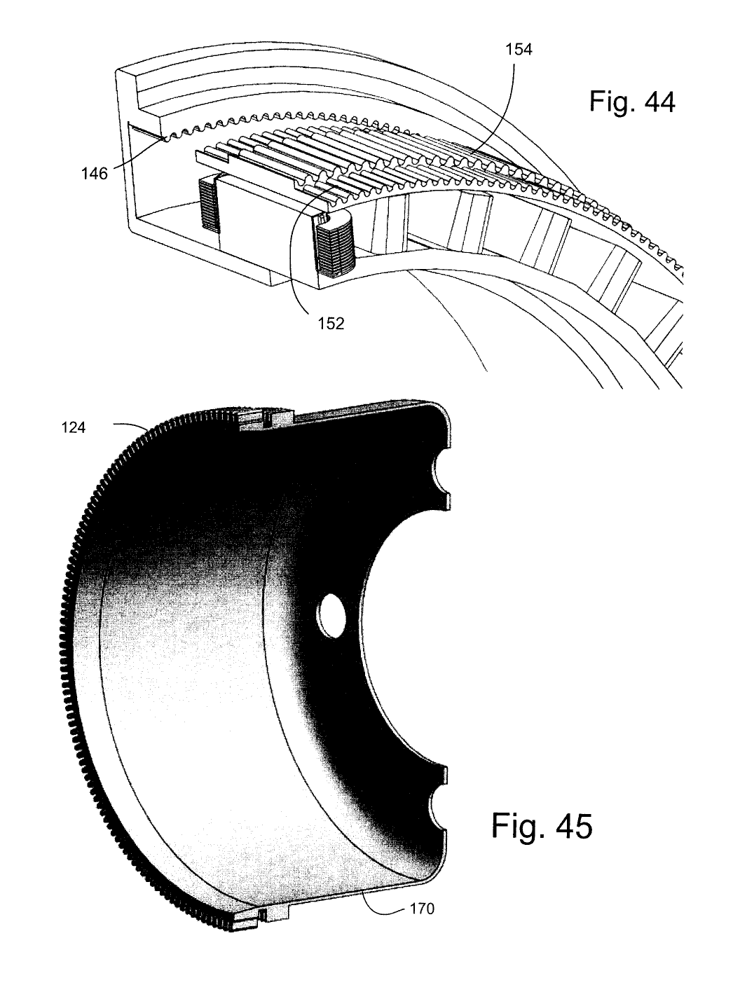

FIG. 40 shows the assembled actuator with the fixed and output housing members 132 and 136. FIG. 41 shows a section view. Electromagnet cores 168 can have a permanent magnet/s imbedded in them, such as but not limited to a neodymium magnet. This permanent magnet can be used to hold the flex spline in a deformed shape, while the electromagnets are energized in sequence to propagate the wave. FIG. 42 shows a partially disassembled and sectioned view. (Electromagnet coils 166 are not shown on all cores in these images). Wires are not shown going to each core but the placement and use of electrical connections to the electromagnets is well known to anyone skilled in the art. Commutation of the magnets can be done with a motor controller or many different contacting or non-contacting means such as brushes or brushless commutating methods common to electric motors. FIG. 43 shows a further disassembled view in which geared surface 152 on the flex spline that meshes with the fixed housing is visible. FIG. 44 shows an exploded view in which the geared surfaces 152 and 154 of the flex spline are visible. The low sliding motion and other benefits of the high aspect ratio gear of the present disclosure shown here is preferably applied to the embodiment of FIGS. 40-44.

Flexible Harmonic Cup Example

Another embodiment of the present device uses a flex spline on the edge of a longer cylinder which is closed on one side to provide a rigid surface for attaching to an output shaft as is used in conventional harmonic drives. The outer gear is held fixed while the flex spline rotates, thereby rotating the attached output shaft. The gear teeth are located on the edge of the cup while the output shaft is attached to the bottom of the cup as shown in the figure below. The gear tooth profile and magnetic actuation are the same as previously described. This variation may also function with the flex spline shaft held fixed and the outer ring rotating, and with more than one outer ring on the flex spline as described previously in the differential harmonic example. FIG. 45 illustrates the structure of the flex spline 124 as a harmonic canister 170. Apart from the gear form shown, the canister shown is a conventional flex spline canister. The outer rings and attaching shaft are not shown to simplify the figures.

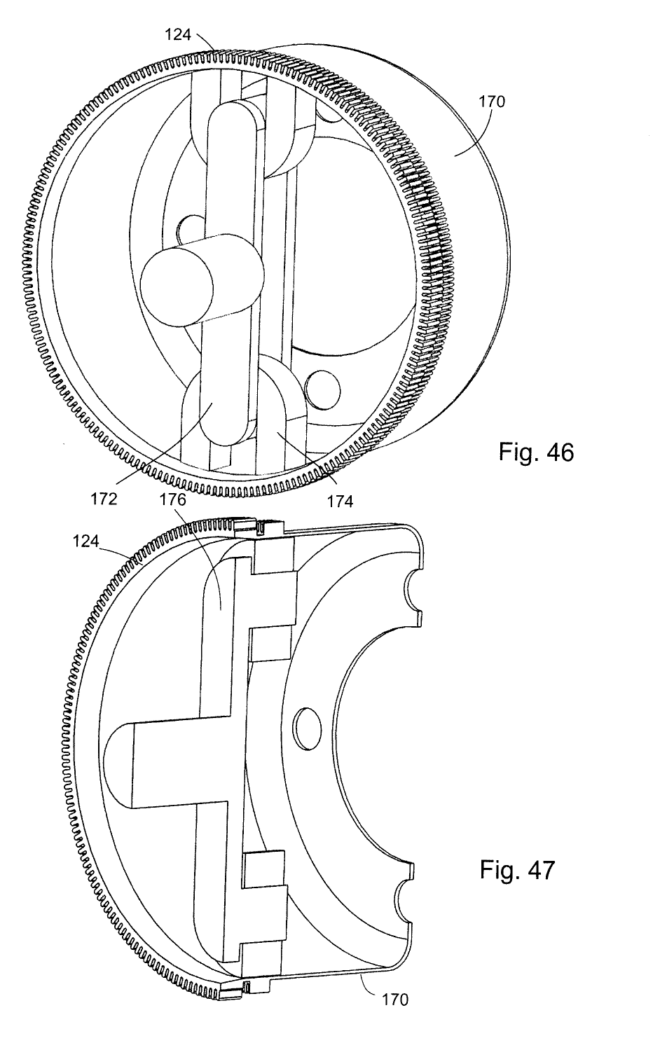

FIG. 46 is a schematic diagram showing an embodiment of the flex spline canister of FIG. 45 using a magnetic rotating cam 172. A flex ring canister wave is held and propagated by the rotating magnetic cam. Outer gears are not shown. A rotating shaft spins magnets and propagates strain wave. The magnets 174 on the magnetic cam pull the flex ring inwards creating deformation.

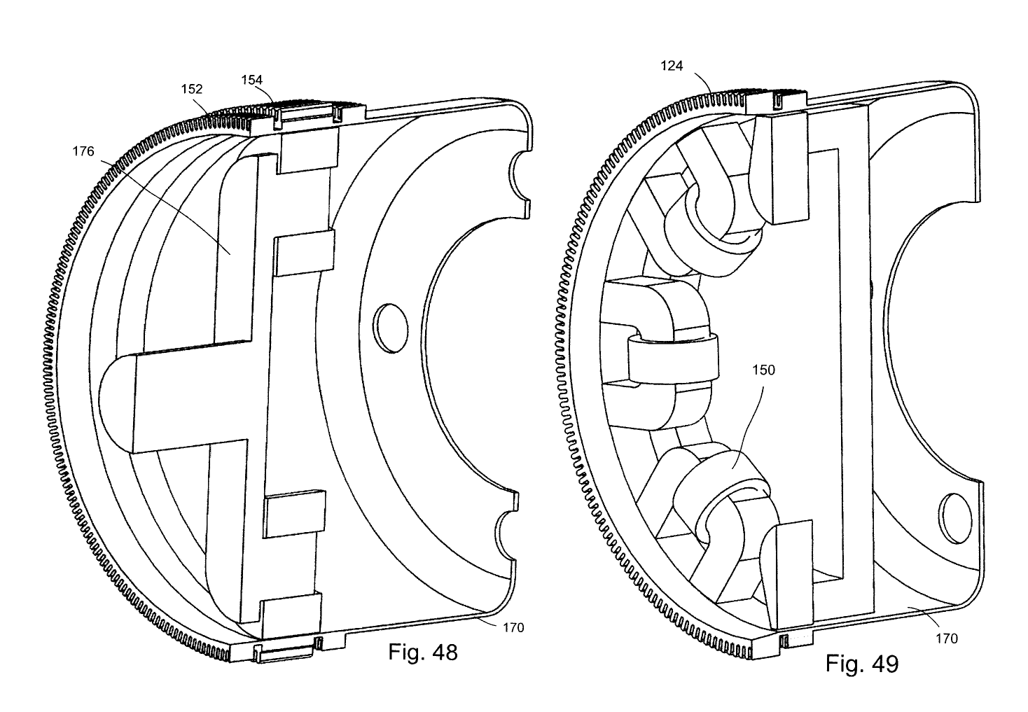

FIG. 47 is a schematic diagram showing a differential flex spline canister variation with high aspect ratio gears using a rotating rolling cam 176. It has two gear sets and is not symmetrical.

FIG. 48 is a schematic diagram showing another differential flex spline canister variation with high aspect ratio gears using a rotating rolling cam 176. It has three gear sets with two of them having the same ratio with the fix gears (fixed gears not shown in these examples of different strain wave component embodiments).

FIG. 49 is a schematic diagram showing a flex spline canister variation using a magnetic non-rotating cam. It has two gear sets and is not symmetrical and the wave is propagated by an array of electromagnets 150.

Further Rotating Magnetic Cam Embodiments

The following device is a rotary actuator that uses a magnetic cam to deform a flexible ring and produce high torque. The device is composed of a stationary outer ring, a flexible ring, a magnetic cam, a driving mechanism, and an output shaft. The system functions as follows: The flexible ring is located within the outer ring, and the magnetic cam is located within the flexible ring. The magnetic cam deforms the flexible ring at 2 or more equi-spaced positions, causing gear teeth on the outside of the flexible ring to contact gear teeth on the inner diameter of the outer ring between the positions of the magnets. As the magnetic cam rotates due to the driving mechanism, the difference in the quantity of teeth on the outer ring relative to the flexible ring functions as a harmonic drive and propagates 2 or more deflected waves through the flex ring causing relative rotation of the flexible ring with respect to the outer ring according to the gear ratio. A coupling system capable of transmitting the torque whilst allowing the flexible ring to deform transmits the movement of the flexible ring to an output shaft.

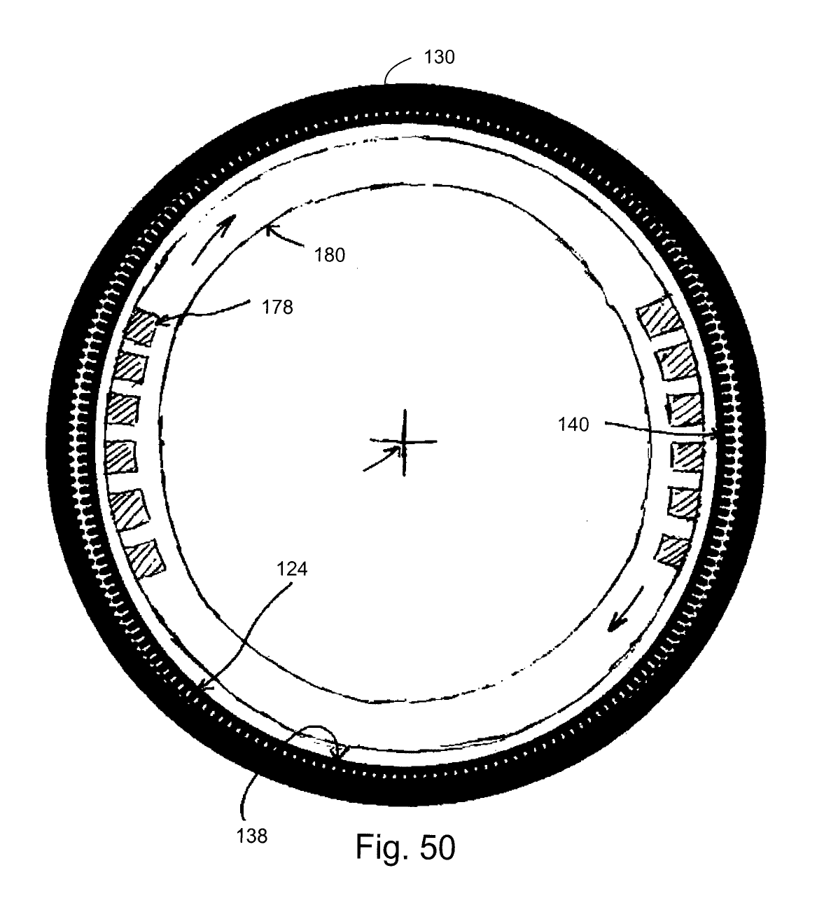

The magnetic cam contains 2 or more equi-spaced magnets, or groups of magnets, which may be permanent magnets 178, electromagnets, or a mixture of both embedded in or attached to a rotating inner ring 180 rotating around center of rotation 182, the inner ring with magnets together forming a magnetic cam. These magnets are able to deform the flexible ring inwards. In the preferred embodiment, there are two separate magnet locations at 180 degrees from one another. In the center of each magnet area, the flex ring is pulled inwards while halfway between the magnet areas the flex ring deforms outwards. This outward deformation causes the flex ring to be pressed into the outer ring which engages the gear teeth (FIG. 50).

Each magnet location on the magnetic cam may consist of one or more magnets. These magnets may all be the same strength, or they may be varying strengths. If all magnets are the same strength the closest point of the flex ring will be located at the center of the magnet grouping. The exemplary embodiment shows six magnets on each side of the magnetic cam, however the device will function with any number of magnets on each side. The magnets may be oriented such that they all have the same polarity facing out, they may have alternating polarities, or any other combination of north and south facing poles using the number of magnets available. Using an alternating polarity configuration will increase the strength of the magnetic force acting on the flex ring. The radial position of each magnet can be fixed or adjustable to allow for fine-tuning of the magnetic forces on the flex ring. The preferred embodiment illustrates an adjustable system where washers may be stacked underneath each magnet to modify its radial position.

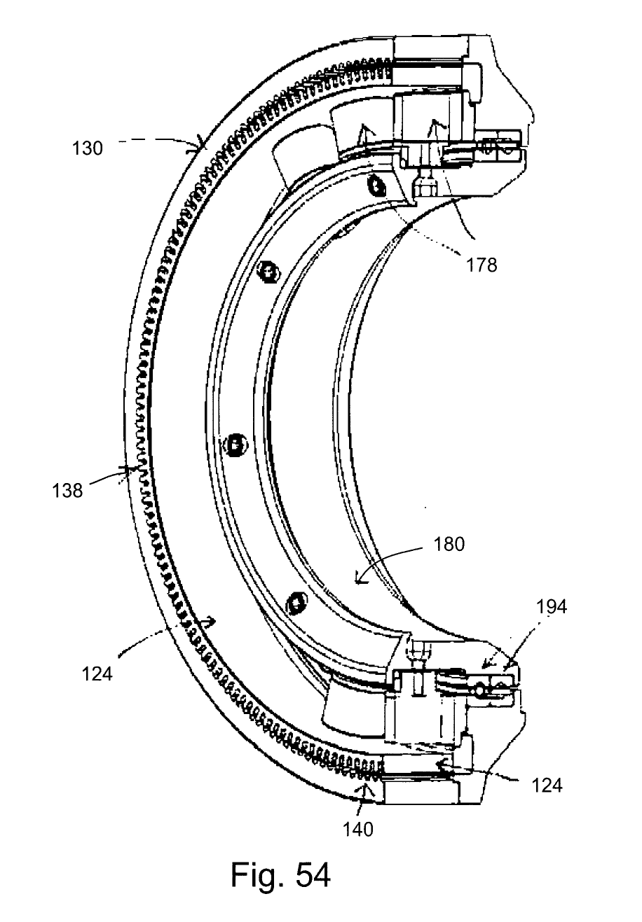

In an embodiment (FIG. 54), the system is tuned to an equilibrium where the magnetic force pulling inwards on the flex ring is balanced by the stiffness of the ring resulting in a deformed state where the gear teeth are contacting the outer ring, but the inner diameter of the flex ring is not contacting the magnetic cam. Other embodiments include using rollers on the surface of the magnetic cam that contact the flex ring when it is fully deformed or allowing the flex ring to directly contact the surface of the magnets and/or magnetic cam. These embodiments would allow more flexible rings or stronger magnets to be used however the system would generate more friction. Preferably, the magnetic cam and the flex ring never contact, therefore no contact friction is generated.

As the magnetic cam rotates, the magnets pull the flex ring in and propagate the deflected wave. The flex ring is positively engaged in the magnetic cam by the gear teeth. Therefore, the flex ring rotates only by a pre-determined number of gear tooth pitches for every circuit of a deflected wave around the circumference. The gear tooth geometry has a low contact angle which results in reduced friction.

Embodiments Illustrating Different Driving Mechanisms:

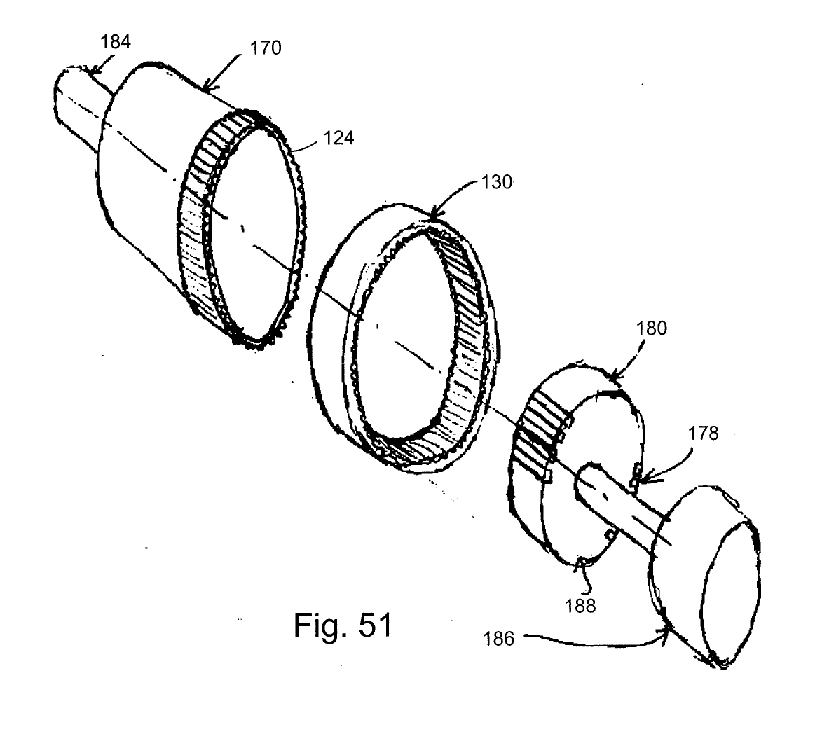

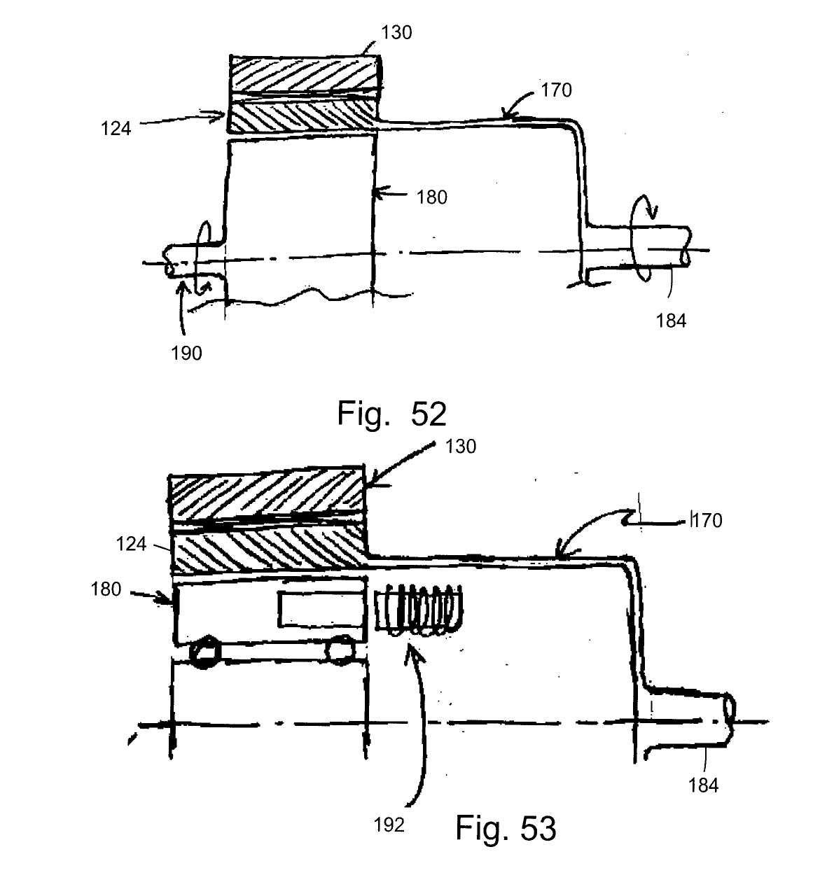

FIG. 51 is a simplified exploded schematic view of a torque transfer device using a flexible ring deflected by a magnetic cam as in FIG. 50. In the simplest embodiment, the device is driven by hand. The rotating inner ring 180 can be manually turned to produce a high torque rotation of the flexible ring, or it can be driven by some other drive. Input drive 186 represents the input turning the rotating inner ring 180. As shown in FIG. 51, a flexible connection 170 between the flexible ring 124 and the output shaft 184 allows the flexible ring to be deformed by magnets 178 while transmitting rotary motion of the flexible ring to the output shaft. In this disclosure, “flexible ring” is interchangeable with “flexible spline”. As can be seen in FIG. 51, in the embodiment shown an area 188 of the rotating inner ring at 90 degree to the magnets 178 has no magnets present. Another embodiment includes connecting the magnetic cam to a shaft 190 that is driven by an external device, as shown in FIG. 52. The magnetic cam can also be driven by an internal electric motor or other internal rotary drive as shown in FIG. 53. An array of electromagnets 192, for example, may drive the magnetic cam. Other embodiments may include for example a hydraulic drive.

FIG. 54 is a section view of an exemplary embodiment of a rotating magnetic cam torque transfer device. The output connection from the flexible ring to the output member is not shown in FIG. 54 but is required in this embodiment. Bearings 194 allow rotation of the rotating inner ring 180 relative to outer ring 130. As can be seen, flexible ring 124 is pulled inward near magnets 178 to form a gear clearance zone 140.

Further Non-Commutated Inner Magnetic Ring Embodiments

Disclosed below are embodiments of a torque transfer device using a non-contacting and non-commutated magnetic cam to pull the flexible spline (FS) inward and/or outward with the majority of the force being concentrated at each of the FS wave max and/or minimum apexes.

The magnetic flux for this non-commutated ring is provided by one or more permanent magnets and one or more electromagnets. The functions of creating the wave form of the FS, maintaining the wave form of the FS and propagating the wave form are accomplished as separate functions in different ways with different embodiments of the present device. With a prior art mechanical cam, all three functions are combined into one device.

By using a non-commutated magnetic “cam” as disclosed here, the creation of the wave can be controlled separately with benefits that include but are not limited to:

a. The option to adjust the non-commutated (NC) ring force to allow increased force when required, such as for greater torque output conditions, or to reduce the NC mag ring force for lower friction, or to reduce it enough to allow lobes to disengage, or partially disengage to accomplish a fail-safe braking effect.

b. Propagating the wave form is accomplished with most embodiments of the present device by commutation of the electromagnetic stator. This eliminates the friction and inertia and speed limitations associated with a rotating and contacting cam component.

Features of the non-commutated magnetic ring include that a majority of magnetic force on FS is concentrated around one or more areas where the FS is radially closest to the NC mag ring. The areas of max force “follow” or are determined by, the wave shape. This is unlike the commutated mag force of the Electromagnet (EM) stator which “leads” or determines the wave apex position.

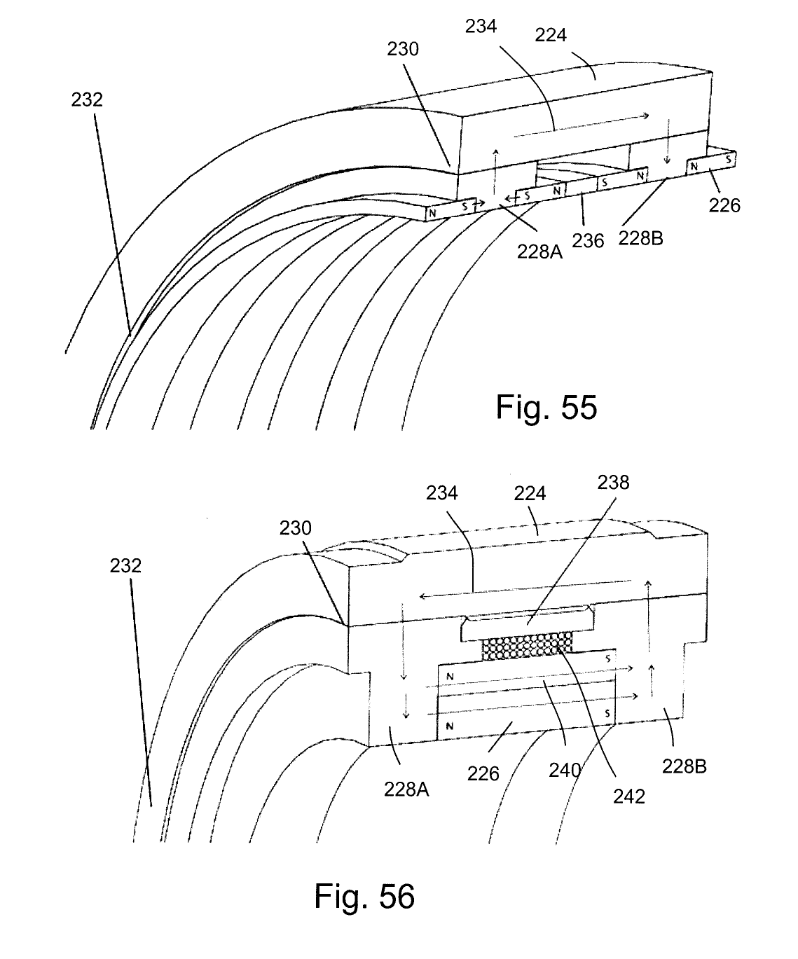

FIG. 55 shows an exemplary embodiment of a NC mag ring with a single, primarily axial flux path through the FS 224. One or more permanent magnets (PM)s 226 arrayed around one or both axial sides of a soft magnetic material ring 228A at one axial end of the FS provide flux to said ring of one polarity. Another soft magnetic material ring 228B at a different axial position is part of the return path for the flux from the original PM/s. Arrows 234 show a flux path through flexible spline 224. The attraction due to the flux path is greater in an area 230 with a smaller radial air gap than in area 232 with a larger radial air gap, thus acting to maintain the distortion of the flexible spline. The second ring may also have one or more PMs on one or both axial sides of the second ring that charge the second ring with the opposite polarity from the PMs on the first ring. Note that the outer poles of the outer PMs shown in FIG. 55 link back to the inner pole of these PMs through the air. This may be preferable in some embodiments where space or weight are saved by not providing a soft magnetic material flux return path. The PMs can be an array of individual magnets or a circumferentially uninterrupted ring mag. In the embodiment shown, central soft magnetic material ring 236 provides a flux path between inner permanent magnets.

FIG. 56 shows an exemplary embodiment of a NC mag ring with a single, primarily axial flux path 234 through the FS. One or more PMs arrayed around one or both axial sides of a soft magnetic material ring at one axial end of the FS provide flux to said ring of one polarity. Another soft magnetic material ring at a different axial position is part of the return path for the flux from the PM/s. The second ring may also have one or more PMs on one or both axial sides of the second ring that charge the second ring with the opposite polarity from the PMs on the first ring. Inner lobe ring 238 is shown in FIG. 56 and meshes with flex ring 224 at area 230.

In this embodiment, a soft magnetic material core 240 is coaxial with the PM (an array of individual EMs could also be used) and is shown surrounding the PM ring 226 here as a non-limiting example. When not energized, the core 240 of this EM coil 242 provides a flux return path for the PM ring, effectively “short circuiting” the PM flux to give it a lower reluctance path through the EM core as compared to through the air gap to and then through the FS. When the EM core is energized in the same axial direction/polarity, it increases the reluctance of the core to the linking of PM flux. When the EM is energized in the same direction/polarity as the PM, the EM core reluctance will increase with respect to the PM flux, so a percentage of the PM flux which is proportional to the EM core flux density, will be redirected through the next lowest reluctance path which includes the FS.

The EM core could also be configured with a higher reluctance (such as, but not limited to by using a smaller cross sectional area so it is closer to saturation when EM is not energized) so the EM could be powered in the reverse polarity to the PM to draw flux away from the FS. This configuration could be used to provide a powered brake that allows the FS to disengage or partially disengage from the inner lobe ring and/or outer lobe ring when the NC mag ring EM is powered in the opposite polarity to the NC mag ring PM.

An important feature of the embodiments of FIGS. 55 and 56 is that one or more PMs that contribute flux to a ring can do so at a different angular position than a smallest air gap, but the flux will still bias toward the smallest air gap because the circumferential continuity of the soft magnetic material ring allows flux to find the lowest reluctance path which includes the FS at the smallest air gap position (this is always true for the PM only NC ring. For the EM PM NC mag ring, the EM must be energized for this to be the case for the majority of the PM flux.

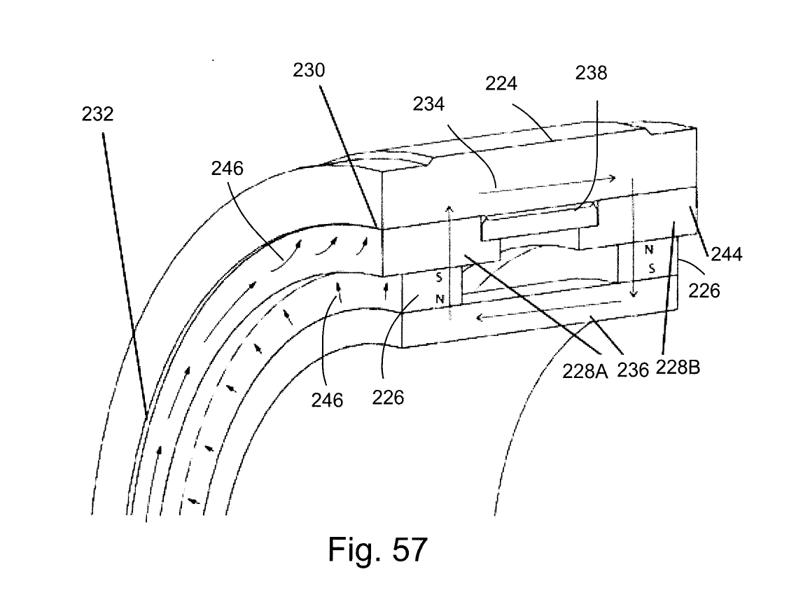

FIG. 57 shows another example of a non-commutated inner mag ring with one or more PMs 226 and soft magnetic material rings 228A and 228B acting as distribution rings 244 to allow PM flux from preferably any angular location to link through the flex spline at any angular position. In this way, the flux from an entire PM ring (or PM array) is able to contribute to the flux density at the smallest air gap between the distribution ring and the FS.

The solid head arrows 246 in FIG. 57 show the radial flux path from a radially magnetized PM and the circumferential flux path in the distribution ring that allows a significant percentage of the PM flux to “flow” to the smallest air gap between the distribution ring and the FS.

The air gap between the mag ring or distribution ring and the FS is usually referred to as a radial air gap in this disclosure. This is the preferred direction because it reduces the axial magnetic force on the FS. Air gaps which are not completely radial are considered to be less preferable in many applications but may still have benefit according to the principles of this device.

Radial PM NC MAG Ring

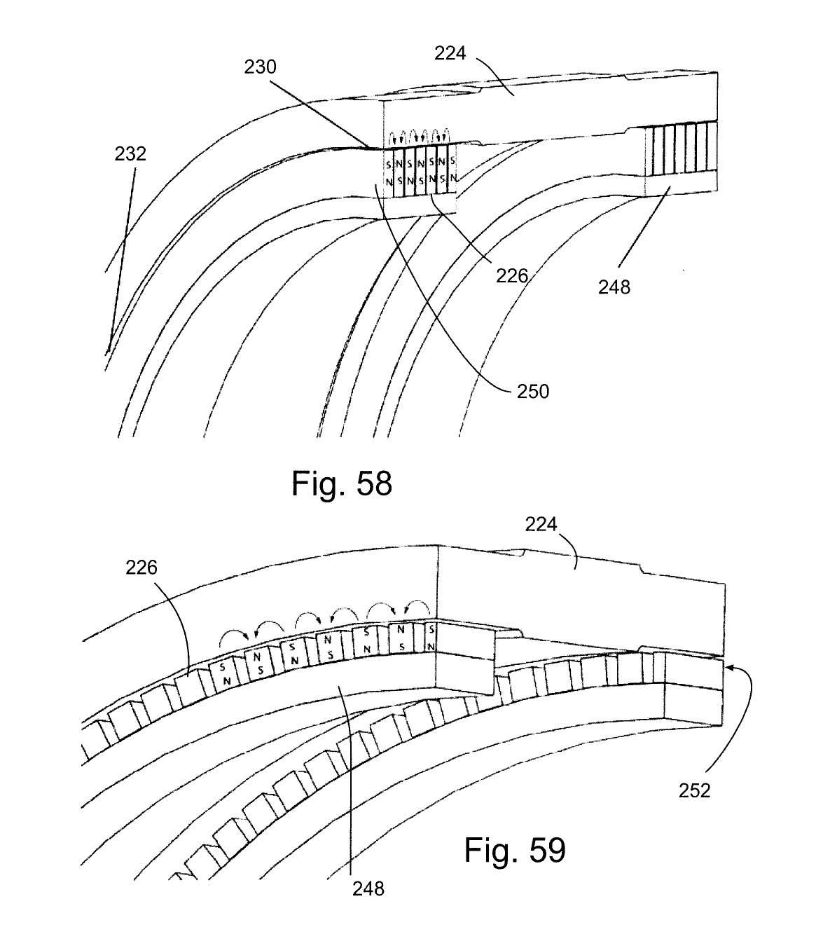

In the exemplary embodiment shown in FIG. 58, one or more PM/s 226 are magnetized in a primarily radial direction. A connecting member is preferably provided on the ID of the PM/s to provide a return path for flux that links from a PM through the FS 224. By placing two more PMs in an axial array 250 with NSNSNS poles contacting or with a gap between them, an increased flux density can be achieved around the ID of the PM/s (or ID of the PMs if the FS is inside the PM ring/array). The benefit of a shorter field is that it provides a significantly higher flux density at a smaller air gap as compared to a larger air gap. This achieves an important feature of the present device which is to use a non-commutated mag ring to create and maintain the FS wave form. The PM array is rotationally symmetrical/consistent so the FS does not strongly bias to any rotational position. The highest magnetic attraction between the inner mag ring and the FS is determined by the smallest radial air gap between these components which is initially established during assembly and maintained by the inner mag ring, according to the principles of any of the embodiments described here and/or the lobe/tooth geometry which does not allow complete disengagement.

Circumferential PM NC MAG Ring

In the exemplary embodiment shown in FIG. 59, two or more axially aligned PM/s 226 are magnetized in a primarily radial direction. A connecting member 248 is preferably provided on the ID of the PM/s to provide a return path for flux that links from a PM through the FS 224. By placing two more PMs 226 in a circumferential array 252 with NSNSNS poles contacting or with a gap between them, an increased flux density can be achieved around the ID of the PM/s (or ID of the PMs if the FS is inside the PM ring/array). The benefit of a shorter field is that it provides a significantly higher flux density at a smaller air gap as compared to a larger air gap. This achieves an important feature of the present device which is to use a non-commutated mag ring to create and maintain the FS wave form. The PM array is rotationally symmetrical/consistent so the FS does not strongly bias to any rotational position. The highest magnetic attraction between the inner mag ring and the FS is determined by the smallest radial air gap between these components which is initially established during assembly and maintained by the inner mag ring, according to the principles of any of the embodiments described here and/or the lobe/tooth geometry which does not allow complete disengagement.

Note that any of the non-commutated magnet ring embodiments can be applied to the ID and/or OD of the FS but are preferably on the ID because this is more effective to keep inner and outer lobes of the FS engaged with inner and outer lobe rings.

As seen in the various embodiments, a flex spline torque transfer device has a flex spline that is deflected in the radial direction by magnetic attraction to form a wave. The flex spline may be deflected radially inward by magnetic attraction to form a wave. The flex spline may be deflected radially inward by magnetic attraction at one or more positions equally spaced around FS ID. The attraction may be greatest at smallest radial air gap between FS and magnetic means and lowest at largest air gap. The magnetic means may or may not be actively commutated. The highest magnetic force may be determined by smallest air gap. In another embodiment, a torque transfer device has a flex spline that is deflected radially inward by magnetic attraction to a permanent magnet means at one or more positions equally spaced around FS ID. The magnetic means has one or more PMs and a distribution ring made of soft magnetic material. The ring allows flux to link back to the same and/or different PM/s at angular positions that change relative to the PM/s.

In other embodiment, the magnetic means has an OD with rotational symmetry (circular but can have radial irregularities, such as teeth or waves, as long as they are repeating and preferably rotationally symmetric/consistent). The magnetic means has flux which is produced by a non-commutated electromagnet (no PMs, just EMs). The magnetic means has flux which is produced by a non-commutated permanent magnet/s (no EMs). The magnetic means has flux which is produced by a non-commutated permanent magnet/s and one or more Ems. Flux from PMs is allowed to link back to originating PM or other PM through EM core/s when EM cores are not energized. If flux linkage through EM cores is reduced by energizing the EM core/s in opposite direction to passive PM flux direction, the next lowest reluctance path for PM flux is across air gap to FS/. The ems can be energized in either polarity. If in one polarity, more flux from the PMs is drawn through the EM core. If the other polarity, less flux links through the EM core/s. The magnetic means has flux which is produced by a non-commutated permanent magnet/s (with or without EMs). Separate magnets and/or poles are alternating NSNSNS in the circumferential direction. The spacing of each magnet or pole is less than 10 times the maximum difference between the largest radial air gap and the smallest radial air gap for a wave cycle. In various embodiments, less than 9, 8, 7, 6, 5, 4, 3, 2 times the circumferential space from pole to pole than the max radial air gap minus the min radial air gap (i.e., the wave magnitude). This spacing may be important for achieving a short enough magnetic field to achieve high force at small air gap and low force at high air gap. The smaller the circumferential space between poles, the shorter the field. The magnetic means has flux which is produced by a non-commutated permanent magnet/s (with or without EMs). Separate magnets and/or poles are alternating NSNSNS in the axial direction. The spacing of each magnet or pole is less than 10 times the maximum difference between the largest radial air gap and the smallest radial air gap for a wave cycle. There may be less than 9, 8, 7, 6, 5, 4, 3, or 2 times the axial space from pole to pole than the max radial air gap minus the min radial air gap (i.e., the wave magnitude).

The FS may be deflected outward by magnetic force provided by a magnetic means, as described above, acting on the OD of the FS. Note that magnetic rings can be fixed to the reference and/or output members or can be free spinning.

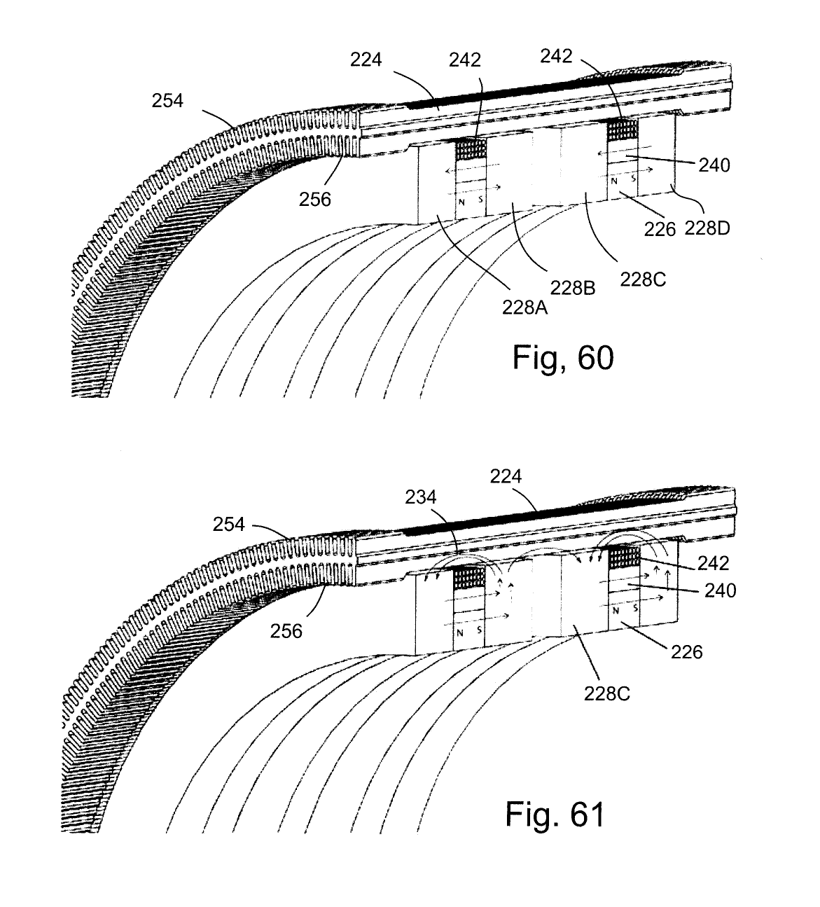

FIG. 60 is a simplified schematic partial section view of an embodiment of a FS with a set of non-commutated permanent mag rings 226 with electromagnets allowing a safety brake effect when power is lost. The inner mag rings are located axially between the lobes on the FS. This provides stability to the FS by spacing the lobes as axially far apart as the width of the FS will allow. The inner NC mag ring makes use of the axial laminated-like structure with multiple poles for flux to flow and a large surface area for maximum magnetic cam force. There can also be an EM or EM-PM stator located on the OD of the FS and it preferably (but not necessarily) also acts on an area axially inward from the lobes. The circular inner lobe ring and outer lobe rings are not shown in this figure, but outer lobes 254 on the flex ring for meshing with the outer lobe ring and inner lobes 256 on the flex ring for meshing with the inner lobe ring are shown. Using a distribution ring (two sets of two distribution rings 228A-228D shown here as a non-limiting example) PM flux form a PM ring magnet or an array of PM magnets with similar pole alignment can be “short circuited” through one or more EM cores when said EM cores are not energized as shown here. This reduces the effectiveness of the PM mag flux to hold the FS in a deformed shape, and allows the FS to disengage or partially disengage, when said EM/s are de-energized as shown in FIG. 60.

FIG. 61 shows the same assembly with the EM core ring 240 energized in the same direction/polarity as the PMs. This prevents PM flux form “short circuiting” through the EM coils. The flux then links back to the originating PM and/or another PM along the next lowest reluctance path which includes the FS. To link through the FS, the flux must jump one or more air gaps on the path originating from a PM, so the PM flux (and any flux that is added to the circuit by the EM) is used to hold the FS in the wave form shape.)

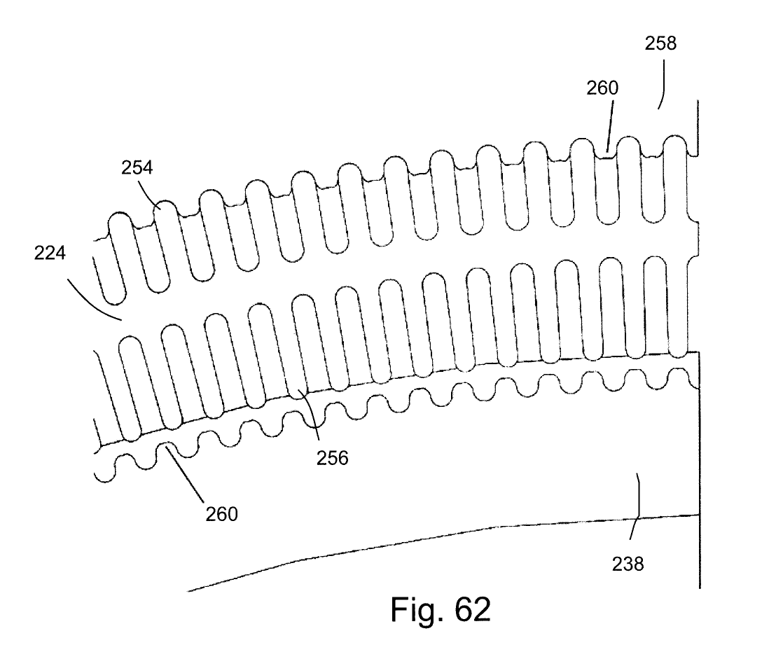

FIGS. 62-64 show a preferred lobe geometry that can be used in the embodiment of FIGS. 60-61 and in other embodiments for a safety break disengagement effect. As shown in FIG. 62-64, inner lobe ring 238 and/or outer lobe ring 258 may have a detent 260 on the lobe tips that meshes with the flex spline when the flex spline disengages from full mesh when the inner (and/or outer) mag ring is de-energized, allowing the FS to relax to a more cylindrical shape. In the embodiments shown, the detents 260 are present both on inner ring lobes 262 and outer ring lobes 264.

FIG. 62 shows the flexible spline fully engaged due to the forces from the inner mag ring (not shown).

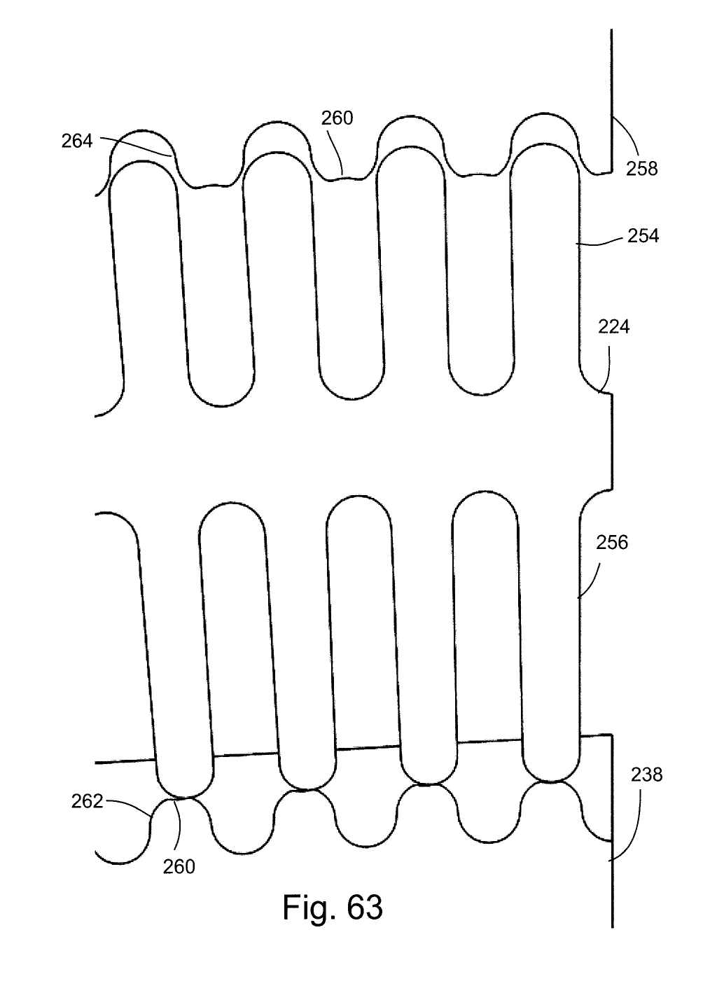

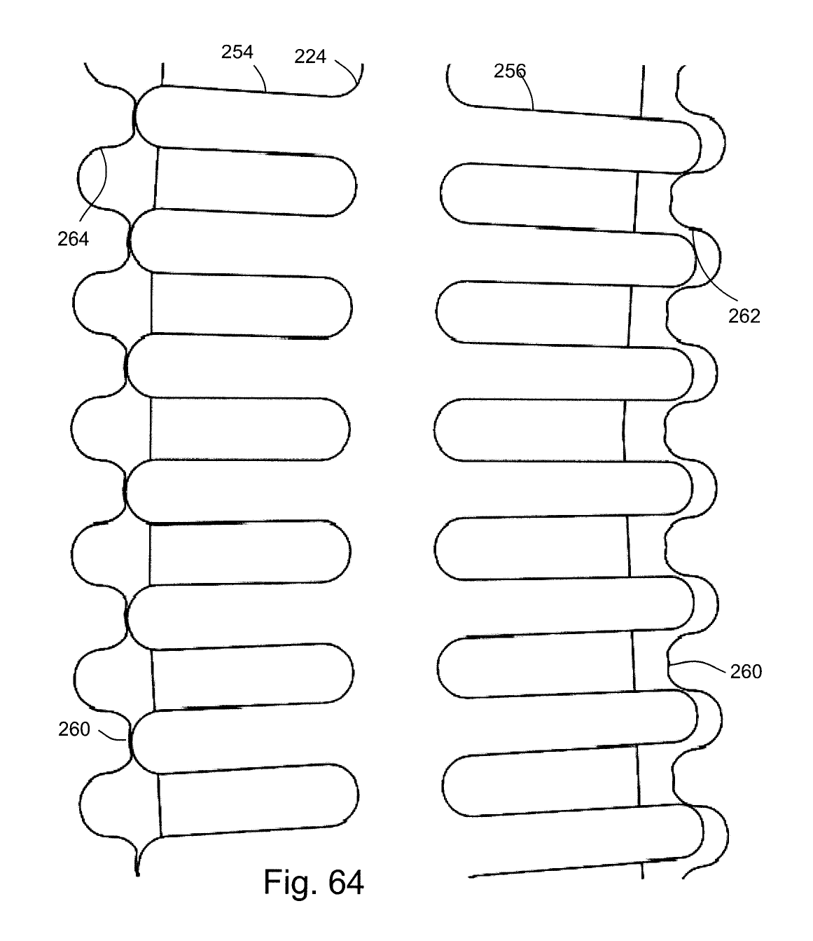

FIGS. 63 and 64 show detail views of safety brake lobe tip detent when inner mag ring is de-energized (and, for example, when the commutated EM/s are at low enough power that they cannot keep the FS in engagement). Note that the FS is not allowed to fully disengage due to mechanical interference. The lobe tip interference of the FS and inner lobe ring (and/or the FS and outer lobe ring) prevents the FS from returning to a completely relaxed state and also prevents the FS from skipping a lobe. In this way, several characteristics can be achieved. FS and inner lobe ring lobe tip detent interference is shown in FIG. 63 at 12:00 position. FS and outer lobe ring lobe tip detent interference is shown in FIG. 64 at 9:00 position.

If the inner mag ring remains energized enough to re-engage the FS into full mesh, variations of this geometry (specifically, the geometry that allows partial disengagement while preventing full disengagement and lobe-skipping) will act as an overload clutch. The effect on the actuator is that when the maximum torque capacity of the system is exceeded, the FS 224 will partially disengage from the outer and/or inner lobe rings. This will increase the air gap to the commutated magnets causing the torque output capability to be reduced. This has been shown to act as an effective overload clutch mechanism which prevents output torque form exceeding a predetermined maximum without skipping lobes to an unwanted FS/lobe ring alignment.

If the inner mag ring is de-energized enough to where the FS 224 will engage with the inner lobe ring and/or outer lobe ring tip detents 260, the detent contact will provide a high level of resistance to FS motion, effectively locking the actuator. This is especially useful for power-out conditions where a load must remain suspended in cases of unexpected power loss.

Embodiments with Axial EMs with Axial PMs

A feature of an embodiment of the present device is the ability to exert a radial force on the flex spline using magnetic attraction. Advantages of this input method include eliminating the inertia of a spinning input motor rotor, and a shorter assembly due to the possibility of surrounding the flex spline with the electromagnets.

Direct electromagnet drive has been disclosed by a number of harmonic drive designers going back to the original Musser patent. The non-commutated inner mag ring of embodiments of the present device allows outer (or inner) Ems to provide wave propagation input without wasting additional EM power to create and maintain the wave. The low separation force of the radially elongated zippering lobes of embodiments of the present device allow greater torque for a given radial force from the non-commutated inner mag ring. The combination of these two features allows high torque to be accomplished with low inertia and input friction.

Propagating the wave with electromagnetic force has its own challenges that are addressed with various embodiments in the present device. Advantages of this input method include eliminating the inertia of a spinning input motor rotor, and a shorter form factor due to the possibility of surrounding the flex spline with the electromagnets. Achieving high pulling force on the flex spline and high overall efficiency is challenging with a direct EM drive for a number of reasons. The requirement for high flexibility of the flex spline is a limitation for conventional tooth forms because conventional tooth forms require a radially thin flex spline. This limits the magnetic volume that the Ems can act upon, thereby limiting the total radial force for a given FS length. The radially elongated lobe shape of the present device includes radial slots between each lobe which allows a higher volume of material for a given FS flexibility (as compared to if the FS had conventional teeth with no radial slots). The EMs can be located on the ID and/or the OD of the FS. Locating the EMs on only the FS will be shown here. The EMs can be configured to pull directly on the lobe tips, or a cylindrical area on the FS can be provided for a more consistent air gap. The flux that flows form EM to EM and/or from the North pole of an EM to the South pole of said EM can flow axially and/or radially through the FS. An advantage of an axial flux path is the thin lobe sections that are aligned axially and that have a similar characteristic to a laminated construction with regard to eddy current generation. For this reason, it is preferable to combine the zippering lobe feature of the present device with an axial flux path EM configuration as shown in this exemplary embodiment.

Attracting a soft magnetic material such as, but not limited to, 4340 steel (as is given as a preferred exemplary material for the FS because of its high strength and high fatigue life characteristics) requires more electrical energy than attracting a permanent magnet in, for example, a spinning rotor of a permanent magnet brushless DC motor. Attaching permanent magnets to the FS is one way to deal with this but this has other challenges related to suspending the magnets without over-stressing them as the FS goes through millions or even billions of cycles.

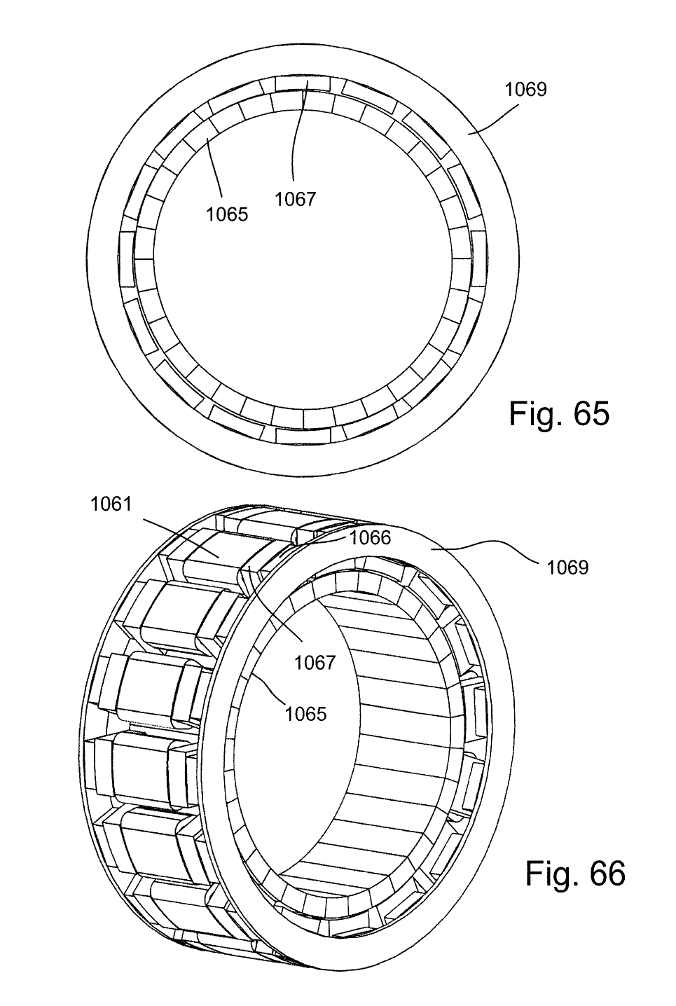

A variety of configurations are disclosed here which take advantage of the increased efficiency of using permanent magnets without attaching these permanent magnets to the FS. FIGS. 65-69 show an exemplary embodiment of an EM coil combined with PMs in such a way as to accomplish a primarily axial flux path thru the FS with reduced electrical energy required to energize the EMs. In this exemplary embodiment, the EM coils are aligned axially so a north pole is toward one axial side of the FS and the south pole of the EM is toward the other axial end of the FS. An array of these EMs encircles the FS and can be any number including but not limited to sixteen EMs as shown here. Each EM is flux linked to an end plate which provides a flux path from the EM coil core radially inward to the flex spline. As the flex spline wave is propagated, the air gap between the FS and the end plates will change in the radial direction. Energizing a coil at a position between TDC and BDC will pull that section of the FS to a smaller air gap position and shape. This, in turn generates torque on the output lobe ring and housing.

To increase the efficiency and/or output torque, permanent magnets are included in the assembly on the opposite axial side of preferably all end plates on one or both axial ends of the EM array. The PMs on one axial end of an end plate array are configured with every first PM having poles axially aligned in the same direction, and every second PM with poles all aligned in the opposite direction. This results in a situation where the flux path of the PMs will complete though the EM coil cores when the EM coil cores are not energized. By choosing a combination of:

a. PM strength

b. Core cross section and material

c. End plate-to-FS air gap

. . . the assembly can be configured for a range of effects that include but are not limited to the following:

In one configuration, using PMs with a high enough field strength to saturate or nearly saturate the EM cores, will cause a percentage of the flux path to jump the air gap between the end plates and the FS when the EM coils are not energized. In this case, the EM coils are preferably energized in the same polarity as the PMs when the FS is moving radially away from them. The EM coils are then energized in opposing polarity to the PMs when the FS is moving radially toward the coil/end plates to steer the PM flux and the EM flux across the air gap to the FS to attract the FS to the end plates.

In another configuration, using PMs with a low enough field strength to link through the EM cores, without causing a significant percentage of the flux path to jump the air gap between the end plates and the FS when the EM coils are not energized is preferable. In this case, the EM coils need not be energized in the same polarity as the PMs when the FS is moving radially away from them (because there is no passive PM flux force on the FS to oppose). The EM coils are then energized in opposing polarity to the PMs when the FS is moving radially toward the coil/end plates, to steer the PM flux and the EM flux across the air gap to the FS to attract the FS to the end plates.

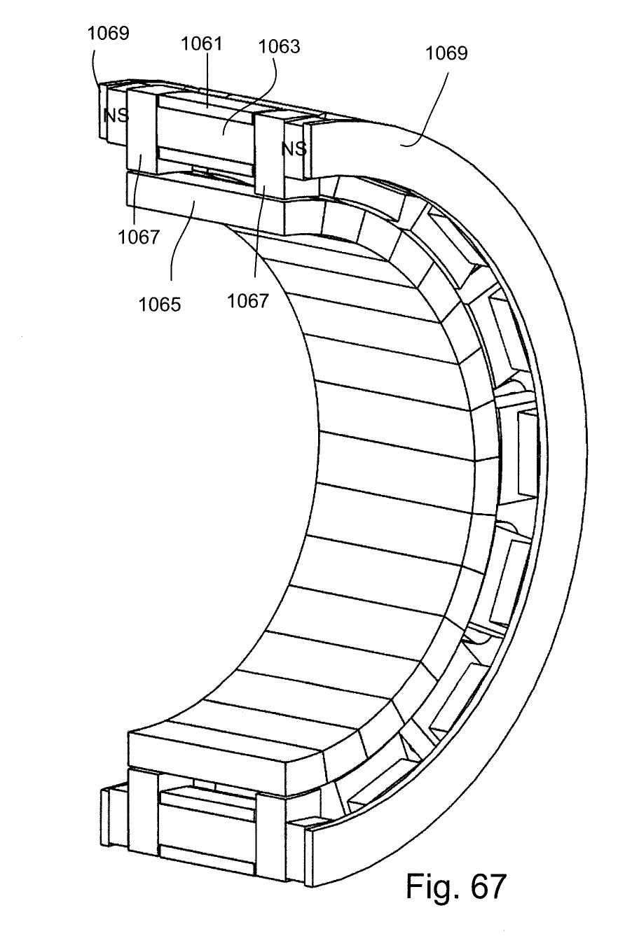

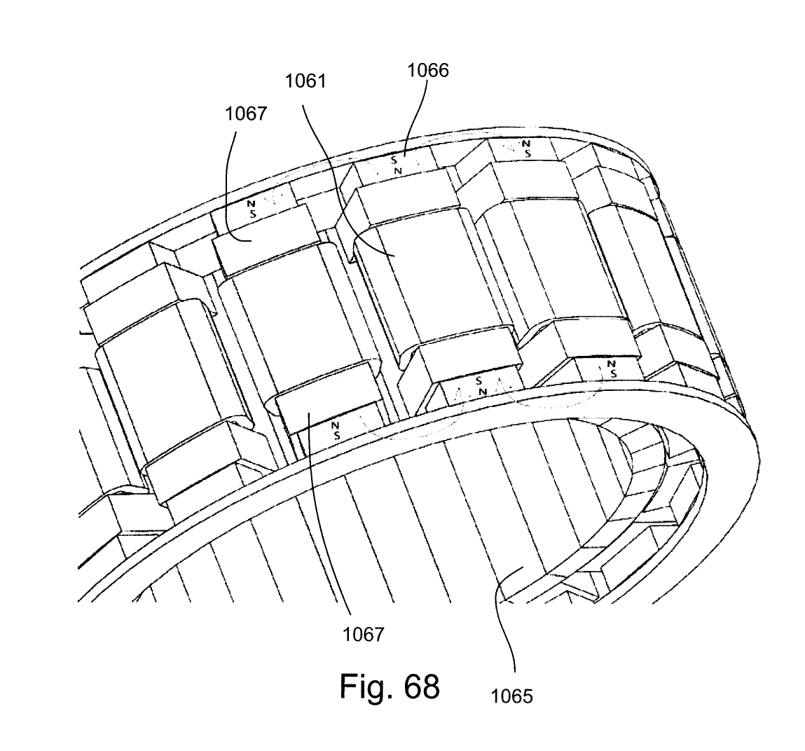

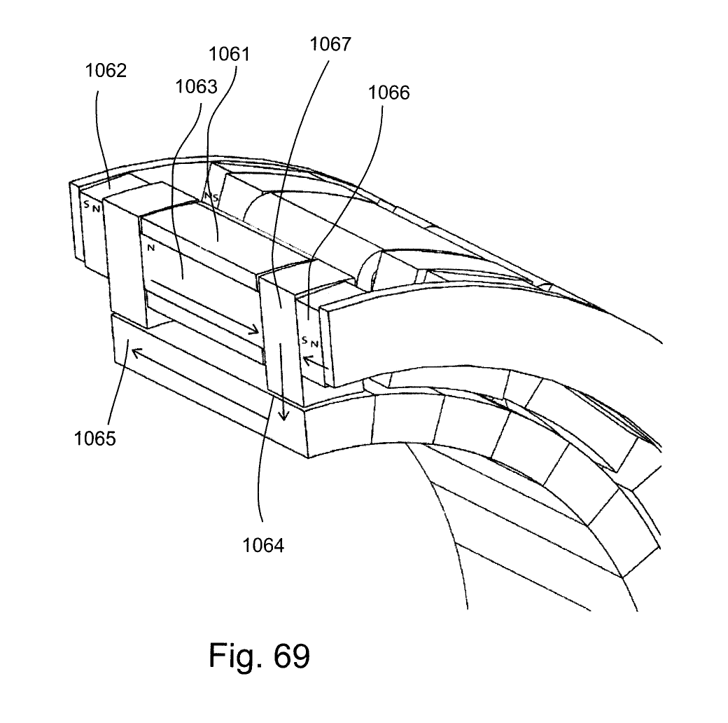

FIGS. 65-69 show an embodiment. FIG. 65 shows a side view of the embodiment. FIG. 66 shows an isometric view and FIG. 67 shows a section isometric view. FIG. 68 shows another isometric view showing circumferential flux linkages between PMs. FIG. 69 shows a detail section isometric view. The FS is shown as segmented in these simplified schematic images. Referring to FIGS. 65-69, and more particularly to FIG. 69, when EM 1061 is energized in opposition to PM 1066, the flux from EM 1061 prevents flux from PM 1066 from linking with PM 1062 through EM core 1063. The flux from PM 1066 and EM 1061/core 1063 then both take the next lowest reluctance path which is through end plate 1067 and across the air gap 1064 to the FS 1065 and axially through the FS to the N pole of the PM 1062 and EM 1061/core 1063. This has been shown, by experimentation, to be a proportional effect where the flux from PM 1066 that is redirected across the air gap 1064 and axially through the FS 1065 by the EM coil 1061 and core 1063, increases in proportion to (although not in a linear relationship) the current in the EM coil 1061. This allows proportional control of the flux density jumping the air gap 1064 between the end plate 1067 and the FS 1065, and, therefore, proportional control of the amount of magnetic force acting on the FS. The use of PMs in this way can increase the amount of magnetic force acting on the FS for a given level of electrical energy into an EM coil. Side irons 1069 are shown in FIG. 67.

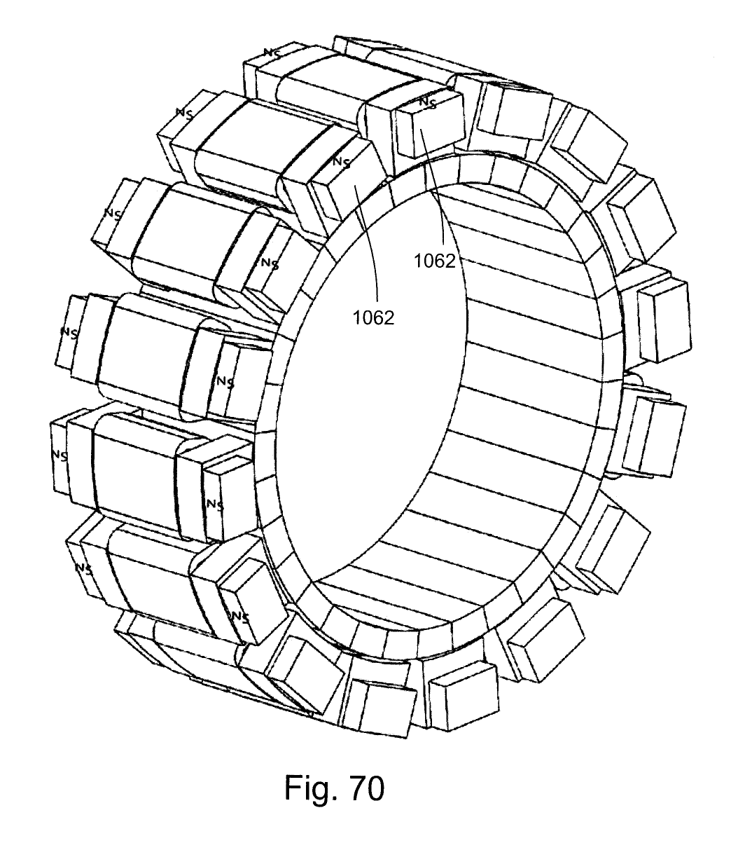

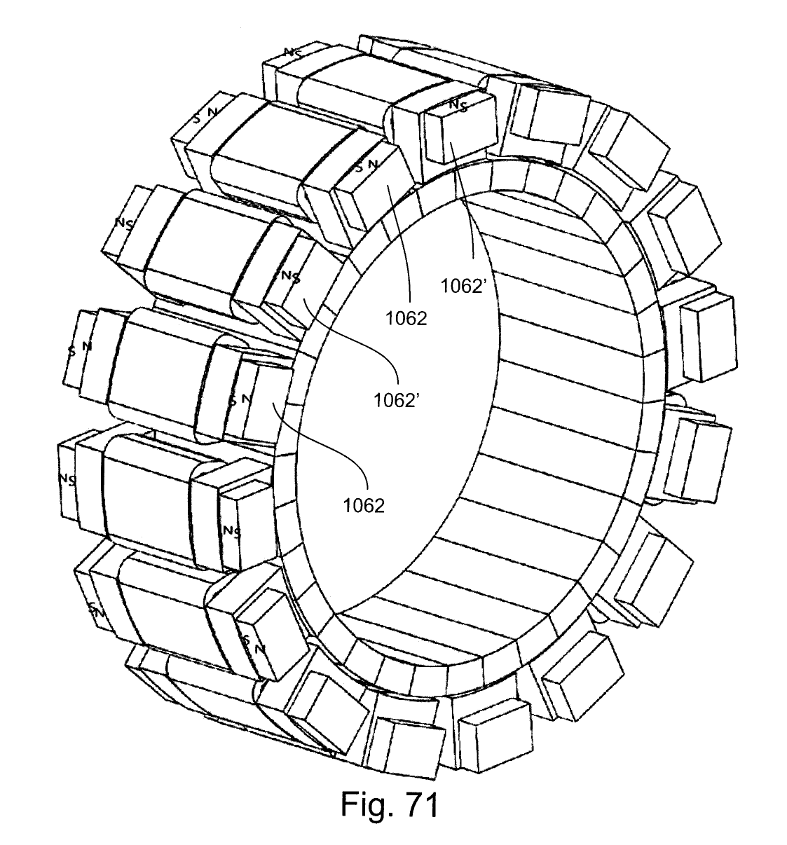

In another embodiment, the side iron rings 1069 are not used on one or both axial ends. In this case, the flux linkage from PM to PM is partly through the air. Pole alignment for the PMs can be the same for all magnets or reversed for every second set of PMs. FIG. 70 shows an embodiment with all PMs 1062 in the same alignment. FIG. 71 shows an embodiment with every other PM 1062 in reverse polarity alignment, such that PMs alternate between a first polarity 1062 and a second polarity 1062′. In both cases it is preferable that if an EM has PMs at both ends, that both PMs have the same alignment.

A flex spline motor with commutated electromagnet input can have one or more PMs, such that at least part of the flux from the PMs links though and EM coil when the coil is not energized, and at least part of the flux from the PM is directed across the air gap to the flux with energization of the EMs. The reluctance of flux linkage (back to the same magnet and/or to other PMs in the circuit) through the core may be low enough that energizing the cores in the same polarity as the PMs is not required at BDC. The PM flux linkage (back to the same magnet and/or to other PMs in the circuit) through the EM core may be high enough reluctance that a positive EM polarity reduces the PM flux linking across the air gap to the FS and through the FS. A linkage member may provide a unidirectional flux path between a North pole on a PM and a South pole on another PM. Flux may flow axially through the FS. EM coils may be situated for axial flux path through the EM cores. EM coils may be energized sequentially in alternating polarity. An EM coil may be energized in opposite polarity to a PM which is flux linking through said EM core to increase radial magnetic force on the FS. An EM coil may be energized in the same polarity of a PM that is flux linking through said EM core to reduce the flux linking through the FS. There may be EMs on the OD of the FS. There may be EMs on the ID of the FS. Any of the above may be used in combination with a non-commutated mag ring. Any of the above may be used in combination with the zippering lobe geometry.

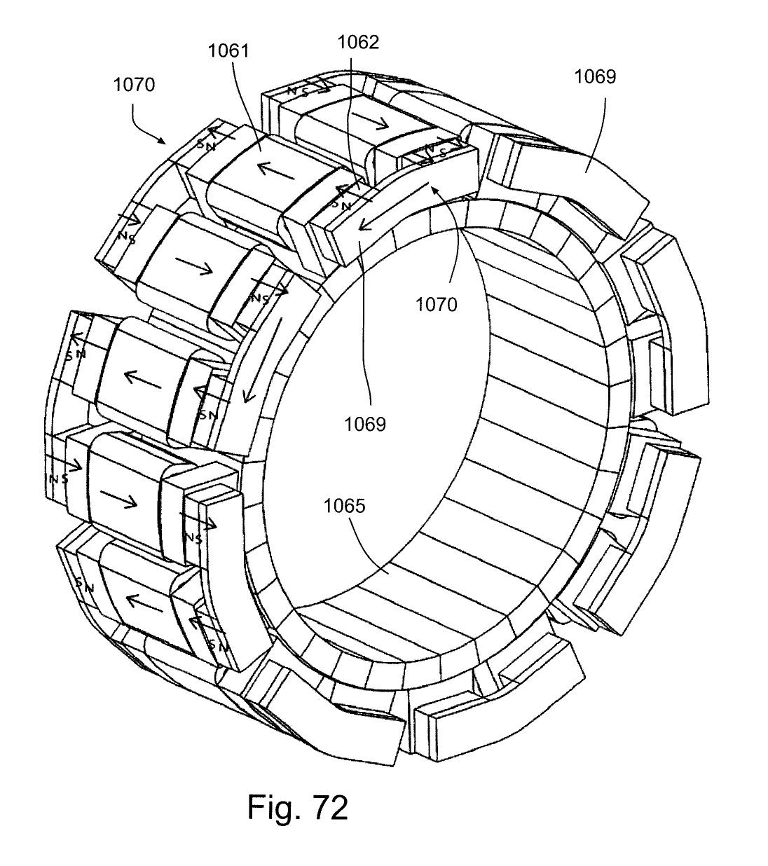

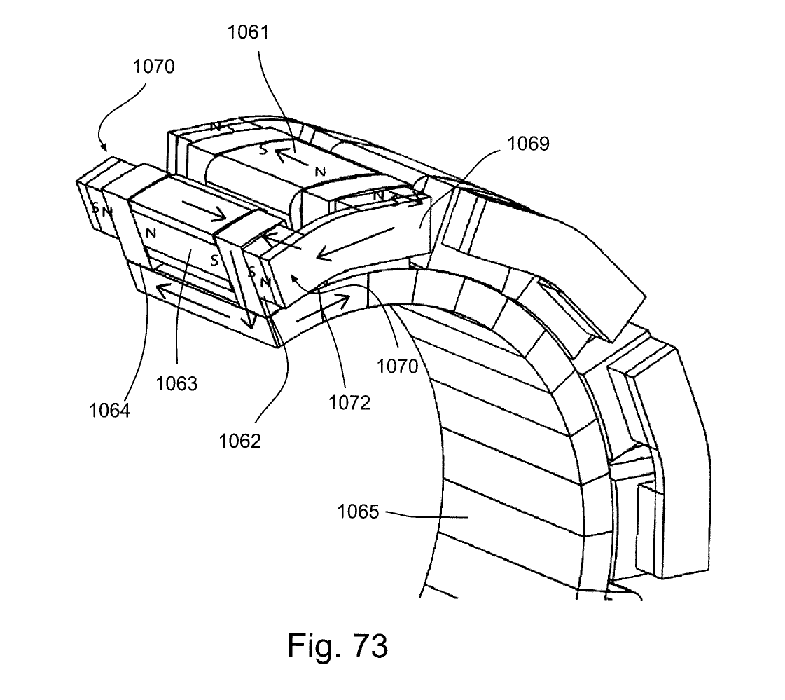

In another embodiment, shown in FIGS. 72-73, each side iron 1069 only connects every second PM 1062 on each axial end 1070 of the unit. Such provides a passive flux path (that is, a path for the PM magnets when the EM coils 1061 are not energized) that will stay in the PMs 1062 and EM cores 1063 without jumping the air gap 1064 to the FS 1065. This requires computer analysis and/or testing to determine the maximum PM flux density that will allow insignificant force on the FS to be achieved when the EM coils are not energized. In one exemplary embodiment, neodymium iron boron PMs are combined with EM coils of a similar cross sectional geometry. FIG. 72 shows the flux path when EMs 1061 are not energized. Intermittent side iron plates 1069 (for example made of soft magnetic material such as but not limited to silicon steel) provide uninterrupted flux path for PM flux. FIG. 73 is a sectional view of the flux path when the EMs 1061 are energized in opposite polarity to the PMs 1062. The flux is rejected from passing through a coil, and takes the next lowest reluctance path across the air gap 1064 to the FS 1065 and through the FS 1065 to the other end of the EM 1061. As the axial path through the FS gets closer to saturation, the flux can also flow circumferentially through the FS to the end plate on an adjacent EM (shown at 1073 in FIG. 73).

For clarity in this disclosure, flux direction is shown with arrows from N to S internally in a magnet (PM or EM). It is recognized by the inventor that flux doesn't actually flow, but this terminology may be used for illustrative purposes. The flux steering principle used in these embodiments is that any time an EM is energized in the opposite polarity to a PM, the reluctance to flux linkage through that EM is increased and the flux will prefer to flow along a lower reluctance path. These EM-PM embodiments are configured so the next lowest reluctance path for the flux from a PM is radially though and end plate at one end of an EM, radially across the air gap from said end plate to the FS, axially and/or circumferentially through the FS toward one or more other air gaps radially adjacent to an opposite polarity end plate/s.

If an EM is energized in the same direction as a flux linked PM, it reduces the reluctance through the EM core and draws flux away from the air gap. Drawing flux away from an air gap is only preferable if the flux density in the path is high enough that a significant percentage (such as 20%, although greater or lesser percentages will be considered significant in specific applications) is forced to jump the air gap to the FS.

Although it takes additional electrical power to draw flux though a core by energizing a core in the same polarity as an adjacent PM, designing the system to require this same polarity EM energization has the preferable characteristic, for some applications of enabling the use of more powerful PMs. The benefit of more powerful PMs is a reduction of the electrical energy required to steer the PM flux toward the FS by energizing the EMs in reverse polarity. The net gain of higher powered PMs has been shown by experimentation to yield a net benefit even if the EM coils must be energized in the same polarity to draw passive PM flux through them after TDC.

If the flux density of an adjacent PM though an EM core is not high enough to increase the reluctance in said core to a high enough reluctance to cause a significant percentage of flux form said PM to jump the endplate-to-FS air gap, there is no need to energize an EM in the same polarity as an adjacent PM. This PM power is considered preferable, for example, if free backdriving is desired when the actuator is not powered.

The flux path of one or more PMs includes one or more EM cores. When an EM core is unenergized (or energized in the same direction/polarity as the PMs), the majority of the flux from a PM which is adjacent to said core links back to itself or to another PM though said core. When said core is energized in opposite direction/polarity, the flux from said PM is directed or steered to the next lowest reluctance path. This includes a radially aligned end plate located axially and/or circumferentially between said PM and said EM. At the radial termination of said end plate where it faces the FS, the flux crosses the air gap to the FS, flows axially and/or radially to another air gap/end plate to link to said or another PM and the same or another EM. Steering flux that is provided by one or more PMs requires less energy than creating the same density of flux with an EM, so this flux steering method is able to provide higher forces and greater efficiency than using EM coils alone.

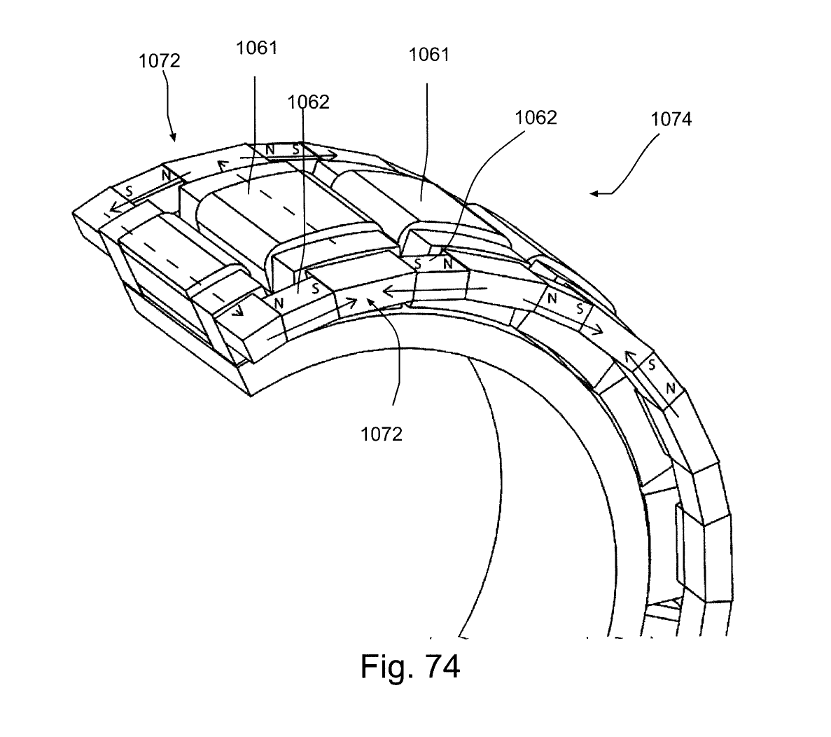

FIG. 74 shows an example of a circumferentially aligned EM-PM stator which operates according to one or more of the above principles but with a different structure.

All configurations in this disclosure are given as non-limiting examples. The flux steering principles disclosed here to propagate a harmonic drive flex spline can be applied in many different configurations that are anticipated by the inventor. The flux steering principles are as follows: a permanent magnet is arranged in proximity to an electromagnet with a soft magnetic material core such that the majority of the flux from the PM links back to itself and/or another PM through the core of the EM when the EM is not energized and/or when the EM is energized in the same direction/polarity as said PM. When the EM is energized in reverse polarity, a portion of the flux from the PM (including all of the flux from the PM) which was previously linking through the EM core is redirected along an alternate flux path which includes crossing an air gap to the flex spline.

The exemplary embodiment shown in FIG. 74 has an array of EM coils 1061 arranged axially (although other coil alignment directions are anticipated such as, but not limited to radial and or circumferential) with a PM 1062 between each coil 1061 on one or both axial sides 1072 of the stator 1074. PMs on both axial sides are shown here. If PMs are on only one side, then a magnetic material such as steel will preferably link poles on the opposite axial side from the PMs.

Flux linkages are shown when EMs are not energized and flux from PMs links back to originating PM and/or other PMs through an EM core (shown in broken line in this image). Due to the low reluctance flux path through the EM cores (as a result of the EMs not being energized or energized in the same direction as the PMs), the majority of the flux prefers to flow through the EM cores rather than crossing the higher reluctance air gap between the end plate and the flex spline.

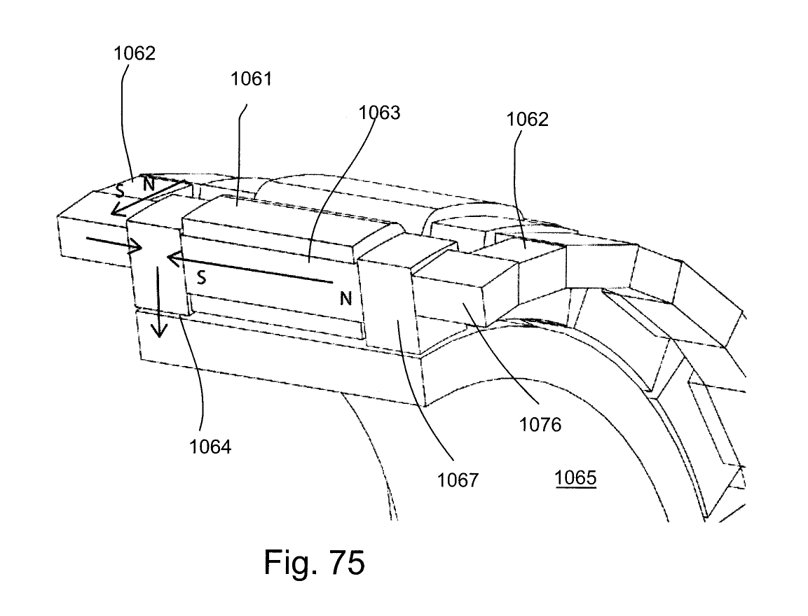

FIG. 75 shows the same configuration as FIG. 74 with the cross sectioned EM coil 1061 energized in reverse polarity to the PMs 1062, which were linking through that coil when said EM coil 1061 was passive or energized in the same direction/polarity as said PMs 1062. A portion of the flux that was previously linking through the EM core is now redirected to the next lowest reluctance flux path which includes the primarily radial air gap between the flux linkage member (end plate) and the FS.

Coil 1061

EM core 1063

End plate 1067

Flux linkage member 1076 attached to (or one piece with) the end plate 1067

PM 1062

Flex spline 1065 (simplified, for illustrative purposes, with no lobes or slots)

Core 1063, end plate 1067 and member 1076 can all be one piece. The important thing is that they provide two alternative paths for the flux. One path includes the core 1063. The other path includes the air gap 1064 and FS.

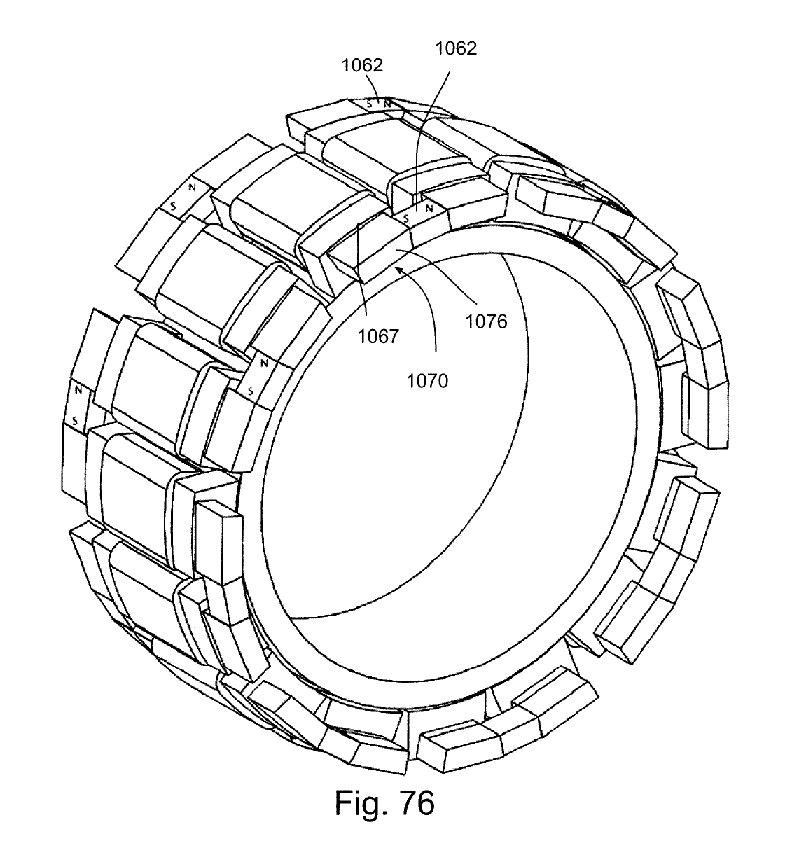

FIG. 76 shows a circumferential PM 1062 configuration with alternating PMs 1062 and no direct flux linkage 1076 between endplates 1067 on an axial end 1070. In this example, it is preferable for all PMs 1062 to be circumferentially aligned in the same polarity.

In all exemplary embodiments, it is understood that all EM coils are controlled by the motor controller individually. With two wave apexes on the FS, two opposing coils are preferably linked together for simplicity and symmetry to form an EM pole. Each coil or pole is then energized/commutated in a sequence that applies a magnetic force to the FS causing the wave to propagate.

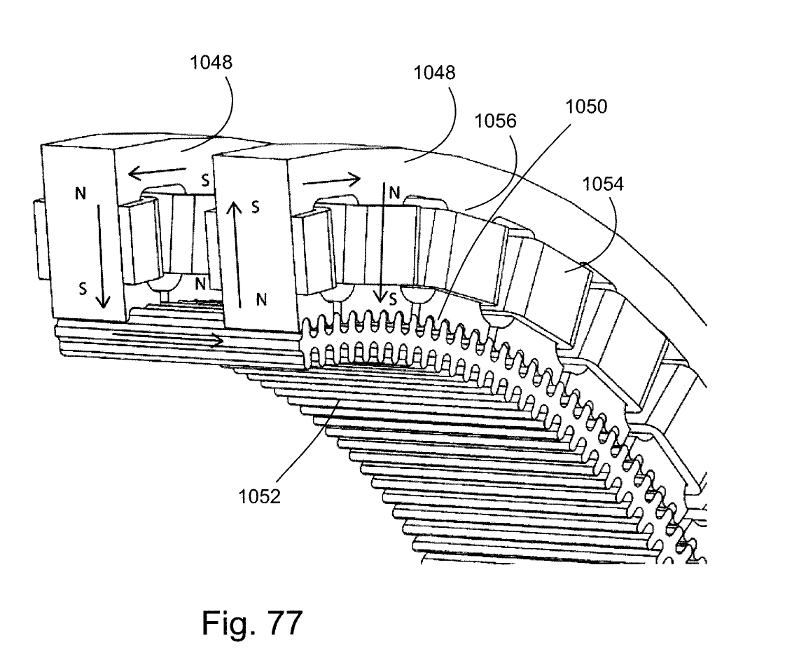

FIG. 77 shows a stator 1048 with integrated lobes 1050 for engagement with the FS 1052. The stator in prior art devices has one core ring and requires flux to travel circumferentially through FS to get from a N pole to a S pole. This exemplary embodiment uses two or more axially aligned stators 1048 having coils 1054 on each axially aligned set of posts 1056 that are wired for opposite polarity to each other. The stators 1048 can be wired for commutation in a number of ways that are well known to motor designers including as a stepper motor or as a three, four, five, or more phase device. By splitting the stator into two axially symmetric components, it allows the flux to link axially through the FS. This is considered to be advantageous because the cross sectional area of the FS will be greater in the axial direction than in the circumferential direction. With a split stator configuration, flux can still link circumferentially between energized poles of opposite polarity, but a significant percentage of flux will find the shortest path along the lowest reluctance direction, axially through the FS.

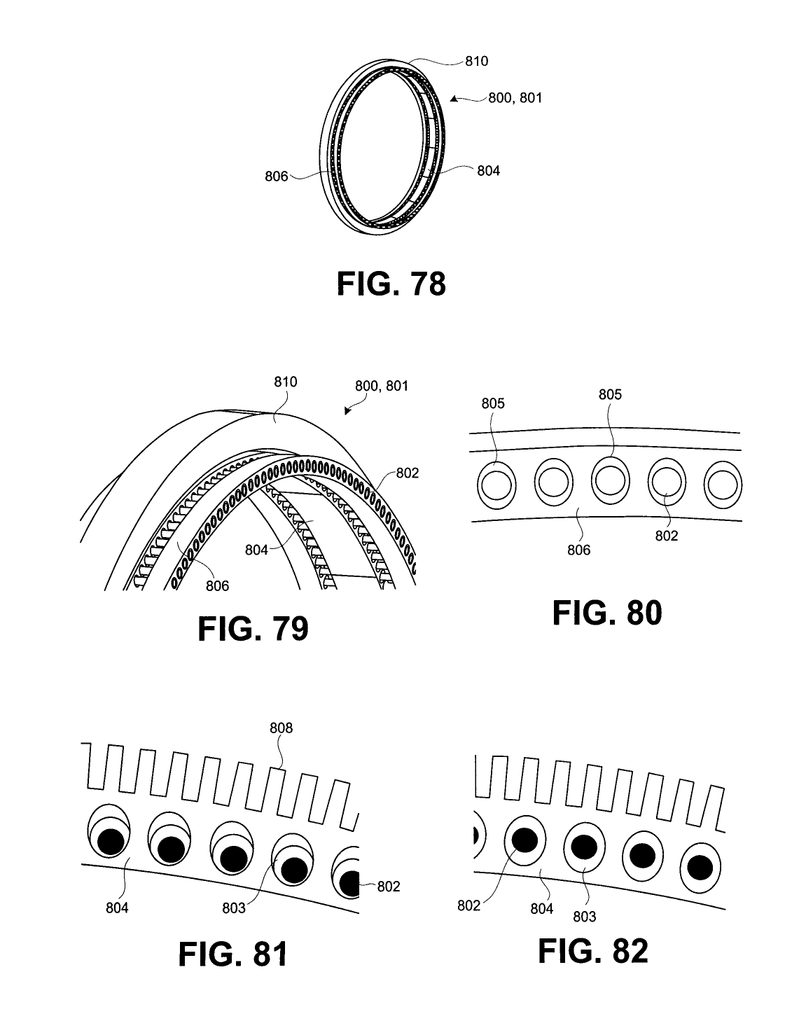

In FIGS. 78-79, there is shown a harmonic drive actuator 801, which transmits torque through an array of pins 802 which couple the flex spline 804 to the housing 806. The flex spline 800 functions with a permanent magnet array (not shown in these figures) providing the inward radial force required to hold the spline 800 in its elliptically deformed state and with propagation of the wave shape accomplished through sequentially commutative ring, an array of electromagnets pulling inward and or outward on the flex spline 800. Interaction of the propagating wave of the flex spline 800 with outward facing teeth 808 and the inward facing teeth of the output ring 810 results in rotation of the output ring 810. Rotation of the output ring 810 is by one or more gear teeth for every wave cycle of the strain wave member 804 has its teeth 808 mesh with the output ring teeth. The electromagnet coils are preferably porous in the sense that they have fluid flow channels passing through them. Increasing the surface area exposed to the surrounding fluid as compared to conventional wires which are either round or squared and that prohibit the flow of fluid through a conventional coil. The fluid is passively or actively caused to move across the coils and is passively or actively cooled. This allows higher operating current without overheating the magnets and therefore higher maximum magnetic force available for holding the flex spline and/or applying torque to move the actuator.

Application of the orbiting pin 802 coupling and the interstitial fluid flow path coils are both illustrated here in use with a strain wave actuator, but the orbiting pin coupling can be used to control the motion of any orbiting member, and the interstitial fluid flow path coils can be used in any electrical machine which would benefit from increased coil cooling.

In an embodiment, each pin coupling 802 is free to orbit, and rotate inside a round or non-round bore 805 at either end in the stationary housing 806. The pins 802 pass through an elliptical or preferably ovoid hole 803 in the flex spline 800, shown in FIGS. 80-85. The preferable shape of the hole 803 is determined by the range of motion of the flex spline 804 as it moves in and out of contact with the gear teeth on the outer ring 810. As the strain wave propagates through the flex spline 804, each section undergoes a somewhat elliptical or ovoid translation. During this translation, a pin 802 maintains a rolling contact with the inwardly facing surface/s and/or edges of the axial hole 803 through the flex spline 804. In this way, the pin 802 prevents relative rotation of the flex spline 804 to the housing 806 while still allowing the strain wave(s) to propagate. The rolling contact reduces friction between each pin 802 and the flex spline 804 allowing the flex spline 804 to move freely along the motion path defined by the pin through-hole 803.

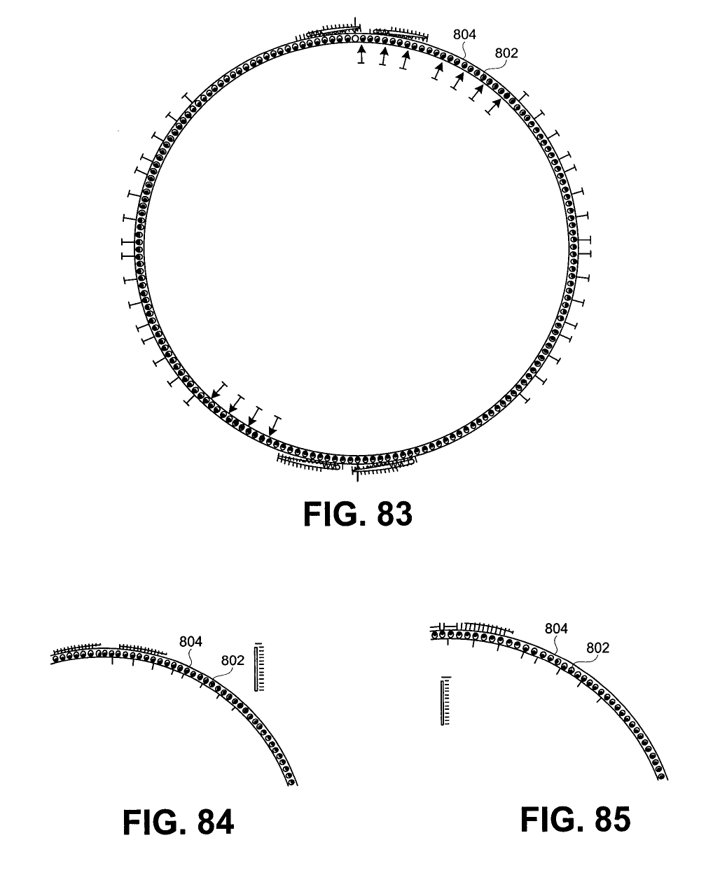

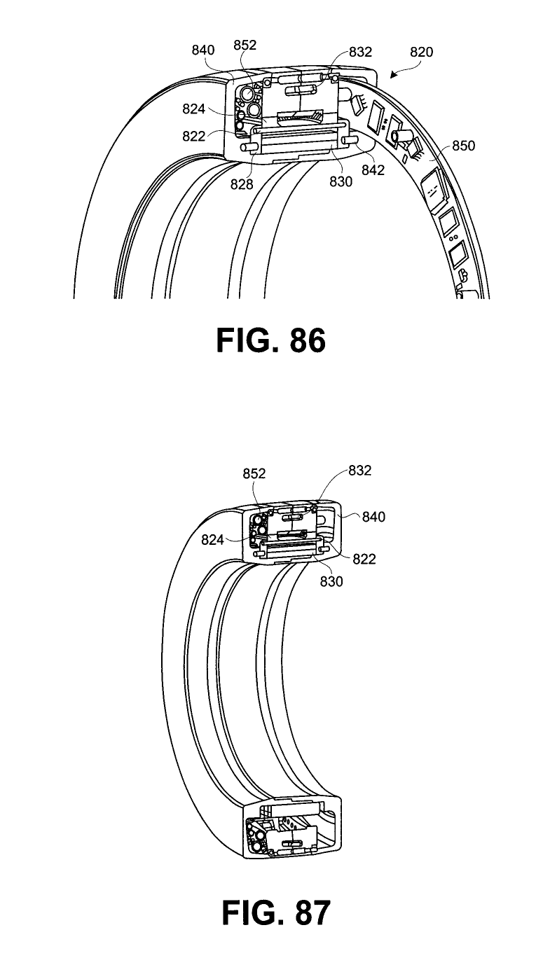

FIG. 80 shows openings in a fixed housing 806, with the pin couplers 802 in neutral position in ovoid holes 805. In FIG. 81, the openings are in the flex spline 804, and the pin couplers 802 are under load from magnetic forces acting on the flex spline 804 and thus are biased to one side of the openings in the flex spline 804. FIG. 82 shows the pin couplers 802 in neutral position in a flex spline 804. FIG. 83 show a sequence of pin coupler 802 positions around a complete flex spline 804 with the major axis of the ellipse at 12 o'clock and 6 o'clock. FIGS. 84 and 85 show details of FIG. 86.

Torque is transmitted from the housing 806 to the output ring 810 via the pin couplings 802. As the strain wave(s) propagate and the gear teeth mesh, the offset between the gear teeth on the flex ring 804 and the gear teeth on the output ring 810 cause relative motion of one with respect to the other. The pin couplings 802 prevent the flex ring 804 from rotating with respect to the housing 806 and so the entirety of the rotation movement is transmitted to the output ring 810.

The pins 802 may be long or short to provide different effects on the system. In the case where the pins 802 are shortest, the flex spline 804 is closer to contacting the housing 806 on either side. The shorter pins 802 provide a very rigid coupling between the housing 806 and the flex spline 804, and there is minimal deformation of the pins 802. If the pins 802 are longer, the flex spline 804 is separated from the housing 806 by a distance determined by the length of the pin 802. This allows for some flexing of the pin 802, as determined by the pin material, length, and diameter, which may be desirable for certain configurations.

In another embodiment, instead of simply rolling in place, the pins 802 are allowed to pivot and rotate while simultaneously rolling. Each pin 802 can have three or four points of contact which define the limits of its movement. The points of contact both constrain the maximum deformation of the flex spline 804 and prevent relative rotation of the flex spline 804 to the housing 806.

The pins 802 may be made out of any suitably rigid material including but not limited to aluminum, steel, ceramic or plastic. The material must be rigid enough to supply the required torque to the output ring 810. The diameter of the pins 802 can range up to the radial thickness of the flex spline 804.

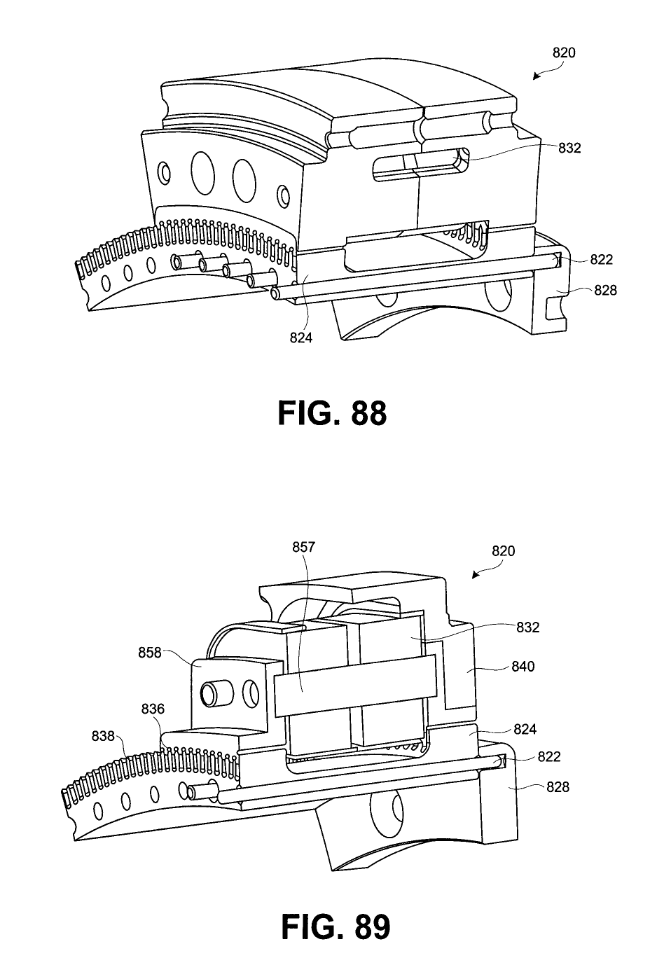

FIGS. 86-91 are partial and cross-sectional views of a Rotary actuator 820 using an orbiting pin coupling as described in relation to FIGS. 78-85. It also uses an array of permanent magnets 830 to pull the ID of the flex ring 824 inward at two opposing places. It uses electromagnets 832 external to the flex ring 824 which use the inward facing output ring teeth 836 and the outward facing flex ring teeth 838 as part of the flux path for the magnet sections 830, 832. Each magnet 830, 832 is magnetically insulated from the adjacent magnet in the array and these magnets 832 are powered sequentially to propagate the wave and transfer the torque to the housing through the orbiting pins 822.

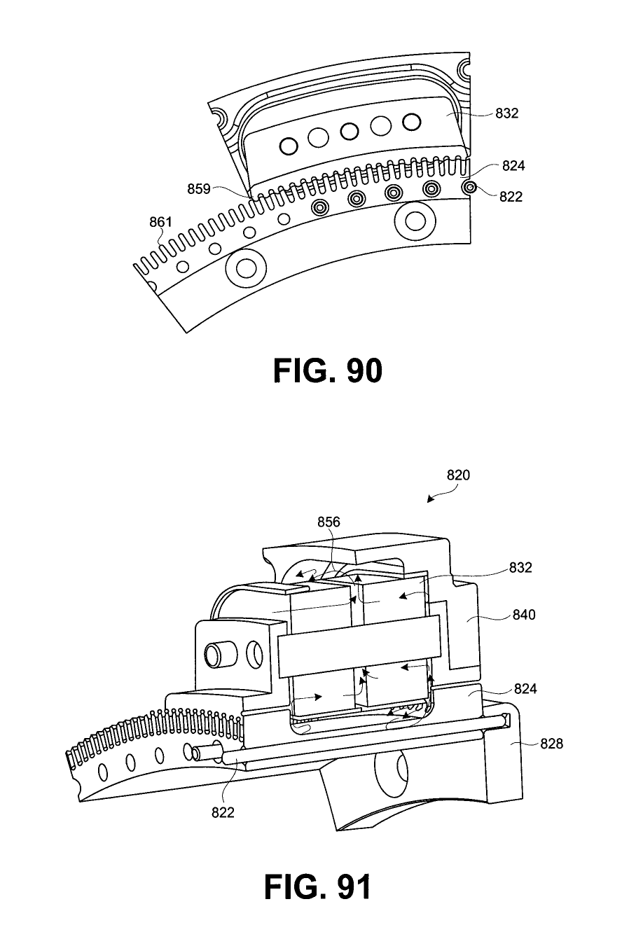

FIGS. 86-91 show a single sided FS 824 (lobes on outside only) sectioned through a pin 822 of the drive system. Both covers 840 are connected to the pin carrier rings 828, which is the output. The fixed mounting interface is formed by 2 cylindrical surfaces at the OD between covers 840 and bearings 842. These figures also show the integration of some or all of the control system 850 into one side of the reActuator and wiring 852 into the other side. The PMs 830 that pull the FS 824 inward are located between the pin carrier rings 828. The PMs 830 are long, thin magnets, orientated axially, mounted in the outer, castellated surface of a steel magnet carrier ring, lower part of the covers 840. FIG. 89 shows an EM core 857 engaged in core end plates 858, which carry the flux from the EM core 857 to the FS 824. FIG. 90 shows that the core end plates 858 have lobes 859 that engage with the lobes 861 of the FS 824. FIG. 91 shows how cooling air 856 flows through the coils to cool them. In FIG. 91, airflow or other fluid flow axially inward through the space between the teeth and axially inward through the coils and then radially outward from between the coils. Many other configurations are possible. This is just shown as one example of how fluid flow can be generated through an electrical machine by use of the present porous magnet device.

Polyphase EM Drive (with Safety Brake)

In this section, a three phase permanent magnet charged electromagnetic drive is disclosed with a split stator which allows axial flux linkage through the flex spline. A conventional polyphase stator configuration such as is common to motors with rotors fixed for rotation, is known to use a single stator that creates a flux path radially through the rotor from a N pole on one angular position to an S pole at an angular position at 180 degrees relative to said N pole. With more poles, the flux path is somewhat radial and somewhat circumferential through the rotor. In some motors with rotors that are fixed for rotation such as the Flynn motor U.S. Pat. No. 7,898,135 B2, permanent magnets are used in alternating polarity without back iron and with flux linkage through the rotor radially and/or circumferentially.

The embodiments disclosed in this section take advantage of the simplicity and reduced wiring of a four pole, three phase stator with the following differences. Instead of a single stator, the embodiments use two identically wired stators which are spaced apart in the axial direction (with concentric axes) and with one stator fixed at 90 degrees to the other. Each slot on one stator is axially aligned with a slot on the other stator with each of said slots being wired (as a result of the 90 degree relative phase shift) for opposite polarity when energized.

Instead of flux linkage happening from one angular position on a single stator to another angular position on the same stator, as with a common three phase motor, the present device creates a flux linkage path between two stators, said flux path which includes a radial air gap from the first stator to the FS, and an axially path through the FS, and a radial path across the air gap between the FS and the second stator. Advantages of this include the ability to maximize the cross sectional area of the FS along the flux linkage path. The embodiments of this section use elongated lobes that have a significantly greater minimum cross sectional area in the axial, as opposed to the circumferential, direction. Furthermore, these elongated, axially aligned lobes increase the cross sectional area-to-surface area ratio of the FS as compared to conventional harmonic drive teeth, which has a benefit with regard to reducing eddy current generation. This increased cross section to surface area ratio, combined with the axial flux path of the split stators also takes advantage of the skin effect of high frequency flux flow through the stator. The surface area of the lobes in the axial direction is greater as the minimum cross sectional area than in the circumferential direction, allowing flux linkage at high frequency in the axial direction with lower losses than in the circumferential direction.

Permanent magnets are known to increase the power density of common brushless DC motors when PMs are attached to the rotating rotor. Attaching permanent magnets to the continuously bending FS of the present device is challenging, however, especially for very high cycle life applications where magnets must be isolated from bending stresses. Attaching permanent magnets to a stator designed for circumferential flux flow, such as the Flynn motor U.S. Pat. No. 7,898,135 B2 would have losses in a direct drive harmonic gearbox such as the present device due to the thin minimum section area of the FS in the circumferential direction, as compared to the cross section of a rotor (in the circumferential direction) that is fixed for rotation on a shaft such as the Flynn motor U.S. Pat. No. 7,898,135 B2.

When a similar brushless DC motor is applied to the present device with individual EM coils as in any of the prior embodiments with EM coils, it is challenging to achieve smooth advancement of the EM coil forces due to the exponential increase of radial force from the individual EM coils as the air gap is decreased. To achieve smooth actuation of the FS is it preferable to use a four pole, three phase stator configuration (or polyphase with a different number of poles in different applications such as when using an FS with more than two wave apexes). The following embodiments of the present device allow the advantages of a three phase stator to be combined with the advantages of adding PMs to the flux path, without having to secure PMs to the FS.

We have found through experimentation that including one or more PMs in a magnetic flux path between the two stationary stators can increase the force generated by an EM in that flux path on one or both stators, for a given current, by a factor that is greater than the current required to oppose that PM flux when force from the EM coil is not required. This is especially true if the flux from the PMs in the circuit have not saturated the EMs and ideally if the PMs provide enough flux to bring the EMs to ¼ to ½ of saturation. In this case, energizing the EMs takes less power to generate the same force than if there is no flux provided by the PMs.

With flux provided by PMs between the two identical stators with axially aligned and inverted polarity windings as described above, it is preferable in some configurations to prevent flux from linking to the flex spline through EM locations that are out of phase with the wave propagating EM locations by, for example, at 90 degrees out of phase. This makes a four pole, three phase winding on each of the split stators (with opposite polarity on axially symmetric poles) suitable for use with the present device because it provides two positive poles at 180 degrees from each other and two negative poles at 90 degrees to the positive poles. The negative poles, in this case, serve the function of preventing flux from linking through these poles to the FS. It should be noted that this is different than a motor with a four pole spinning rotor in that a spinning four pole rotor with a four pole three phase wiring configuration is intended to achieve flux linkage at four equally spaced angular positions. Embodiments with two FS wave apexes are preferably configured for EM energized flux linkage at two equally spaced angular positions (with positive polarity in the EMs on the first stator and negative polarity on the axially aligned EMs on the second stator) and to reduce or eliminate flux linkage to and through the FS between the two stators, at 90 degrees to the positive polarity EMs by using a negative polarity on these EMs on the first stator, and positive polarity on the axially aligned EMs on the second stator. In this way, two areas of increased axially linked flux through the FS can be achieved with two areas of reduced axially linked flux at 90 degrees to the first.

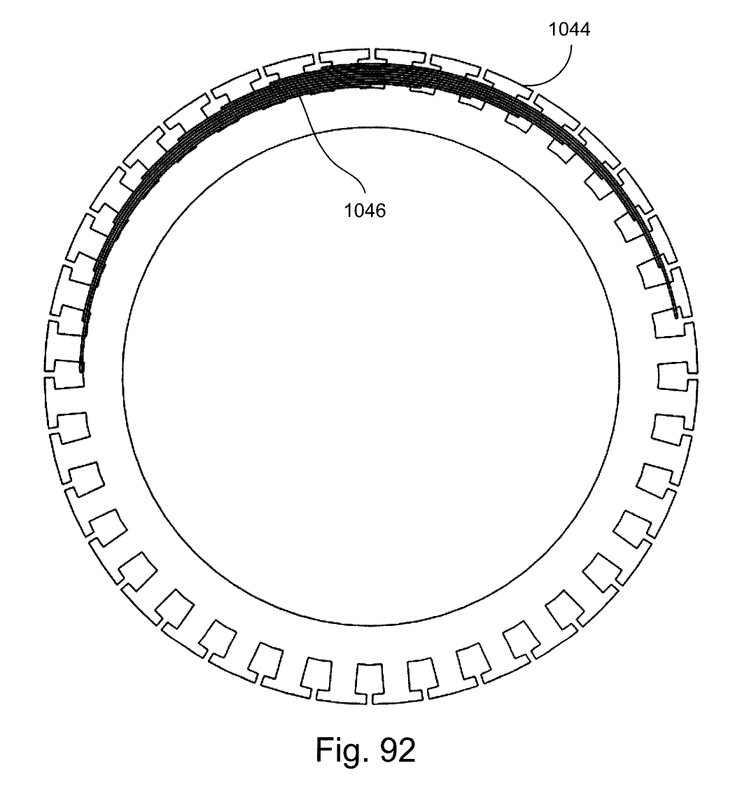

Wiring of each of the axially symmetric stators can be of a number of styles of winding as are used in common or uncommon poly phase electric motors such as, but not limited to, a four pole three phase winding as shown as a non-limiting example in FIGS. 92-94.

The assembly is made of two identical stators that will have to meet, in the case that a 4-pole 3-phase design is used, the criteria for 4-pole 3-phase design, given by the following general formula:

Number of Poles×Number of Phases=n×Number of Slots,

where n is a positive integer 1, 2, 3, 4, etc.

It will be understood by those skilled in the art, that a higher number of phases could also be used as long as the wiring is aimed at creating a 4-pole configuration.

Each stator has identical windings that in the embodiments of this section are shown but not limited to 3-phase 4-pole windings.

To those skilled in the art it will be clear that these windings could be of any known configuration, such as Lap winding, Concentric winding, Delta, Wye etc.

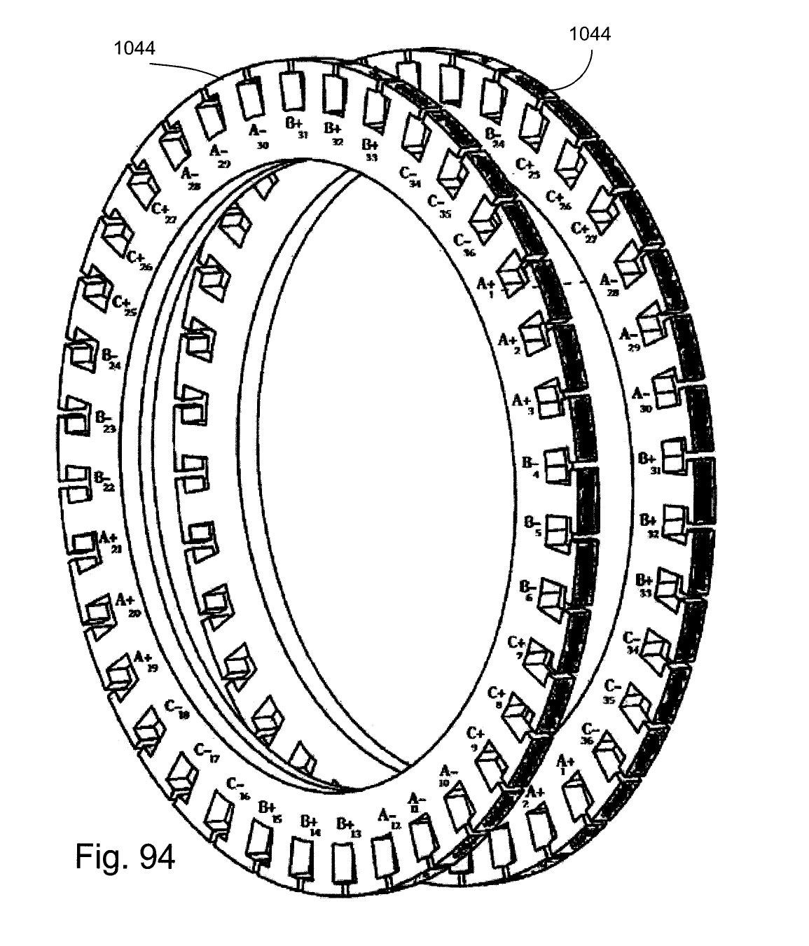

Both stators are wired such that they axially align, slot #1 of Stator1 should coincide with slot #28 of Stator2 (shown with a dashed line in the wiring diagram of FIG. 94).

It will be clear to those skilled in the art that the rotation could be clockwise or counterclockwise as long as the magnetic fields in both stators rotate in the same direction.

Many other configurations are anticipated and conceived by the inventors. These include stator configurations which are not identical but achieve the same reverse polarity between axially aligned slots, or one stator which is passive instead of active.

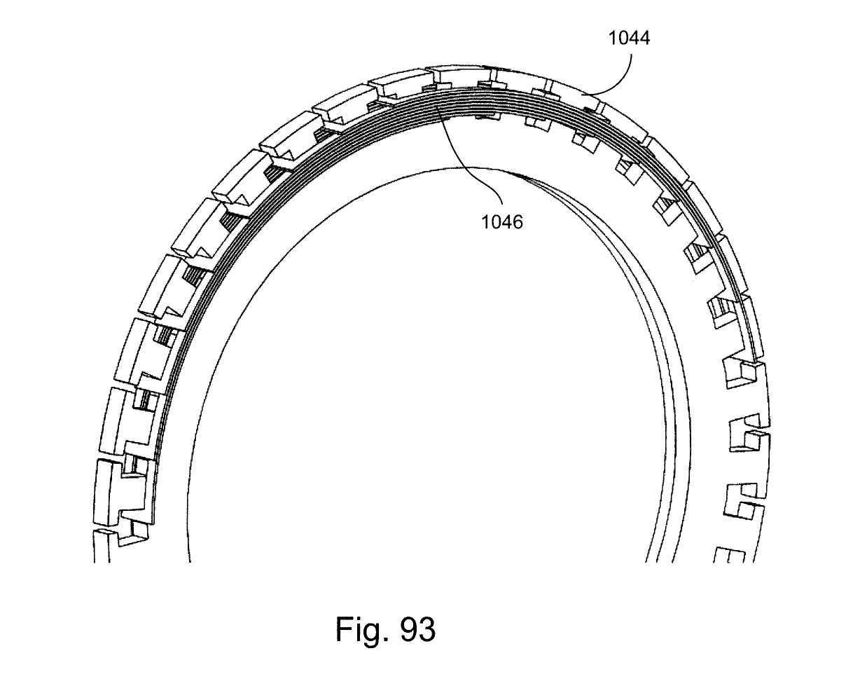

A non-limiting example of a split rotor stator of the present device with a four pole, three phase wiring scheme is shown in FIG. 92 partially assembled with one of four sets of arrayed windings on one of the two stators (other stator not shown). It uses two sets of split rotors but one set of split rotors or more than two sets of split rotors can be used in various applications. FIG. 93 shows an isometric view of the stator of FIG. 92.

FIG. 94 shows a wiring diagram showing one example of how the two axially disposed stators could be wired as a four pole, three phase device. In this case, a pole refers to a N polarity zone on one stator and a S polarity zone on the other stator that is axially aligned such that flux flows axially through the FS to link said N and S zones.

In the wiring diagram of FIG. 94, as will be familiar to anyone skilled in the art, the letters A, B, and C represent the phases of the three phase winding. The plus or minus after the letter represents the polarity of the winding in respect to the neutral point. The numbers from 1 to 36 represent the slot numbers.

Many different winding strategies are possible and anticipated by the inventors. A feature unique to the present device is the split stator with axially aligned slots or posts on the other rotor having opposite polarity to achieve axial flux flow through the flex spline from split stator to the other. In an embodiment, the two symmetric stators include one or more permanent magnets between them with polarity that provides N polarity flux to one stator and S polarity flux to the other stator.

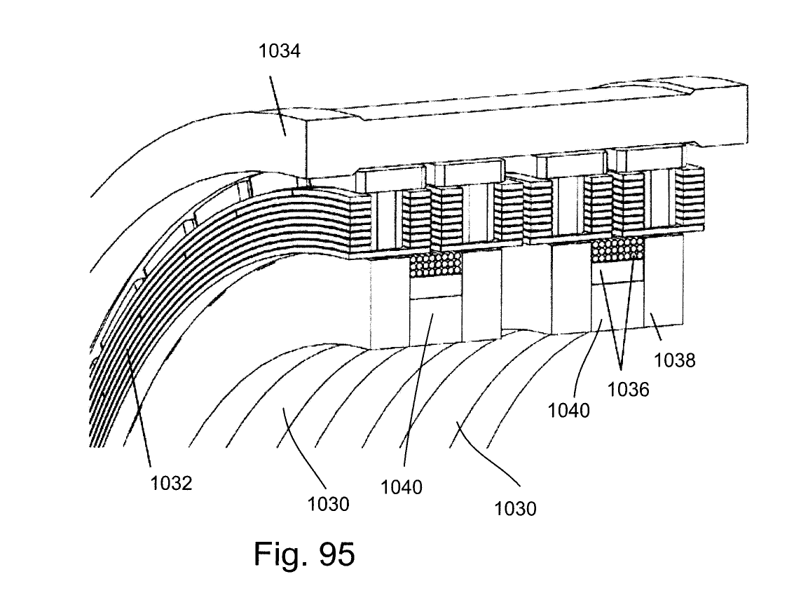

FIG. 95 shows a simplified partial sectioned assembly of dual split 90 degree phase shifted stator sets, each with a four pole three phase winding. The example shown here has two sets of split stators to reduce the maximum length of the flux linkage path between axially aligned N and S zones on each stator set.

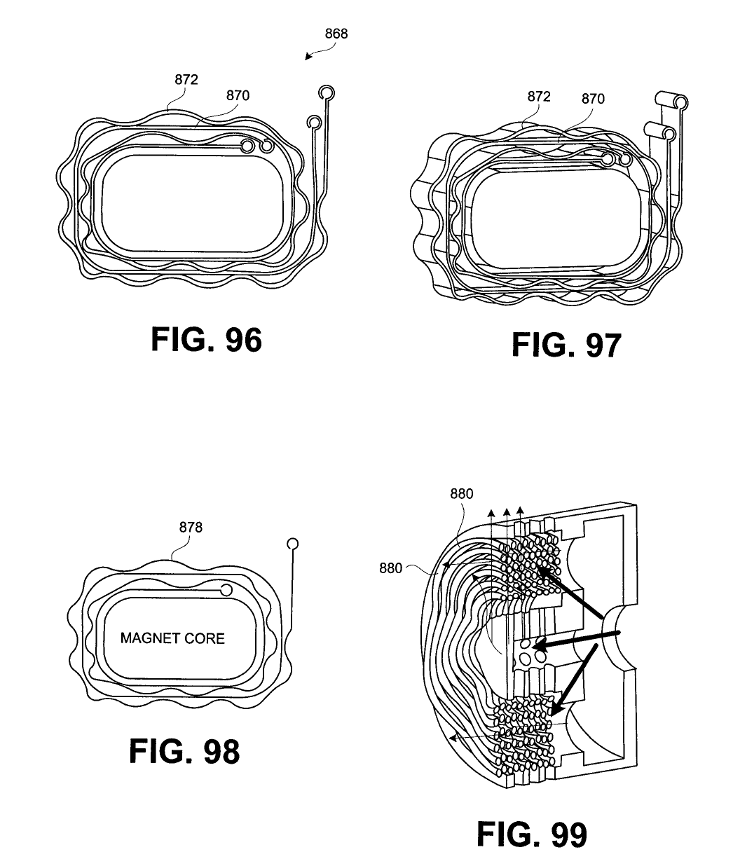

In various embodiments, the electromagnets which provide the driving force for the actuator, or for many other applications to many other electrical machines, are porous to allow for more effective cooling of the coils. The coils have a certain ratio of conductor material to unoccupied space which allows a fluid to move through and remove heat from the conductor/s via forced flow or natural convection. Examples of fluids for this purpose can be in liquid or gaseous form and include but are not limited to air, hydrogen, nitrogen, water, oil. As shown for example in FIGS. 96-99, the porous (permeable) coil can be any configuration of a conductor which allows for multiple windings or turns while incorporating interconnected pockets or channels which allow fluid to pass through the coil axially and/or radially for cooling. The inventor has anticipated many possible configurations which are described in this section. The conductor may be coated on one or all sides with an insulating material to prevent electrical short circuits between the turns of the conductor. Instead of an insulating coating, an insulating spacer ribbon may be used.

In an embodiment shown in FIGS. 96 and 97, the conductor 870 is corrugated along its entire length. The corrugation pattern may include straight waves, diagonal waves, chevron-shaped waves, pock-marks for example, but other patterns or combinations of patterns are possible. Corrugation may be achieved by use of a roller or a stamp on the conductive ribbon. The flat component 872 may be an insulator or may be another conductor. The flat component 872 ensures that an approximately equal amount of unoccupied space is present within each wrap. These components are rolled together in a spiral to form the coil of the electromagnet 868 as shown below. The spacer may be of similar thickness or thicker/thinner than the conductive ribbon as long as it still retains sufficient stiffness to prevent the conductor corrugations from nesting. This embodiment is preferable for manufacturing simplicity since the two materials are simply rolled together.

In an embodiment shown in FIG. 98, a single conductive ribbon 878 is corrugated in sections equal to a single wrap such that a corrugated wrap is followed by a flat wrap, and a flat wrap followed by a corrugated wrap. In this way, the flat sections of the ribbon prevent nesting of the corrugations and maintain approximately equal amounts of unoccupied space throughout the volume of the coil. A third embodiment includes a conductive ribbon corrugated along its entirety, but with the corrugation pattern and spacing designed such that nesting is prevented and an equal amount of unoccupied space is maintained throughout the volume of the coil. As shown in FIG. 99, the coil may be composed of any shape of wire 880, corrugated in such a way as to create a porous matrix as it is wound, allowing fluid contact with approximately the same amount of wire surface for each turn. The end views of the corrugated coil embodiments above also represent a single coil of a corrugated wire embodiment. Yet another embodiment of the porous coil may use any non-round wire (including square, rectangular, oval, and any other non-circular cross-section) that is twisted as it is wound so that pockets are introduced during winding, creating a porous matrix. The wire may be twisted during the winding process or pre-twisted during manufacturing. For example, both corrugated and twisted wire across its entire length, alternately corrugated and straight wire sections, alternately twisted and straight wire sections, alternately twisted then corrugated wire sections, alternately corrugated twisted and straight wire sections, and so on. Any of the variations used above may also be used in conjunction with a branching wire which splits into multiple wires, having a cross-section together equaling the cross section of the original wire and each split wire having the same cross-section as one another so that the current divides equally among each branch. Another embodiment uses variable thickness wires to change the relative heat generation in different areas of the coil. As the fluid flows through the coil in a certain direction, the portion of the filaments that it contacts first will have the greatest portion of heat removed. As it continues to flow through the coil it increases in temperature and is able to remove less heat leading to a small heat gradient from one end of the coil to the other in the direction of the fluid flow. One embodiment which would allow more uniform heat distribution in the coil would be to have the thinnest sections of the wire near the source of the fluid flow and thicker sections of wire which have lower resistance and generate less heat on the far side of the fluid flow path.

The coil may be made from any conductive material including but not limited to copper, silver, gold, aluminum, iron, silicon and graphite. The individual filaments may be textured or rough on the surface to provide an increase in surface area for cooling, or the filament itself may be porous, containing pockets and paths for fluid to pass through. The conductor filaments may be large and thick on the order of inches, or extremely small down to the scale of micro or nano-wires.

The magnet core may be left vacant to allow for greater fluid flow through the coil leading to a higher rate of cooling, or it may be composed of a solid material including but not limited to steel, silicon steel, nickel-steel alloys, cobalt-based amorphous alloys, non-oriented metal powder materials, manganese-zinc ferrites, and nickel-zinc ferrites. Any of these materials may also be used to form a porous core (readily available from a number of manufacturers, such as Applied Porous Technologies Inc. and Mott Corporation) to increase overall fluid flow in the electromagnet as well as the coils preventing heat buildup from eddy currents and other losses within the core.

The magnet is cooled using either forced or convective flow of a fluid through the porous coil. Some convective cooling strategies include submersing the magnet in a liquid with a boiling point lower than the maximum desired temperature of the magnet. As the coil is heated, it boils the liquid next to the surface of the filaments, forming vapor bubbles which rise to the top of the liquid. Similarly for gaseous cooling, gas next to the filament surface becomes less dense as its temperature increases causing it to rise away from the filament. Cooler air takes its place and in this way a convective current is established which removes heat away from the filaments. Forced cooling strategies employ an external source to move the fluid through the system. Such sources include but are not limited to fans, vacuums, pumps, and pressure sources.

The cooling system may be either open or closed. In a closed system, fluid which carries heat away from the filaments passes through a heat exchanger or otherwise is cooled and returns to the coils once again. The cooling fluid is isolated from the environment and its quantity is fixed. In an open system, the fluid is not enclosed and is part of the ambient environment. Examples of open systems include using ambient air to cool the coils convectively, or with a fan or a vacuum source.

The efficiency of the cooling can be increased in a number of ways. The biggest benefit of using porous magnets is that the surface area of the material increases thereby increasing the cooling efficiency for a given flow rate. The cooling increases proportionally to the increase in surface area of the filaments. Therefore using smaller filaments will result in a greater volume to surface area ratio of the conductor and will allow for more efficient cooling. Theoretically, using the smallest filaments possible will have the best rate of cooling however such a configuration may not be possible due to the voltages required for such a system. Another method of increasing the cooling efficiency is to increase the temperature difference between the filaments and the cooling fluid. This can be accomplished in one of two ways. The first way is to allow the filaments to reach a higher temperature, although one that lies below the melting temperature of the filament material so that the coil integrity remains intact. This greater temperature difference will allow the cooling fluid to remove a greater amount of heat energy from the filaments. The second strategy is to decrease the average temperature of the cooling fluid. The coils can be cooled using colder materials, or even cryogenically cooled to sub-zero temperatures. Using cryogenic cooling would also allow the use of a superconducting coil which dramatically reduces the required voltage allowing even smaller cross-section filaments to be used. Another method of increasing the cooling efficiency is to force the fluid flow through the magnet in the direction which results in the least resistance to that flow. For instance, when using a corrugated ribbon coil, the most efficient direction of cooling is along the line of the corrugation ridges. Another method to increase the rate of cooling is to increase the volumetric flow rate of the cooling fluid. Although this method is not available for passive cooling systems which operate purely by convection, it is easily accomplished in active cooling systems by increasing the power supplied to the element which is causing the flow (i.e., increasing the speed of a fan or a pump). Another strategy to increase the volumetric fluid flow is to increase the porosity of the coil. This reduces the resistance of the coil to the fluid passing through the pores and allows a higher volumetric flow rate resulting in more effective cooling at the expense of increasing coil size.

The main benefit of cooling the magnet coils is the use of higher currents than would be possible with non-cooled magnets. Higher operating currents yield higher magnetic forces which means that more powerful magnets can be constructed using less material than radiatively-cooled magnets or non-cooled magnets. If the cooling is significant, the magnets can be constructed to be a much smaller size than equivalent strength non-cooled magnets. This cooling system could be used but not limited to magnets, electro motors, inverters or transformers.

The windings of these magnets may be connected in any combination of series or parallel to yield the desired circuit control characteristics. Putting all turns in parallel will require the lowest applied voltage for a specified number of amp-turns, but will require a very large input current. Conversely, having each turn connected in series will yield the lowest required input current for the same number of amp-turns, but will require the highest input voltage. If the number of parallel vs series coils are known in advance, coil embodiment #7, the branching wire, can be used with the total number of branches representing the total number of coils in parallel. This embodiment is preferable for ease of assembly since the branched bundle can be wound together as if it were a single wire.

Although the magnet cooling becomes more effective at increasingly smaller filament cross-sections and equivalently higher numbers of turns, the inductance of the system increases which leads to slower turn on/turn off speeds for the magnet. In applications where very high speed is required, it may be preferable to use thicker filaments at higher currents with less turns. When the filament is thicker, there is a larger heat gradient between the center and the surface of the filament therefore care must be taken to ensure that the internal temperature of the filament does not rise above desired levels, either by increasing the rate of cooling, or by reducing the current supplied to the coils.

Coils can be cooled for example by, convectively cooled (passive) system, active cooling system (fan, vacuum, etc.) or active liquid cooling system (pump) including cryogenic coil cooling.

The coils would allow fluid flow through them axially and/or radially. Many different configurations of this nonround twisted and or wave shaped and/or corrugated and or non-consistent cross-section shape conductor are anticipated by the inventor. The purpose of this disclosure is to illustrate the effect of creating fluid flow chambers between the coils. Other methods of creating fluid flow between the coils include spacers, such as thread or filament or tape which is spirally wound around wires to create spaces between the wires. An example of a preferably, but not necessarily spirally wound spacer on a round (but could be any cross-sectional shape, such as oval or square or flat) conductor such as, but not limited to, a wire is shown below. The spirally wound spacer could be a non-conducting thread such as not limited to a high temperature material such as no Max or cotton, or a conductor, but a non-conductors believe preferable. Airflow in the image below is schematic the represented by the arrows. Fluid flows in from the right at an increased pressure and flow is axially across the coils through the openings created by the spirally wound spacer. Other fluid flows radially outward through flow channels in the core and out through the openings in the outer casing of the core and or axially outward through the spaces between the coils.

Twisted nonround wire coil for use in electrical means such as, but not limited to, electric motors, transformers, electromagnets, rectifiers, inductors, and any machine which uses one or more coils of wire to produce electromagnetic or other effects. The purpose of the nonround twisted wire is to reduce the length of the line contacts between adjacent wires to produce intermittent contact between the wires resulting in a fluid flow path from one end of the coil to the other and/or from the inside of the coil outward. The fluid is forcibly moved through the coil by a pump and or fan, not shown in most of these images. The fluid interacts with the wire to pull heat away from the wire and the coil, allowing the coil to carry higher current without overheating the wire and or insulation on the wires.

Coils can be wrapped in series and or in parallel. Series is shown in these images for simplicity of illustration. Wires are preferably coated with an electrically insulating material such as lacquer or paint. Porous coils may be made of smaller gauge wires grouped together. The wires themselves can be circular in cross-section, but are preferably non-round and preferably twisted before bundling. The bundles are then coiled and preferably twisted before coiling, but if the individual wires are twisted the bundles don't necessarily need to be twisted as well.

The present device may be capable of being operated in an open loop configuration, such as for example, where the EM coils are energized in sequence at a pre-determined rate or speed. No position feedback is required to operate in an open loop configuration. This is similar to a stepper motor control which has known advantages for discrete positioning of the rotor, especially at low speed.

Closed Loop Operation:

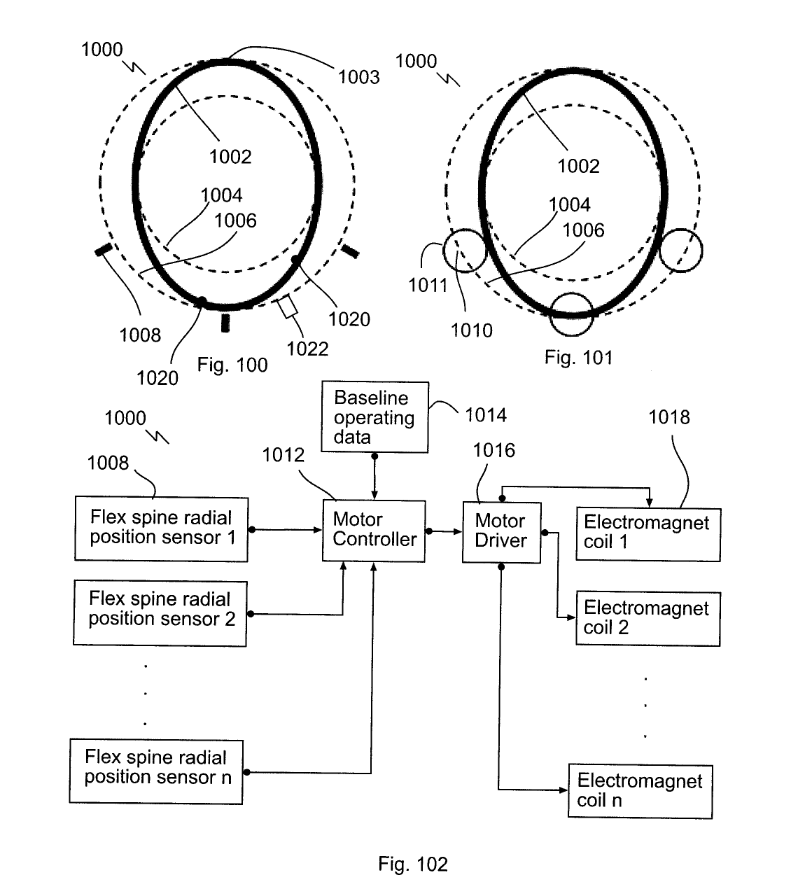

Referring to FIGS. 100-102, the present strain wave torque transfer device 1000 may also suitable for operation in a closed loop configuration where, for example, a wave generator such as a series of electromagnet coils 1018, radially spaced around and adjacent to the flex spline 1002, are energized in sequence at a rate determined by measured parameters and desired operating parameters. The radial displacement of the flex spline 1002 may be used to determine the angular position of a flex spline 1002 wave, such as a wave apex 1003, as determined by a wave sensor 1008 or 1010. Other suitable wave characteristics may be used. This wave apex position may be the primary measured parameter used to determine which magnetic coils to energize. Thus, in one case a controller, such as motor controller 1012, is connected to operate the wave generator 1018 using signals from the wave sensors 1008 or 1010. The structure shown in FIG. 100 is a schematic, non-limiting representation of how a displacement sensor 1008 may detect the radial displacement of the flex spline 1002. There are numerous methods known to those skilled in the art for measuring displacement that can be readily applied to the invention. The structure shown in FIG. 101 is an alternative, non-limiting representation where a sensor 1010 detects an amount of material within a target range 1011 (shown as a circle). In this non-limiting embodiment, the sensor may be mounted axially. There are various methods known to those skilled in the art for detecting the presence of material that can be readily applied to the invention. Two exemplary methods are a reflective optical proximity sensor or an eddy current sensor suitable for flex splines made from a conductive material.

In one non-limiting embodiment, the motor controller can be simplified if the number of radial displacement sensors is equal to the number of discrete sets of electromagnets, such that the output from each sensor can be used to directly control one set of electromagnets.

### Multiple Position Sensors:

The feedback loop can be operated from a single sensor. The accuracy of the angular position measurement will be dependent on the how the radial displacement changes with angular position. The radial displacement of the flex spline can be roughly approximated by a sinusoidal curve. In the peaks and valleys, there is little change in radial displacement with angular position. The accuracy of the angular position measurement can be improved using multiple sensors, for example a plurality of sensors spaced radially around and adjacent to the flex spline 1002. An exemplary implementation for a two lobed flex spline where the no-load deformation is symmetrical every 180 degrees would be two sensors spaced 90 degrees apart, or three or more sensors spaced 60 degrees or less apart. The improvement in the measurement accuracy is significant with the addition of the second sensor and the incremental improvement diminishes as more are added.

### Integral Torque Sensing:

An embodiment of the present device is suitable for integrated torque sensing. This has advantages that will be recognized by those skilled in the art. Thus, in one case, the controller 1012 or another controller comprises a torque measurement module that measures torque by comparing a characteristic of a measured flex spline wave (for example from a series of sensors 1008) with a baseline flex spline wave (1014). A baseline relationship between the energized magnet coils and the measured wave position, for example the angular position of the flex spline apex, can be established to determine a no-load baseline. This baseline FS apex-to-energized EM coil position can be programmed into a motor controller for various operating conditions. By comparing the baseline angular position to the measured angular position for a given coil energy state, the amount of torque can be determined from the phase shift of the FS from the energized EM coils, without any external torque sensor. The phase shift of the flexspline is approximately linear with torque a proportionality constant can be preloaded into the motor controller. A higher order polynomial may be used for greater accuracy. Alternatively the algorithm may be implemented with a look-up table approximating this nearly linear response where the phase shift is measured and the corresponding torque is known from a preloaded look-up table.

The shape of the flex spline will also change with increased torque from a symmetrical non-circular shape on either side of a line from one flex spline wave apex through the center axis of the actuator to the other side of this line. With two or more sensors such as, but not limited to as described above (and preferably 6 or more equally arrayed around the flex spline) the shape of the flex spline can be measured under a range of operating conditions. By comparing the no-load shape of the flex spline to the asymmetrical shape of the flex spline as a result of transmitting torque, the magnitude of the torque can be sensed.

### Collision Detection:

The controller 1012 or another controller may comprise a collision detection module that outputs a collision detected signal upon detection of a deviation, between torque signals received from the torque measurement module, beyond a predetermined range of deviation. For any given operation sequence, the asymmetric deformation of the flex spline and or the phase shift as compared to the energized EM coils, can be predicted and compared, in real time, to the actual measured flex spline asymmetry and/or phase shift. A sudden deviation between the expected torque and the measured torque can be used to indicate an unexpected interaction of the output member with the environment that may be undesirable. This integrated torque feedback can be used to detect this event and respond before harm or damage is done to personnel or equipment. A collision would be detected when the rate of change of the torque with time is larger than a predetermined constant. The implementation of this in a digital motor controller is known to those skilled in the art. Mathematically this would look like:

|dT/dt|>K

### Absolute Encoder:

An absolute encoder, for example in controller 1012, may be connected to determine a cycle position of the strain wave torque transfer device 1000 by comparing the relative positions of the inner gear ring 1004, flex spline 1002, and outer gear ring 1006. When using a flex spline (FS) with inner and outer lobes, also known as inner and outer gear rings 1004 and 1006, respectively, as disclosed here, the flex spline 1002 may advance by a set number of teeth for every wave propagation cycle. This may be true relative to the outer lobe ring (OLR) and also the inner lobe ring (ILR), but the rate of advance is different for both. In addition, the inner lobe ring (and associated housing) advances relative to the outer lobe ring (and associated housing members). The combination of these three relative positions results in a device with two distinct speed reduction ratios that are described mathematically below. The combination of two different ratios results in a specific outer lobe on the flex spline meshing with a specific lobe on the outer lobe ring only once in a certain number of rotations when a specific inner lobe on the flex spline meshes with a specific lobe on the inner lobe ring. This is referred to here, as the beat frequency. In many cases, the number of flex spline wave propagation cycles from one alignment of the same two FS lobes with the same two inner and outer lobe ring lobes happens at a greater number of flex spline wave propagation cycles than the internal speed reduction ratio of the device and in all cases it is greater than the external speed reduction ratio.

Using an exemplary embodiment of present device with an external speed reduction ratio of 95:1 as an example, specific lobes on the outer and inner lobe rings will only align with specific lobes on the flex spline, when the inner and outer lobe rings also align with each other, once every 27265 wave propagation cycles of the flex spline or 287 rotations of the ILR with respect to the OLR.

An index feature 1020 may be positioned on the flex spline 1002, and an index detector 1022 may be on the inner gear ring or outer gear ring 1006, in which the index detector is connected to output signals to the absolute encoder. The implementation may be considered to work best with one or more index features on the flex spline, preferably at non-equal intervals, and one or more detectors on the inner and/or outer housing members. This absolute encoding function may also benefit from one or more index features on an output member, such as rings 1004 or 1006, preferably at non-equal intervals, and one or more detectors on the fixed or reference member, such as the other of rings 1004 and 1006. The range of the absolute encoder may be maximized by the selection of gear teeth such that the greatest common factor is 1 between the external and internal gear ratio. Two exemplary implementation are shown below for the beat frequency achieved in terms of output rotations given a two lobed deformed flex spline.

$$External Ratio = \frac{FS wave propagation cycles}{ILR rotation w . r . t . OLR} = {( [ \frac{OLR teeth}{FS outer teeth} - 1 ] + [ \frac{FS Inner teeth}{ILR teeth} - 1 ] ⋆ \frac{OLR teeth}{FS outer teeth} )}^{- 1}$$

$$Internal Ratio = \frac{FS wave propagation cycles}{FS tooth propagation cycles w . r . t . OLR} = FS inner teeth$$

$$Beat Frequency = \frac{External Ratio ⋆ Internal Ratio}{Greatest Common Factor}$$

### Example 1

OLR teeth=576, FS Outer teeth=574, FS Inner teeth=287, ILR teeth=285

$$External Ratio = 95 ;$$

$$Internal Ratio = 287 ; Beat Frequency = \frac{287 ⋆ 95}{1}$$

### Example 2

OLR teeth=606, FS Outer teeth=604, FS Inner teeth=302, ILR teeth=300

$$External Ratio = 100 ;$$

$$Internal Ratio = 302 ; Beat Frequency = \frac{302 ⋆ 100}{2}$$

A greater number of index features on the flex spline and fixed and output members will generate a more frequent absolute rotation encoder pulse. If fewer index features are used, the actuator will need to cycle more often before getting to an identifiable absolute angular position. Absolute angular encoding is especially useful in applications where power is sometimes lost during motion control of an actuator. In these cases, when power returns it is desirable to have the ability for the CPU to know what angle the encoders are at and how many output member rotations the actuator is away from the original rotation position. An actuator may have a maximum and minimum stroke.

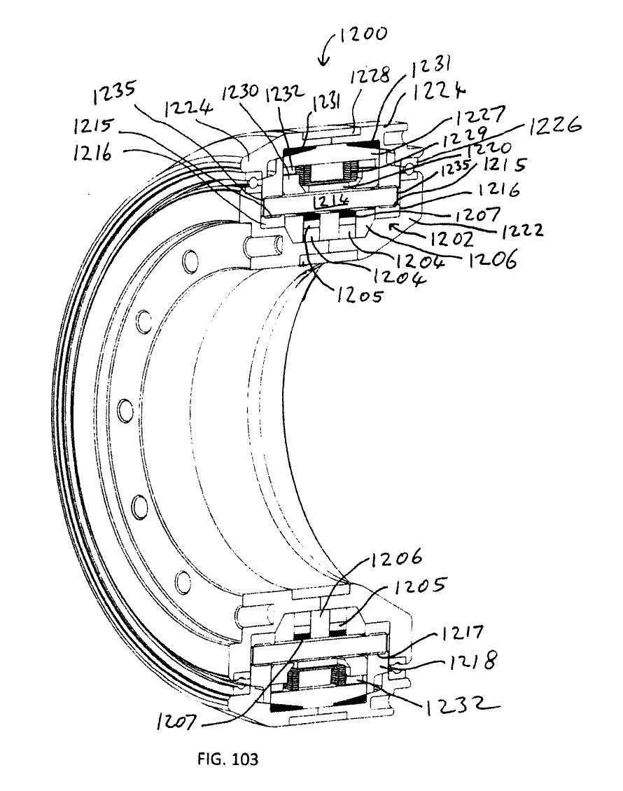

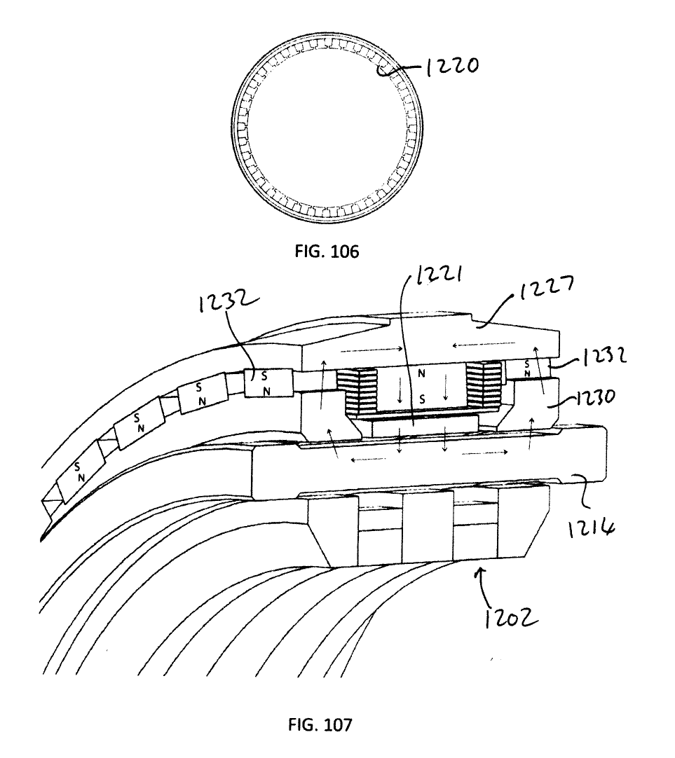

An embodiment of an actuator 1200 shown in FIGS. 103-107 uses an internal non-commutated magnet ring assembly 1202 with two permanent magnets 1204 with axial polarity sandwiched between three soft magnetic distribution rings 1206. A soft magnetic material ring 1205 surrounds each PM 1204 in said ring. Each of said soft magnetic rings 1205 is surrounded by a coil 1207 such as but not limited to a copper coil. Energizing the copper coils 1207 in the same polarity as the PM rings 1204 forces the flux to link back to the PMs 1204 and EMs radially across the air gap to a flex spline (FS) 1214 and axially through the FS 1214. In this way, the inner magnet ring assembly 1202 can be turned on by energizing the EM coils 1207 or it will short the flux path through the EM cores 1205 when power is lost. In this case, the flex spline 1214 will partially disengage, creating high enough FS lobe tip interference with the lobe tips 1215, 1217 of the inner and/or outer lobe rings 1216, 1218 to act as a brake.

The FS 1214 has inner lobes 1215 on inner lobe rings 1216 and outer lobes 1217 on outer lobe rings 1218 at both axial ends. This configuration provides stability of the FS 1214 and allows for a consistently controlled air gap between the cylindrical centerline area of the FS 1214 ID and the inner mag ring assembly 1202, and the cylindrical centerline area of the FS 1214 OD and the EM coil array 1207.

An inner lobe ring 1216 is fixed to the inner housing assembly 1222 on either axial end of the inner mag ring assembly 1202. The lobes on the FS 1214 and the inner lobe ring 1216 and the outer lobe ring 1218 are not shown in this example for simplicity of illustration. These components are designed according to the principles described in this disclosure for an inner-outer lobed FS with radially elongated zippering lobe mesh characteristics for low friction operation.

The inner housing assembly 1222 supports the outer housing assembly 1224 with two low profile rolling element bearings 1226. The housings 1222, 1224 can be of any material but aluminum or magnesium or steel are considered good choices depending on requirements of the system such as weight or rigidity.

Clamping the two outer housing halves 1224 axially together with a counter-threaded ring member 1228 holds the outer lobe rings 1218 concentric with the assembly and secures the three phase stator core 1227 in place. The three phase motor core 1220 is designed according to the principles of the present device with a variation as follows: The EM coils 1229 can be wound individually or as a three phase four pole motor stator or in a number of other ways as described elsewhere in this disclosure. In this exemplary embodiment, a three phase four pole winding is used and configured to maximize the axial flux flow through the FS 1214. This is done by providing a non-commutated distribution ring 1230 on each axial end of the stator 1227. These distribution rings 1230 can also be wired for commutation but it is preferable in some applications to reduce the complexity by using a single wired core component as shown. The outer distribution rings 1230 will allow some flux to link through the FS 1214 at a smaller air gap position in some cases, but this can be helpful to keep the FS 1214 lobes in mesh with the outer lobe ring under high loads so this is not considered to be a detrimental effect.

An array of PMs 1232 (which could also be a single ring PM) is located axially (not shown here) or radially (shown here) between the commutated stator 1227 and the outer distribution rings 1230. The PM 1232 array adds to the flux density of the commutation flux path to reduce the current needed to propagate the FS wave. Due to the outer distribution rings 1230 linking all of the PMs 1232 together, the PMs 1232 do not need to be very strong and can be of a lower cost PM material and also possibly a higher heat material to reduce the risk of damage to the PMs 1232 at high power levels. It is preferable that the power of these PMs 1232 is only enough to bring the commutated core 1227 and outer distribution rings 1230 to 20-40% of saturation when the system is unenergized (although other beneficial effects may be possible at higher or lower saturation levels). This allows the commutated core to multiply the flux density when powered without exceeding the flux density limit of these components.

A set of auxiliary coils 1231 is shown surrounding the OD of the commutated core. The PM array magnets 1232 are preferably all polarized in the same radial direction (EG: all PMs have the N pole facing radially in and the S pole facing radially out.). The auxiliary coils 1231 are wired to boost the PM flux with a winding direction that creates the same polarity field as the PMs 1232. The main purpose of these coils is to increase the flux in the stator assembly and FS during periods of high torque loading. This additional flux will find its way circumferentially through the distribution rings 1230 to the smallest air gap with the FS 1214 where it will assist the inner mag ring to keep the FS lobes engaged with the outer lobe rings 1216, 1218. The current to these coils can be anywhere from zero to maximum depending on the torque loading of the system.

Axial restraining rings 1235 are provided at either axial end of the FS 1214 to prevent contact of the FS with the housing walls these and the inner and outer lobe rings can be made of many different materials. Toughmet bronze is considered a good material for many applications especially if lubrication free operation is desired.

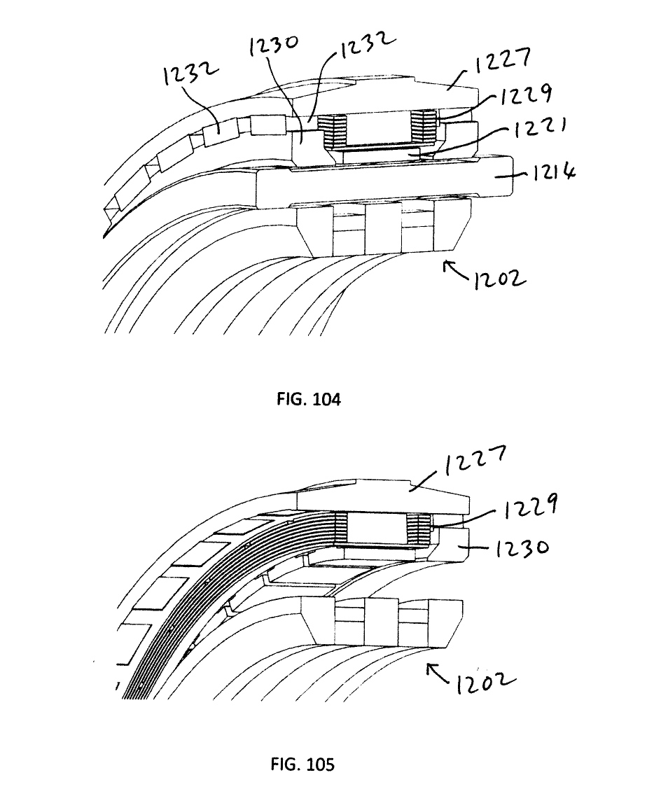

The embodiment is shown in FIG. 104 with the inner and outer housings 1222, 1224, inner and outer lobe rings 1216, 1218, axial restraining rings 1235, inner mag ring coils 1207 and auxiliary coils 1231, and counter-threaded inner and outer rings removed. The FS 1214 is simplified without any lobes as is shown at the section plane midway between radially inward and outward limits.

In a further-disassembled view in FIG. 104, a three phase wiring 1236 is represented by simplified windings.

The commutated stator 1221 is shown in FIG. 104. Many different commutation configurations can be used with different effects. This one uses a 36 slot three phase four pole configuration. Although the FS 1214 has only two apexes in this exemplary embodiment, the PM arrays 1232 require that the flux from the PMs is resisted or prevented from linking through the FS at approximately 90 degrees from the flux that is propagating the FS wave. A four pole winding accomplishes this by providing a reverse polarity to the two poles 90 degrees out of phase to the wave propagation poles. The wave propagation poles add EM flux to the system that is in the same direction/polarity as the PM flux.

The flux path at a wave propagation position is shown in FIG. 107. The flux path direction is radially through the commutated stator 1221 and radially across the air gap to the FS 1214, axially through the FS 1214 in both axial directions, radially across the air gap from the FS 1214 to the distribution rings 1230, radially through the PMs 1232 from the distribution rings 1230 to the EM core outer ring 1227 of the commutated stator assembly and back to the original and/or adjacent EMs.

At 90 degrees to the above position, the EM flux produced by the commutated stator will be the opposite polarity as shown in FIG. 107 but the PM polarity will be the same toward the FS 1214 as shown in FIG. 107, makes the flux less likely to cross the air gap at the 90 degree position. In addition, the air gap at 90 degrees is at its maximum radial distance between the FS 1214 and the commutated stator assembly 1221, 1230, etc. further (and beneficially) adding to the reluctance of a flux path that would include the FS 1214.

Many other variations to this design are envisioned and anticipated by the inventors. Features of this embodiment may be combined with other features of other embodiments in this disclosure and vice versa. This is intended to show an example of how the principles of the present device can be configured in a simple assembly with only one moving part that comprises the motor, the gear reducer, the FS 1214 positional encoder (described elsewhere in this disclosure), and the torque sensor (also described elsewhere in this disclosure) the large center through hole is beneficial for many applications and the low inertia, low friction characteristics of the zippering lobe geometry all offer benefits for motion control applications such as, but not limited to robotics actuators, motors, and other rotary devices.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A torque transmitting device, comprising:
an outer ring having lobes;
a flexible spline having an inner surface and an outer surface, the flexible spline having lobes on the outer surface of the flexible spline configured to mesh with the lobes on the outer ring; and
a force applying element which holds the flexible spline in a shape conforming in curvature to the outer ring at two or more apexes at which the flexible spline contacts the outer ring.

2. The torque transmitting device of claim 1 in which the force applying element comprises an array of permanent magnets situated radially inward from the flex spline and arranged to pull the flexible spline inwardly away from the outer ring at locations between the two or more apexes.

3. The torque transmitting device of claim 1 in which the force applying element comprises an array of permanent magnets situated radially outward from the flex spline and arranged to pull the flexible spline outwardly towards the outer ring at the two or more apexes.

4. The torque transmitting device of claim 3 in which the force applying element comprises permanent magnets arranged evenly over the circumference of the force applying element.

5. The torque transmitting device of claim 1 further comprising an array of electromagnetic elements arranged to propagate the apexes of the flexible spline when the electromagnetic elements are energized sequentially.

6. The torque transmitting device of claim 5 in which the array of electromagnetic elements is positioned adjacent and around the outer surface of the flexible spline to attract the outer surface of the flexible spline outward.

7. The torque transmitting device of claim 5 in which the array of electromagnetic elements is positioned adjacent and around the inner surface of the flexible spline to attract the outer surface of the flexible spline outward.

8. The torque transmitting device of claim 5 in which the array of electromagnetic elements is positioned around the inner and outer surfaces of the flexible spline.

9. The torque transmitting device of claim 1 in which one of the flexible spline and the outer ring is a reference element and the other of the flexible spline and the outer ring is an output element.

10. The torque transmitting device of claim 1 further comprising an inner ring having lobes, and in which the flexible spline also has lobes on the inner surface of the flexible spline configured to mesh with lobes on the inner ring.

11. The torque transmitting device of claim 10 in which one of the inner ring and the outer ring is a reference element and the other of the inner ring and the outer ring is an output element.

12. The torque transmitting device of claim 10 in which the lobes on the inner surface of the flexible spline are positioned with spaces between the lobes on the inner surface smaller than a width of the lobes on the inner ring so the lobes on the inner surface of the flexible spline are in bending tension when fully meshed with the lobes on the inner ring.

13. The torque transmitting device of claim 10 in which the lobes on the inner surface of the flexible spline have a lobe tip width to lobe height ratio of 2:1 or greater.

14. The torque transmitting device of claim 1 in which the lobes on the outer surface of the flexible spline have a lobe tip width to lobe height ratio of 2:1 or greater.

15. The torque transmitting device of claim 1 in which the flexible spline is coupled to a housing ring by pins.

16. A torque transmitting device comprising:
an outer ring having lobes; and
a flexible spline having an inner surface and an outer surface, the flexible spline having lobes on the outer surface of the flexible spline configured to mesh with the lobes on the outer ring, the lobes on the outer surface of the flexible spline having a lobe tip width to lobe height ratio of 2:1 or greater.

17. The torque transmitting device of claim 16 in which one of the flexible spline and the outer ring is a reference element and the other of the flexible spline and the outer ring is an output element.

18. The torque transmitting device of claim 16 further comprising an inner ring having lobes, and in which the flexible spline also has lobes on the inner surface of the flexible spline configured to mesh with lobes on the inner ring, the lobes on the inner surface of the flexible spline having a lobe tip width to lobe height ratio of 2:1 or greater.

19. The torque transmitting device of claim 18 in which one of the inner ring and the outer ring is a reference element and the other of the inner ring and the outer ring is an output element.

20. The torque transmitting device of claim 18 in which the lobes on the inner surface of the flexible spline are positioned with spaces between the lobes on the inner surface smaller than a width of the lobes on the inner ring so the lobes on the inner surface of the flexible spline are in bending tension when fully meshed with the lobes on the inner ring.

21. The torque transmitting device of claim 16 in which the lobes on the outer surface of the flexible spline are positioned with spaces between the lobes on the outer surface smaller than a width of the lobes on the outer ring so the lobes on the outer surface of the flexible spline are in bending tension when fully meshed with the lobes on the outer ring.

22. The torque transmitting device of claim 16 where the lobes on the outer surface of the flexible spline have a lobe tip width to lobe height ratio of 3:1 or greater.

23. The torque transmitting device of claim 22 where the lobes on the outer surface of the flexible spline have a lobe tip width to lobe height ratio of 4:1 or greater.

24. The torque transmitting device of claim 23 where the lobes on the outer surface of the flexible spline have a lobe tip width to lobe height ratio of 5:1 or greater.

25. The torque transmitting device of claim 16 further comprising a force applying element which holds the flexible spline in a shape conforming in curvature to the outer ring at two or more apexes at which the flexible spline contacts the outer ring.

26. The torque transmitting device of claim 25 in which the force applying element is rotatable to propagate the apexes of the flexible spline.

27. The torque transmitting device of claim 26 in which the force applying element comprises permanent magnets arranged equally around the circumference of the force applying element.

28. The torque transmitting device of claim 25 in which the force applying element comprises an array of permanent magnets situated radially inward from the flex spline and arranged to pull the flexible spline inwardly away from the outer ring at locations of smallest air gap.

29. The torque transmitting device of claim 25 in which the force applying element comprises an array of permanent magnets situated radially outward from the flex spline and arranged to pull the flexible spline outwardly towards the outer ring at the two or more apexes.

30. The torque transmitting device of claim 25 further comprising an array of electromagnetic elements arranged to propagate the apexes of the flexible spline when the electromagnetic elements are energized sequentially.

31. The torque transmitting device of claim 30 in which the array of electromagnetic elements comprises inductance magnets.

32. The torque transmitting device of claim 30 which the array of electromagnetic elements is positioned around the outer surface of the flexible spline.

33. The torque transmitting device of claim 30 in which the array of electromagnetic elements is positioned around the inner surface of the flexible spline.

34. The torque transmitting device of claim 30 in which the array of electromagnetic elements is positioned around the inner and outer surfaces of the flexible spline.

35. A torque transmitting device, comprising:
an outer ring having lobes;
a flexible spline having an inner surface and an outer surface, the flexible spline having lobes on the outer surface of the flexible spline configured to mesh with the lobes on the outer ring;
a force applying element which holds the flexible spline in a shape that causes it to contact the outer ring at two or more apexes; and
an array of electromagnetic elements arranged to arranged to propagate the apexes of the flexible spline when the electromagnetic elements are energized sequentially, the electromagnetic elements comprising permanent magnets and electromagnets having cores and coils, the permanent magnets and electromagnets being arranged so that at least part of the flux from the permanent magnets passes through cores of the electromagnets when the coils of the electromagnets are not energized, and at least some portion of the flux from the permanent magnets passing though the cores of the electromagnets is redirected through the flexible spline when the electromagnets are energized in opposition to the flux of the permanent magnets.

36. The torque transmitting device of claim 35 in which the shape of the flexible spline conforms in curvature to the outer ring at the two or more apexes at which the flexible spline contacts the outer ring.

37. The torque transmitting device of claim 35 in which the array of electromagnetic elements is also the force applying element.

38. The torque transmitting device of claim 35 in which the force applying element comprises an array of permanent magnets.

39. The torque transmitting device of claim 35 where the reluctance of permanent magnet flux through the core is high enough reluctance that energizing the electromagnets with polarity aligned with the permanent magnet flux reduces the permanent magnet flux linking through the flexible spline.

40. The torque transmitting device of claim 35 in which the permanent magnet flux redirected through the flexible spline when the electromagnets are energized in opposition to the flux of the permanent magnets flows substantially axially through the flexible spline.

41. The torque transmitting device of claim 35 in which the electromagnet coils are arranged to be energized sequentially in alternating polarity to propagate the apexes of the flexible spline.

42. The device of claim 35 in which the controller comprises a torque measurement module that measures torque by comparing a characteristic of a measured flex spline wave with a baseline flex spline wave.

43. The device of claim 42 in which the characteristic is one or more of wave position and flex spline shape.

44. The device of claim 35 in which the controller comprises a collision detection module that outputs a collision detected signal upon detection of a deviation, between torque signals received from the torque measurement module, beyond a predetermined range of deviation.

45-81. (canceled)
